(19) United States
(12) Patent Application Publication
(10) Pub. No.: US 2022/0188700 A1
(43) Pub. Date: Jun. 16, 2022

(54) DISTRIBUTED MACHINE LEARNING HYPERPARAMETER OPTIMIZATION

(71) Applicant: BOMBORA, INC., New York, NY (US)

(72) Inventors: Oleg Valentin KHAVRONIN, Oakland, NJ (US); Benny LIN, New York, NY (US); Anthony LIVHITS, Forest Hills, NY (US); Erik Gregory MATLICK, Miami Beach, FL (US); Christian Michael BURTON, New York, NY (US); Robert James ARMSTRONG, Reno, NV (US)

(73) Assignee: BOMBORA, INC., New York, NY (US)

(21) Appl. No.: 17/224,903

(22) Filed: Apr. 7, 2021

Related U.S. Application Data
(63) Continuation-in-part of application No. 15/690,127, filed on Aug. 29, 2017, now abandoned.
Application No. 15/690,127 is a continuation-in-part of application No. 14/981,529, filed on Dec. 28, 2015, now abandoned.
Application No. 14/981,529 is a continuation-in-part of application No. 14/498,056, filed on Sep. 26, 2014, now Pat. No. 9,940,634.

(51) Int. Cl. G06N 20/00; G06N 7/00; G06F 40/279

(52) U.S. Cl. CPC G06N 20/00; G06F 40/279; G06N 7/005

(57) ABSTRACT

Disclosed embodiments include a distributed hyperparameter (HP) tuning system, which includes a manager and a plurality of trainers. The manager continuously estimates HP sets for a machine learning (ML) model and distributes each HP set to respective trainers. Each trainer obtains a respective HP set and trains a local version of the ML model using the respective HP set. Each trainer determines a performance value for an HP sets used to train its local version of the ML model, and sends the performance value and the HP set to the manager. The manager estimates a new HP set from the HP set received from each trainer. The HP set estimation continues until convergence takes place. Other embodiments may be described and/or claimed.

### RELATED APPLICATIONS

The present application is a continuation-in-part (CIP) of U.S. application Ser. No. 15/690,127 filed Aug. 29, 2017, which is a CIP of U.S. application Ser. No. 14/981,529 filed on Dec. 28, 2015, which is a CIP of U.S. application Ser. No. 14/498,056 filed Sep. 26, 2014 now issued as U.S. Pat. No. 9,940,634, the contents of each of which are hereby incorporated by reference in their entireties.

### TECHNICAL FIELD

Embodiments described herein generally relate to machine learning (ML) and artificial intelligence (AI) and ML model parameter and/or hyperparameter (“(H)P”) optimization, and in particular, to distributed ML (H)P optimization techniques and systems.

### BACKGROUND

Machine learning (ML) is the study of computer algorithms that improve automatically through experience and by the use of data. ML algorithms build models based on sample data (known as “training data”) and/or based on past experience, in order to make predictions or decisions without being explicitly programmed to do so. ML algorithms involve a number of hyperparameters (HPs) that have to be set before running them. In ML, parameters that are derived via training are often referred to as “model parameters”' whereas parameters whose values are used to control the learning process are often referred to as “hyperparameters”. In contrast to model parameters, which are determined during training, tuning HPs often have to be carefully optimized to achieve maximal performance.

In order to select an appropriate HP configuration for a specific dataset at hand, users of ML algorithms can resort to default values of HPs that are specified in implementing software packages or manually configure them based on, for example, research publications, experience, or trial-and-error. Alternatively, an HP tuning strategy can be used, which is a data-dependent optimization procedure, which tries to minimize the expected generalization error of the inducing algorithm over an HP search space of considered candidate configurations, usually by evaluating predictions on an independent test set, or by running a resampling scheme such as cross-validation. These search strategies range from simple grid search or random search to more complex, iterative procedures such as Bayesian optimization. The iterative process of tuning HPs for a particular ML models is computationally intensive and may take many hours, and even multiple days.

### BRIEF DESCRIPTION OF THE DRAWINGS

FIG. 1 depicts an example content consumption monitor (CCM) according to various embodiments. FIG. 2 depicts components of the CCM of FIG. 1 according to various embodiments. FIG. 3 depicts an example operation of a CCM tag according to various embodiments. FIG. 4 depicts example events processed by the CCM of FIG. 1 according to various embodiments. FIG. 5 depicts an example user intent vector according to various embodiments. FIG. 6 depicts an example process for segmenting users according to various embodiments. FIG. 7 depicts an example process for generating organization (org) intent vectors according to various embodiments.

FIG. 8 depicts an example consumption score generator according to various embodiments. FIG. 9 depicts components of the consumption score generator of FIG. 8 according to various embodiments. FIG. 10 depicts an example process for identifying a surge in consumption scores according to various embodiments. FIG. 11 depicts an example process for calculating initial consumption scores according to various embodiments. FIG. 12 depicts an example process for adjusting the initial consumption scores based on historic baseline events according to various embodiments.

FIG. 13 depicts an example process for mapping surge topics with contacts according to various embodiments. FIG. 14 depicts an example content consumption monitor calculating content intent according to various embodiments. FIG. 15 depicts an example process for adjusting a consumption score based on content intent according to various embodiments.

FIGS. 16a and 16b depict example model optimizer architectures according to various embodiments. FIG. 17 depicts components of the model optimizer of FIGS. 16a and 16b according to various embodiments. FIG. 18 depicts an example of the model optimizer of FIGS. 16a and 16b generating parameter sets according to various embodiments. FIGS. 19 depicts an example process used by a main (master) node in the model optimizer according to various embodiments. FIG. 20 depicts an example process used by training nodes in the model optimizer according to various embodiments. FIG. 21 depicts an example computing system suitable for practicing various aspects of the various embodiments discussed herein.

### DETAILED DESCRIPTION

Embodiments disclosed herein are related to artificial intelligence (AI) and machine learning (ML) techniques, and in particular, to distributed ML model optimization.

### 1. Machine Learning and Model Optimization Aspects

Machine learning (ML) involves programming computing systems to optimize a performance criterion using example (training) data and/or past experience. ML refers to the use and development of computer systems that are able to learn and adapt without following explicit instructions, by using algorithms and statistical models to analyze and draw inferences from patterns in data. ML involves using algorithms to perform specific task(s) without using explicit instructions to perform the specific task(s), but instead relying on learnt patterns and/or inferences. ML uses statistics to build mathematical model(s) (also referred to as “ML models” or simply “models”) in order to make predictions or decisions based on sample data (e.g., training data). The model is defined to have a set of parameters, and learning is the execution of a computer program to optimize the parameters of the model using the training data or past experience. The trained model may be a predictive model that makes predictions based on an input dataset, a descriptive model that gains knowledge from an input dataset, or both predictive and descriptive. Once the model is learned (trained), it can be used to make inferences (e.g., predictions).

ML algorithms perform a training process on a training dataset to estimate an underlying ML model. An ML algorithm is a computer program that learns from experience with respect to some task(s) and some performance measure(s)/metric(s), and an ML model is an object or data structure created after an ML algorithm is trained with training data. In other words, the term “ML model” or “model” may describe the output of an ML algorithm that is trained with training data. After training, an ML model may be used to make predictions on new datasets. Additionally, separately trained AI/ML models can be chained together in a AI/ML pipeline during inference or prediction generation. Although the term “ML algorithm” refers to different concepts than the term “ML model,” these terms may be used interchangeably for the purposes of the present disclosure.

ML techniques generally fall into the following main types of learning problem categories: supervised learning, unsupervised learning, and reinforcement learning. Supervised learning is an ML task that aims to learn a mapping function from the input to the output, given a labeled data set. Supervised learning algorithms build models from a set of data that contains both the inputs and the desired outputs. For example, supervised learning may involve learning a function (model) that maps an input to an output based on example input-output pairs or some other form of labeled training data including a set of training examples. Each input-output pair includes an input object (e.g., a vector) and a desired output object or value (referred to as a “supervisory signal”). Supervised learning can be grouped into classification algorithms, regression algorithms, and instance-based algorithms.

Classification, in the context of ML, refers to an ML technique for determining the classes to which various data points belong. Here, the term “class” or “classes” may refer to categories, and are sometimes called “targets” or “labels.” Classification is used when the outputs are restricted to a limited set of quantifiable properties. Classification algorithms may describe an individual (data) instance whose category is to be predicted using a feature vector. As an example, when the instance includes a collection (corpus) of text, each feature in a feature vector may be the frequency that specific words appear in the corpus of text. In ML classification, labels are assigned to instances, and models are trained to correctly predict the pre-assigned labels of from the training examples. A “label” may refer to a desired output for a feature and/or feature vector in an ML algorithm. ML algorithms for classification may be referred to as a “classifier.” Examples of classifiers include linear classifiers, k-nearest neighbor (kNN), decision trees, random forests, support vector machines (SVMs), Bayesian classifiers, convolutional neural networks (CNNs), among many others (note that some of these algorithms can be used for other ML tasks as well).

A regression algorithm and/or a regression analysis, in the context of ML, refers to a set of statistical processes for estimating the relationships between a dependent variable (often referred to as the “outcome variable”) and one or more independent variables (often referred to as “predictors”, “covariates”, or “features”). The outcome of a regression algorithm is a continuous value and not a discrete value as in classification. In contrast to classification, regression does not have a defined range of output values. A regression prediction is, depending on the algorithm, a combination of previously seen values with similar features or a function of its features. Examples of regression algorithms/models include logistic regression, linear regression, gradient descent (GD), stochastic GD (SGD), and the like.

Instance-based learning (sometimes referred to as “memory-based learning”), in the context of ML, refers to a family of learning algorithms that, instead of performing explicit generalization, compares new problem instances with instances seen in training, which have been stored in memory. Examples of instance-based algorithms include k-nearest neighbor, and the like), decision tree Algorithms (e.g., Classification And Regression Tree (CART), Iterative Dichotomiser 3 (ID3), C4.5, chi-square automatic interaction detection (CHAID), etc.), Fuzzy Decision Tree (FDT), and the like), Support Vector Machines (SVM), Bayesian Algorithms (e.g., Bayesian network (BN), a dynamic BN (DBN), Naive Bayes, and the like), and ensemble algorithms (e.g., Extreme Gradient Boosting, voting ensemble, bootstrap aggregating (“bagging”), Random Forest, and the like.

In the context of ML, an “ML feature” (or simply “feature”) is an individual measureable property or characteristic of a phenomenon being observed. Features are usually represented using numbers/numerals (e.g., integers), strings, variables, ordinals, real-values, categories, and/or the like. Additionally or alternatively, ML features are individual variables, which may be independent variables, based on observable phenomenon that can be quantified and recorded. ML models use one or more features to make predictions or inferences. In some implementations, new features can be derived from old features. A set of features may be referred to as a “feature vector.” A vector is a tuple of one or more values called scalars, and a feature vector may include a tuple of one or more features. The vector space associated with these vectors is often called a “vector space” or a “feature space.” In order to reduce the dimensionality of the feature space, a number of dimensionality reduction techniques can be employed. Additionally or alternatively, a feature vector may be a data structure that contains known attributes of an instance.

Unsupervised learning is an ML task that aims to learn a function to describe a hidden structure from unlabeled data. Unsupervised learning algorithms build models from a set of data that contains only inputs and no desired output labels. Unsupervised learning algorithms are used to find structure in the data, like grouping or clustering of data points. Some examples of unsupervised learning are K-means clustering, principal component analysis (PCA), and topic modeling, among many others. In particular, topic modeling is an unsupervised machine learning technique scans a set of InObs (e.g., documents, webpages, files, data structures, etc.), detects word and phrase patterns within the InObs, and automatically clusters word groups and similar expressions that best characterize the set of InObs. Semi-supervised learning algorithms develop ML models from incomplete training data, where a portion of the sample input does not include labels. One example of unsupervised learning is topic modeling. Topic modeling involves counting words and grouping similar word patterns to infer topics within unstructured data. By detecting patterns such as word frequency and distance between words, a topic model clusters feedback that is similar, and words and expressions that appear most often. With this information, the topics of individual set of texts can be quickly deduced.

Reinforcement learning (RL) is a goal-oriented learning based on interaction with environment. In RL, an agent aims to optimize a long-term objective by interacting with the environment based on a trial and error process. Examples of RL algorithms include Markov decision process, Markov chain, Q-learning, multi-armed bandit learning, and deep RL.

An artificial neural network or neural network (NN) encompasses a variety of ML techniques where a collection of connected artificial neurons or nodes that (loosely) model neurons in a biological brain that can transmit signals to other arterial neurons or nodes, where connections (or edges) between the artificial neurons or nodes are (loosely) modeled on synapses of a biological brain. The artificial neurons and edges typically have a weight that adjusts as learning proceeds. The weight increases or decreases the strength of the signal at a connection. Neurons may have a threshold such that a signal is sent only if the aggregate signal crosses that threshold. The artificial neurons can be aggregated or grouped into one or more layers where different layers may perform different transformations on their inputs. Signals travel from the first layer (the input layer), to the last layer (the output layer), possibly after traversing the layers multiple times. NNs are usually used for supervised learning, but can be used for unsupervised learning as well. Examples of NNs include deep NN (DNN), feed forward NN (DNN), a deep FNN (DFF), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), etc.), deep stacking network (DSN). Any of the aforementioned ML techniques may be utilized, in whole or in part, and variants and/or combinations thereof, for any of the example embodiments discussed herein.

ML may require, among other things, obtaining and cleaning a dataset, performing feature selection, selecting an ML algorithm, dividing the dataset into training data and testing data, training a model (e.g., using the selected ML algorithm), testing the model, optimizing or tuning the model, and determining metrics for the model. Some of these tasks may be optional or omitted depending on the use case and/or the implementation used.

ML algorithms accept model parameters (or simply “parameters”) and/or hyperparameters (HPs) that can be used to control certain properties of the training process and the resulting model. Model parameters are parameter values, characteristics, and/or properties that are learnt during training. Additionally or alternatively, a model parameter is a configuration variable that is internal to the model and whose value can be estimated from the given data. Model parameters are usually required by a model when making predictions, and their values define the skill of the model on a particular problem. Usually, parameters are not set manually by the data scientist or ML practitioner. Furthermore, parameters may differ for individual experiments and may depend on the type of data and ML tasks being performed. Examples of such parameters include weights in an artificial neural network, support vectors in a support vector machine, and coefficients in a linear regression or logistic regression. Examples of parameters for topic classification and/or natural language processing (NLP) tasks may include word frequency, sentence length, noun or verb distribution per sentence, the number of specific character n-grams per word, lexical diversity, constraints, weights, and the like.

HPs are characteristics, properties, or parameters for a training process that cannot be learnt during the training process and are set before training takes place. HPs are often used in processes to help estimate model parameters. Examples of HPs may include model size (e.g., in terms of memory space or bytes), whether (and how much) to shuffle the training data, the number of evaluation instances or epochs (e.g., a number of iterations or passes over the training data), learning rate (e.g., the speed at which the algorithm reaches (converges to) the optimal weights), learning rate decay (or weight decay), the number and size of the hidden layers, weight initialization scheme, dropout and gradient clipping thresholds, the C and sigma HPs for support vector machines, the k in k-nearest neighbors, and/or the like. In some implementations, the parameters and/or HPs may additionally or alternatively include vector size and/or word vector size.

HPs can be classified as model HPs and algorithm HPs. Model HPs are parameters that cannot be inferred while fitting the ML model to the training set because they refer to the model selection task. Algorithm HPs in principle have no influence on the performance of the model but affect the speed and quality of the learning process. An example of a model HP is the topology and size of a neural network, and examples of algorithm HPs include learning rate and mini-batch-size. The term “hyperparameter” as used herein may refer to either model hyperparameters, algorithm hyperparameters, or both, even though these terms refer to different concepts.

The particular values selected for the HPs affect the training speed, training resource consumption, and the quality of the learning process. Different HPs used to define an ML algorithm/model may cause the ML algorithm/model to generalize different data patterns. For example, the same kind of ML model can require different constraints, weights, or learning rates (i.e., HPs) to generalize different data patterns. Additionally, the performance of an ML algorithm/model is dependent on the choice of HPs. Selecting and/or altering the value of different HPs can cause relatively large variations in ML algorithm/model performance Therefore, HPs may need to be optimized or “tuned” so that the model can optimally solve the ML problem in an efficient manner

As mentioned previously, in order to select an appropriate HP configuration for a specific dataset, data scientists or ML practitioners can resort to default values of HPs that are specified in implementing software packages or manually configure them, for example, based on recommendations from the literature, experience, heuristics, or trial-and-error. Alternatively, an HP tuning strategy can be used. HP tuning is a data-dependent, second-level optimization procedure, which tries to minimize the expected generalization error of the inducing algorithm over an HP search space of considered candidate configurations, usually by evaluating predictions on an independent test set, or by running a resampling scheme such as cross-validation. These search strategies range from simple procedures (e.g., grid search or random search) to more complex, iterative procedures (e.g., Bayesian optimization). The conventional tuning strategies are computationally intensive and may take many hours, and even multiple days. Other issues related to HP tuning are discussed in Probst et al., “Tunability: Importance of HPs of Machine Learning Algorithms”, arXiv preprint arXiv:1802.09596 (23 Oct. 2018), which is hereby incorporated by reference in its entirety.

In ML, HP optimization or tuning is the problem of choosing a set of optimal HPs for a learning algorithm and/or ML model. The terms “optimize” and/or “optimal” may refer to reducing resource consumption during and/or after training, reducing the amount of time to process data and/or output predictions (i.e., save time), producing a most accurate result set (predictions), or combinations thereof. “Optimal” may also refer to balancing these considerations differently depending on implementation and/or design choice (e.g., selecting to optimize for resource consumption over speed and accuracy, attempting to optimize for resource consumption, speed, and accuracy, etc.). HP optimization finds a tuple of HPs that yields an optimal model which minimizes a predefined loss function on given independent data.

An optimization algorithm (or “optimizer”) may be used to optimize HPs. Optimizers attempt to minimize a loss function, for example, by converging to a minimum value of the cost function during the training phase. Loss functions express the discrepancy between predictions of the model being trained and the problem instances. Model parameter optimization finds a tuple of model parameters that yield an optimal model that minimizes a predefined loss function on given independent data. Model parameter optimization or “tuning” involves selecting a set of model parameters for an ML algorithm, an ML model, and/or a learning algorithm. The tunability of an algorithm, model, model parameter, or interacting model parameters is a measure of how much performance can be gained from the tuning process. However, model parameter optimization (tuning) itself is tedious, computationally resource intensive, and time consuming.

Conventional HP optimization/tuning strategies include grid-search, random search, and Bayesian optimization. Grid-search (or “parameter sweep”) is used to find the optimal HPs of a model which results in the most ‘accurate’ predictions. Grid-search is a brute force technique where a search is performed on a manually specified set or subset of an HP space of a learning algorithm. The grid-search approach is expensive in terms of time and computing resource consumption when compared to the other approaches. For example, for a set of one hundred HPs (e.g., 100 different problems to solve) where each HP has one thousand possible choices (values), and each training process takes about one hour to complete, then the HP tuning process would take about 100,000 hours to complete.

The random search approach involves randomly selecting a set of HPs until an HP combination is discovered that improves ML model and/or ML algorithm performance. In general, the random search approach yields less accurate HPs than the grid-search approach, which leads to less accurate ML model. However, the random search approach can outperform grid-search when only a small number of HPs affect the final performance of the ML algorithm or ML model.

Bayesian optimization minimizes an objective function by building a probability model based on past evaluation results of the objective. When applied to HP optimization, the objective function is the validation error of an ML model using a set of HPs. This approach involves iteratively evaluating an HP configuration based on a current model, and continually updating the probability model to concentrate on promising HPs based on previous results. Bayesian optimization has been shown to obtain better results in fewer evaluations in comparison to the grid-search and random search approaches. However, evaluating the objective function is expensive (in terms of resource consumption and time) because it requires training an ML model with a specific set of HPs.

Embodiments disclosed herein include a distributed model generation system that generates/optimizes ML models from relatively large volumes of data faster than the existing optimization approaches (e.g., requiring fewer evaluation instances or epochs) while also producing more optimal model parameters than the existing optimization approaches. The distributed model generation system can be thought of as using ML to optimize model parameters. In embodiments, the distributed model generation system uses Bayesian optimization in combination with a distributed model training architecture to more quickly identify a set of model parameters that optimize the performance of the model, which is faster than using Bayesian optimization alone. This amounts to an improvement in the technological field of ML, and also amounts to an improvement in the functioning of computing systems themselves.

The distributed model generation system includes a manager node (“manager”) and a plurality of training nodes (or “workers”). The manager operates a model parameter and/or hyperparameter (“(H)P”) optimization process, and at each instance or epoch of the training process, the manager directs each worker to run model training with respective sets of (H)Ps. Each of the workers trains and tests a local ML model using their respective (H)P sets, in parallel. Each worker independently provides their tested (H)P sets with calculated performance scores back to the manager, which then performs additional optimizations on the (H)P sets to produce more optimal (H)P sets. These more optimal (H)P sets are then sent to available workers to train and test their local models using the updated (H)P sets. This process continues until convergence is met. This allows the high processing demands of model training and testing operations to be distributed to the workers, while the manager performs the optimization process to estimate the (H)P sets for the model. This results in a much faster and less computationally intensive optimization and training process in comparison to existing ML HP tuning/optimization techniques. Obtaining results faster while consuming less computational resources is an improvement in the functioning of computing systems themselves, and also amounts to an improvement in the technological field of machine learning.

In embodiments, the manager directs the workers to perform the model training by calling a training function/algorithm, which may have precision metric(s) (e.g., key performance indicator(s)), and passes in the respective parameter sets to each worker and indicates the training data on which each worker is to train. In embodiments, the manager sends messages to the worker nodes to run model training with a set of parameters or a set of HPs through a distributed queue. As each worker produces a result of the model training (e.g., a next-best set of parameters), they send the result back to the manager node, which selects a new parameter space for one of the workers to explore. In embodiments, the workers continually push their results back into the distributed queue, and take another parameter set to search from the distributed queue until the model and/or optimization converges (e.g., when one or more precision metric(s) are reached or met). An iterative algorithm is said to converge when, as iterations (e.g., epochs) proceed, the output gets closer to some specific value; this specific value is called the “limit.”

In some embodiments, the manager estimates model parameter sets for an ML model, and loads the estimated parameter sets into a distributed queue. The manager may estimate the first model parameter sets by using a best-known model parameter set for the model. Each training node downloads a different model parameter set from the queue for training a corresponding model (e.g., each training node is responsible for training its own model). Each training node trains its model and produces a training result, which may be in the form of model performance values. These model performance value(s) may indicate how well the model performed for the specific model parameter set that was used for training. Each training node sends its training result back to the manager as it is produced. For each received result obtained from a training node, the manager estimates one or more new parameter sets for the model based on the training result and stores the new parameter set(s) in the distributed queue. Each training node obtains another parameter set from the queue after it pushes its training result back to the manager. The manager continually estimates new parameter sets and loads the newly estimated parameter sets into the queue until a desired model performance value is obtained. The desired model performance value is indicative of model convergence.

In various embodiments, a distributed ML model generation system includes a manager node that estimates parameter sets for a topic classification (TC) model. A topic model is a statistical model for discovering topics that occur in a collection of information objects, such as electronic documents, web pages, and the like. The TC model is trained on a set of training data and then tested on a set of test data to determine how well the topic model classifies data into different topics. The training and testing process is often iterative where different parameter sets are selected for training the model. The model is then tested to determine a performance level for the selected parameter set. Based on the results, another parameter set is selected to retrain and retest the model to hopefully improve model topic classification performance. Different parameter sets are tested until the model reaches a desired performance level. The TC model may be used to discover hidden semantic structures in the information objects or other collection of text. The estimated parameter sets are loaded into a queue. Multiple training nodes (e.g., workers) download the estimated parameter sets from the queue for training associated TC models. The training nodes generate model performance values for the trained TC models and send the model performance values back to the manager node. The manager node uses the model performance values and the associated parameter sets to estimate additional TC model parameter sets. The manager node estimates new parameter sets until a desired model performance value is obtained. In some embodiments, the manager node may use a Bayesian optimization to more efficiently estimate the parameter sets and may distribute the high processing demands of model training and testing operations to the training nodes.

### 2. Content Consumption Monitor Embodiments

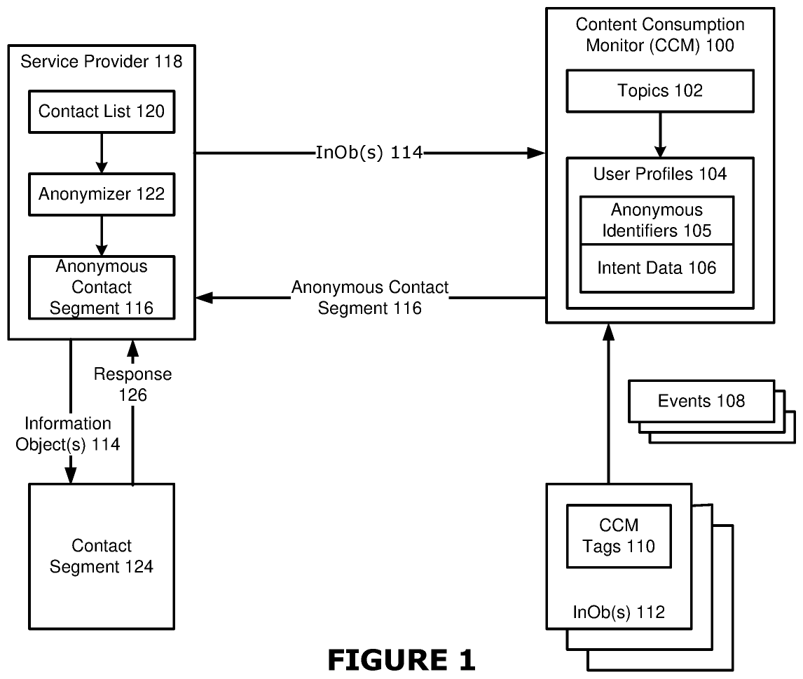

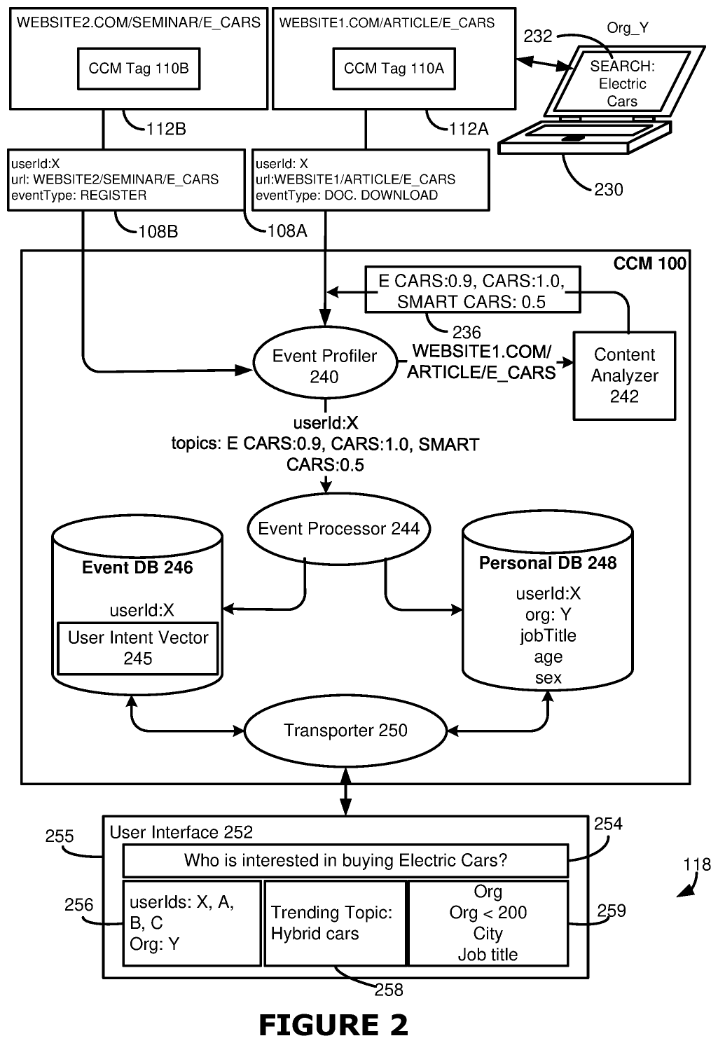

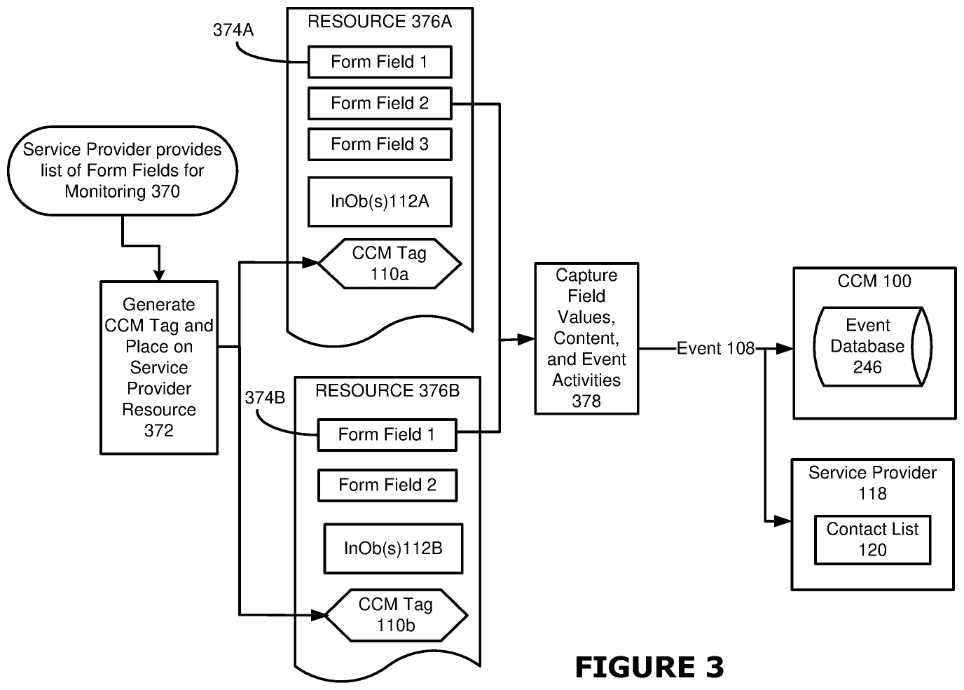

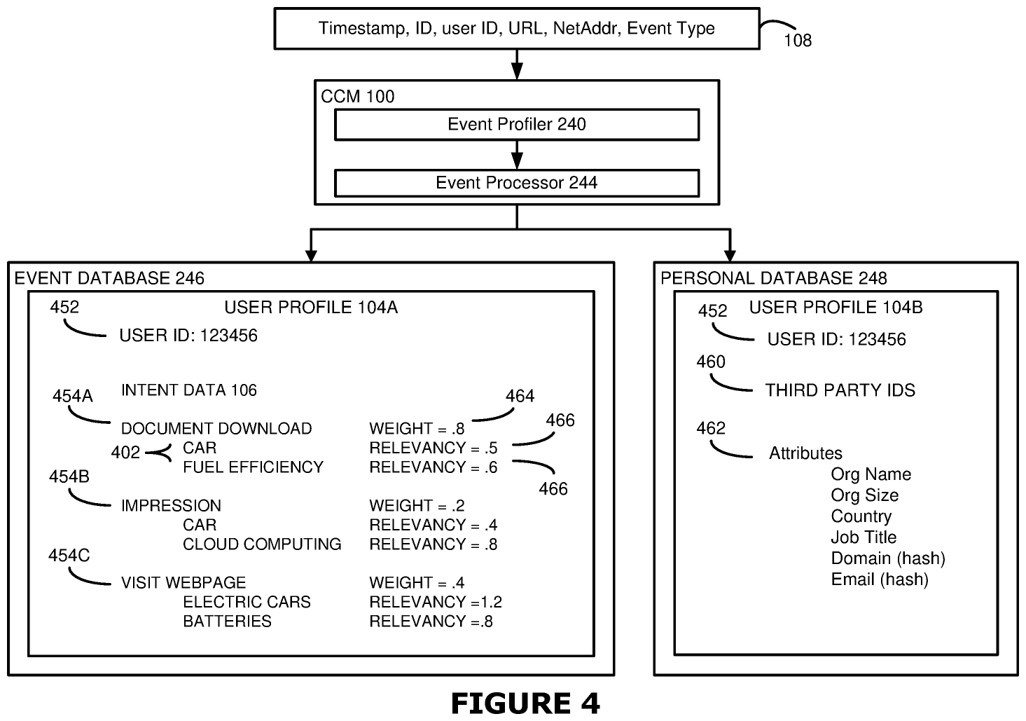

FIG. 1 depicts a content consumption monitor (CCM) 100. CCM 100 includes one or more physical and/or virtualized systems that communicates with a service provider 118 and monitors user accesses to one or more information objects (InObs) 112 such as, for example, third party content and/or the like. The physical and/or virtualized systems include one or more logically or physically connected servers and/or data storage devices distributed locally or across one or more geographic locations. In some implementations, the CCM 100 may be provided by (or operated by) a cloud computing service and/or a cluster of machines in a datacenter. In some implementations, the CCM 100 may be a distributed application provided by (or operated by) various servers of a content delivery network (CDN) or edge computing network. Other implementations are possible in other embodiments.

Service provider 118 (also referred to as a “publisher,” “B2B publisher,” or the like) comprises one or more physical and/or virtualized computing systems owned and/or operated by a company, enterprise, and/or individual that wants to send InOb(s) 114 to an interested group of users, which may include targeted content or the like. This group of users is alternatively referred to as “contact segment 124.” The physical and/or virtualized systems include one or more logically or physically connected servers and/or data storage devices distributed locally or across one or more geographic locations. Generally, the service provider 118 uses IP/network resources to provide InObs such as electronic documents, webpages, forms, applications (e.g., web apps), data, services, web services, media, and/or content to different user/client devices. As examples, the service provider 118 may provide search engine services; social media/networking services; content (media) streaming services; e-commerce services; blockchain services; communication services; immersive gaming experiences; and/or other like services. The user/client devices that utilize services provided by service provider 118 may be referred to as “subscribers.” Although FIG. 1 shows only a single service provider 118, the service provider 118 may represent multiple service providers 118, each of which may have their own subscribing users.

In one example, service provider 118 may be a company that sells electric cars. Service provider 118 may have a contact list 120 of email addresses for customers that have attended prior seminars or have registered on the service provider's 118 website. Contact list 120 may also be generated by CCM tags 110 that are described in more detail below. Service provider 118 may also generate contact list 120 from lead lists provided by third parties lead services, retail outlets, and/or other promotions or points of sale, or the like or any combination thereof. Service provider 118 may want to send email announcements for an upcoming electric car seminar Service provider 118 would like to increase the number of attendees at the seminar. In another example, service provider 118 may be a platform or service provider that offers a variety of user targeting services to their subscribers such as sales enablement, digital advertising, content/engagement marketing, and marketing automation, among others.

The InObs 112 comprise any data structure including or indicating information on any subject accessed by any user. The InObs 112 may include any type of InOb (or collection of InObs). InObs 112 may include electronic documents, database objects, electronic files, resources, and/or any data structure that includes one or more data elements, each of which may include one or more data values and/or content items.

In some implementations, the InObs 112 may include webpages provided on (or served) by one or more web servers and/or application servers operated by different service provides, businesses, and/or individuals. For example, InObs 112 may come from different websites operated by online retailers and wholesalers, online newspapers, universities, blogs, municipalities, social media sites, or any other entity that supplies content. Additionally or alternatively, InObs 112 may also include information not accessed directly from websites. For example, users may access registration information at seminars, retail stores, and other events. InObs 112 may also include content provided by service provider 118. Additionally, InObs 112 may be associated with one or more topics 102. The topic 102 of an InOb 112 may refer to the subject, meaning, and/or theme of that InOb 112.

The CCM 100 may identify or determine one or more topics 102 of an InOb 112 using a topic analysis model/technique. Topic analysis (also referred to as “topic detection,” “topic modeling,” or “topic extraction”) refers to ML techniques that organize and understand large collections of text data by assigning tags or categories according to each individual InOb's 112 topic or theme. A topic model is a type of statistical model used for discovering topics 102 that occur in a collection of InObs 112 or other collections of text. A topic model may be used to discover hidden semantic structures in the InObs 112 or other collections of text. In one example, a topic classification technique is used, where a topic classification model is trained on a set of training data (e.g., InObs 112 labeled with tags/topics 102) and then tested on a set of test data to determine how well the topic classification model classifies data into different topics 102. Once trained, the topic classification model is used to determine/predict topics 102 in various InObs 112. In another example, a topic modeling technique is used, where a topic modeling model automatically analyzes InObs 112 to determine cluster words for a set of documents. Topic modeling is an unsupervised ML technique that does not require training using training data. Any suitable NLP/NLU techniques may be used for the topic analysis in various embodiments.

Computers and/or servers associated with service provider 118, content segment 124, and the CCM 100 may communicate over the Internet or any other wired or wireless network including local area networks (LANs), wide area networks (WANs), wireless networks, cellular networks, WiFi networks, Personal Area Networks (e.g., Bluetooth® and/or the like), Digital Subscriber Line (DSL) and/or cable networks, and/or the like, and/or any combination thereof.

Some of InObs 112 contain CCM tags 110 that capture and send network session events 108 (or simply “events 108”) to CCM 100. For example, CCM tags 110 may comprise JavaScript added to webpages of a website (or individual components of a web app or the like). The website downloads the webpages, along with CCM tags 110, to user computers (e.g., computer 230 of FIG. 2). CCM tags 110 monitor network sessions (or web sessions) and sends some or all captured session events 108 to CCM 100.

In one example, the CCM tags 110 may intercept or otherwise obtain HTTP messages being sent by and/or sent to a computer 230, and these HTTP messages may be provided to the CCM 100 as the events 108. In this example, the CCM tags 110 or the CCM 100 may extract or otherwise obtain a network address of the computer 230 from an X-Forwarded-For (XFF) field of the HTTP header, a time and date that the HTTP message was sent from a Date field of the HTTP header, and/or a user agent string contained in a User Agent field of an HTTP header of the HTTP message. The user agent string may indicate the operating system (OS) type/version of the sending device (e.g., a computer 230); system information of the sending device (e.g., a computer 230); browser version/type of the sending device (e.g., a computer 230); rendering engine version/type of the sending device (e.g., a computer 230); a device type of the of the sending device (e.g., a computer 230), as well as other information. In another example, the CCM tags 110 may derive various information from the computer 230 that is not typically included in an HTTP header, such as time zone information, GPS coordinates, screen or display resolution of the computer 230, data from one or more applications operated by the computer 230, and/or other like information. In various implementations, the CCM tags 110 may generate and send events 108 or messages based on the monitored network session. For example, the CCM tags 110 may obtain data when various events/triggers are detected, and may send back information (e.g., in additional HTTP messages). Other methods may be used to obtain or derive user information.

In some implementations, the InObs 112 that include CCM tags 110 may be provided or hosted by a collection of service providers 118 such as, for example, notable business-to-business (B2B) publishers, marketers, agencies, technology providers, research firms, events firms, and/or any other desired entity/org type. This collection of service providers 118 may be referred to as a “data cooperative” or “data co-op.” Additionally or alternatively, events 108 may be collected by one or more other data tracking entities separate from the CCM 100, and provided as one or more datasets to the CCM 100 (e.g., a “bulk” dataset or the like).

Events 108 may identify InObs 112 and identify the user accessing InObs 112. For example, event 108 may include a URL link to InObs 112 and may include a hashed user email address or cookie identifier (ID) associated with the user that accessed InObs 112. Events 108 may also identify an access activity associated with InObs 112. For example, an event 108 may indicate the user viewed a webpage, downloaded an electronic document, or registered for a seminar Additionally or alternatively, events 108 may identify various user interactions with InObs 112 such as, for example, topic consumption, scroll velocity, dwell time, and/or other user interactions such as those discussed herein. In one example, the tags 110 may collect anonymized information about a visiting user's network address (e.g., IP address), an anonymized cookie ID, a timestamp of when the user visited or accessed an InOb 112, and/or geo-location information associated with the user's computing device. In some embodiments, device fingerprinting can be used to track users, while in other embodiments, device fingerprinting may be excluded to preserver user anonymity.

CCM 100 builds user profiles 104 from events 108. User profiles 104 may include anonymous identifiers 105 that associate InObs 112 with particular users. User profiles 104 may also include intent data 106. Intent data 106 includes or indicates insights into users' interests and may include predictions about their potential to take certain actions based on their content consumption. The intent data 106 identifies or indicates topics 102 in InObs 112 accessed by the users. For example, intent data 106 may comprise a user intent vector (e.g., user intent vector 245 of FIG. 2, intent vector 594 of FIG. 5, etc.) that identifies or indicates the topics 102 and identifies levels of user interest in the topics 102.

This approach to intent data 106 collection makes possible a consistent and stable historical baseline for measuring content consumption. This baseline effectively spans the web, delivering at an exponential scale greater than any one site. In embodiments, the CCM 100 monitors content consumption behavior from a collection of service providers 118 (e.g., the aforementioned data co-op) and applies data science and/or ML techniques to identify changes in activity compared to the historical baselines. As examples, research frequency, depth of engagement, and content relevancy all contribute to measuring an org's interest in topic(s) 102. In some embodiments, the CCM 100 may employ an NLP/NLU engine that reads, deciphers, and understands content across a taxonomy of intent topics 102 that grows on a periodic basis (e.g., monthly, weekly, etc.). The NLP/NLU engine may operate or execute the topic analysis models discussed previously.

As mentioned previously, service provider 118 may want to send an email announcing an electric car seminar to a particular contact segment 124 of users interested in electric cars. Service provider 118 may send InOb(s) 114, such as the aforementioned email to CCM 100, and the CCM 100 identifies topics 102 in InOb(s) 114. The CCM 100 compares content topics 102 with the intent data 106, and identifies user profiles 104 that indicate an interest in InOb(s) 114. Then, the CCM 100 sends an anonymous contact segment 116 to service provider 118, which includes anonymized or pseudonymized identifiers 105 associated with the identified user profiles 104. In some embodiments, the CCM 100 includes an anonymizer or pseudonymizer, which is the same or similar to anonymizer 122, to anonymize or pseudonymize user identifiers.

Contact list 120 may include personally identifying information (PII) and/or personal data such as email addresses, names, phone numbers, or some other user identifier(s), or any combination thereof. Additionally or alternatively, the contact list 120 may include sensitive data and/or confidential information. The personal, sensitive, and/or confidential data in contact list 120 are anonymized or pseudonymized or otherwise de-identified by an anonymizer 122.

The anonymizer 122 may anonymize or pseudonymize any personal, sensitive, and/or confidential data using any number of data anonymization or pseudonymization techniques including, for example, data encryption, substitution, shuffling, number and date variance, and nulling out specific fields or data sets. Data encryption is an anonymization or pseudonymization technique that replaces personal/sensitive/confidential data with encrypted data. A suitable hash algorithm may be used as an anonymization or pseudonymization technique in some embodiments. Anonymization is a type of information sanitization technique that removes personal, sensitive, and/or confidential data from data or datasets so that the person or information described or indicated by the data/datasets remain anonymous. Pseudonymization is a data management and de-identification procedure by which personal, sensitive, and/or confidential data within InObs (e.g., fields and/or records, data elements, documents, etc.) is/are replaced by one or more artificial identifiers, or pseudonyms. In most pseudonymization mechanisms, a single pseudonym is provided for each replaced data item or a collection of replaced data items, which makes the data less identifiable while remaining suitable for data analysis and data processing. Although “anonymization” and “pseudonymization” refer to different concepts, these terms may be used interchangeably throughout the present disclosure.

The service provider 118 compares the anonymized/pseudonymized identifiers (e.g., hashed identifiers) from contact list 120 with the anonymous identifiers 105 in anonymous contact segment 116. Any matching identifiers are identified as contact segment 124. Service provider 118 identifies the unencrypted email addresses in contact list 120 associated with contact segment 124. Service provider 118 sends InOb(s) 114 to the addresses (e.g., email addresses) identified for contact segment 124. For example, service provider 118 may send an email announcing the electric car seminar to contact segment 124.

Sending InOb(s) 114 to contact segment 124 may generate a substantial lift in the number of positive responses 126. For example, assume service provider 118 wants to send emails announcing early bird specials for the upcoming seminar. The seminar may include ten different tracks, such as electric cars, environmental issues, renewable energy, etc. In the past, service provider 118 may have sent ten different emails for each separate track to everyone in contact list 120.

Service provider 118 may now only send the email regarding the electric car track to contacts identified in contact segment 124. The number of positive responses 126 registering for the electric car track of the seminar may substantially increase since content 114 is now directed to users interested in electric cars.

In another example, CCM 100 may provide local ad campaign or email segmentation. For example, CCM 100 may provide a “yes” or “no” as to whether a particular advertisement should be shown to a particular user. In this example, CCM 100 may use the hashed data without re-identification of users and the “yes/no” action recommendation may key off of a de-identified hash value.

CCM 100 may revitalize cold contacts in service provider contact list 120. CCM 100 can identify the users in contact list 120 that are currently accessing other InObs 112 and identify the topics associated with InObs 112. By monitoring accesses to InObs 112, CCM 100 may identify current user interests even though those interests may not align with the content currently provided by service provider 118. Service provider 118 might reengage the cold contacts by providing content 114 more aligned with the most relevant topics identified in InObs 112.

FIG. 2 is a diagram explaining the content consumption manager in more detail. A user may enter a search query 232 into a computer 230, for example, via a search engine. The computer 230 may include any communication and/or processing device including but not limited to desktop computers, workstations, laptop computers, smartphones, tablet computers, wearable devices, servers, smart appliances, network appliances, and/or the like, or any combination thereof. The user may work for an organization Y (org_Y). For example, the user may have an associated email address: user@org_y.com.

In response to search query 232, the search engine may display links or other references to InObs 112A and 112B on website1 and website2, respectively (note that website1 and website2 may also be respective InObs 112 or collections of InObs 112). The user may click on the link to website1, and website1 may download a webpage to a client app operated by computer 230 that includes a link to InOb 112A, which may be a white paper in this example. Website1 may include one or more webpages with CCM tags 110A that capture different events 108 during a network session (or web session) between website1 and computer 230 (or between website1 and the client app operated by computer 230). Websitel or another website may have downloaded a cookie onto a web browser operating on computer 230. The cookie may comprise an identifier X, such as a unique alphanumeric set of characters associated with the web browser on computer 230.

During the session with website1, the user of computer 230 may click on a link to white paper 112A. In response to the mouse click, CCM tag 110A may download an event 108A to CCM 100. Event 108A may identify the cookie identifier X loaded on the web browser of computer 230. In addition, or alternatively, CCM tag 110A may capture a user name and/or email address entered into one or more webpage fields during the session. CCM tag 110 hashes the email address and includes the hashed email address in event 108A. Any identifier associated with the user is referred to generally as user X or user ID.

CCM tag 110A may also include a link in event 108A to the white paper downloaded from website1 to computer 230. For example, CCM tag 110A may capture the URL for white paper 112A. CCM tag 110A may also include an event type identifier in event 108A that identifies an action or activity associated with InOb 112A. For example, CCM tag 110A may insert an event type identifier into event 108A that indicates the user downloaded an electric document.

CCM tag 110A may also identify the launching platform for accessing InOb 112B. For example, CCM tag 110B may identify a link www.searchengine.com to the search engine used for accessing website1.

An event profiler 240 in CCM 100 forwards the URL identified in event 108A to a content analyzer 242. Content analyzer 242 generates a set of topics 236 associated with or suggested by white paper 112A. For example, topics 236 may include electric cars, cars, smart cars, electric batteries, etc. Each topic 236 may have an associated relevancy score indicating the relevancy of the topic in white paper 112A. Content analyzers that identify topics in documents are known to those skilled in the art and are therefore not described in further detail.

Event profiler 240 forwards the user ID, topics 236, event type, and any other data from event 108A to event processor 244. Event processor 244 may store personal information captured in event 108A in a personal database 248. For example, during the session with website1, the user may have entered an employer company name into a webpage form field. CCM tag 110A may copy the employer company name into event 108A. Alternatively, CCM 100 may identify the company name from a domain name of the user email address.

Event processor 244 may store other demographic information from event 108A in personal database 248, such as user job title, age, sex, geographic location (postal address), etc. In one example, some of the information in personal database 248 is hashed, such as the user ID and or any other personally identifiable information. Other information in personal database 248 may be anonymous to any specific user, such as org name and job title.

Event processor 244 builds a user intent vector 245 from topic vectors 236. Event processor 244 continuously updates user intent vector 245 based on other received events 108. For example, the search engine may display a second link to website2 in response to search query 132. User X may click on the second link and website2 may download a webpage to computer 230 announcing the seminar on electric cars.

The webpage downloaded by website2 may also include a CCM tag 110B. User X may register for the seminar during the session with website2. CCM tag 110B may generate a second event 108B that includes the user ID: X, a URL link to the webpage announcing the seminar, and an event type indicating the user registered for the electric car seminar advertised on the webpage.

CCM tag 110B sends event 108B to CCM 100. Content analyzer 242 generates a second set of topics 236. Event 108B may contain additional personal information associated with user X. Event processor 244 may add the additional personal information to personal database 248.

Event processor 244 updates user intent vector 245 based on the second set of topics 236 identified for event 108B. Event processor 244 may add new topics to user intent vector 245 or may change the relevancy scores for existing topics. For example, topics identified in both event 108A and 108B may be assigned higher relevancy scores. Event processor 244 may also adjust relevancy scores based on the associated event type identified in events 108.

Service provider 118 may submit a search query 254 to CCM 100 via a user interface 252 on a computer 255. For example, search query 254 may ask “who is interested in buying electric cars?” A transporter 250 in CCM 100 searches user intent vectors 245 for electric car topics with high relevancy scores. Transporter 250 may identify user intent vector 245 for user X. Transporter 250 identifies user X and other users A, B, and C interested in electric cars in search results 156.

As mentioned previously, the user IDs may be hashed and CCM 100 may not know the actual identities of users X, A, B, and C. CCM 100 may provide a segment of hashed user IDs X, A, B, and C to service provider 118 in response to query 254.

Service provider 118 may have a contact list 120 of users (see e.g., FIG. 1). Service provider 118 may hash email addresses in contact list 120 and compare the hashed identifiers with the encrypted or hashed user IDs X, A, B, and C. Service provider 118 identifies the unencrypted email address for matching user identifiers. Service provider 118 then sends information related to electric cars to the email addresses of the identified user segment. For example, service provider 118 may send emails containing white papers, advertisements, articles, announcements, seminar notifications, or the like, or any combination thereof.

CCM 100 may provide other information in response to search query 254. For example, event processor 244 may aggregate user intent vectors 245 for users employed by the same company Y into an org intent vector. The org intent vector for org Y may indicate a strong interest in electric cars. Accordingly, CCM 100 may identify org Y in search results 156. By aggregating user intent vectors 245, CCM 100 can identify the intent of a company or other category without disclosing any specific user personal information (e.g., without regarding a user's online browsing activity).

CCM 100 continuously receives events 108 for different third party content. Event processor 244 may aggregate events 108 for a particular time period, such as for a current day, for the past week, or for the past 30 days. Event processor 244 then may identify trending topics 158 within that particular time period. For example, event processor 244 may identify the topics with the highest average relevancy values over the last 30 days.

Different filters 259 may be applied to the intent data stored in event database 246. For example, filters 259 may direct event processor 244 to identify users in a particular company Y that are interested in electric cars. In another example, filters 259 may direct event processor 244 to identify companies with less than 200 employees that are interested in electric cars.

Filters 259 may also direct event processor 244 to identify users with a particular job title that are interested in electric cars or identify users in a particular city that are interested in electric cars. CCM 100 may use any demographic information in personal database 248 for filtering query 254.

CCM 100 monitors content accessed from multiple different third party websites. This allows CCM 100 to better identify the current intent for a wider variety of users, companies, or any other demographics. CCM 100 may use hashed and/or other anonymous identifiers to maintain user privacy. CCM 100 further maintains user anonymity by identifying the intent of generic user segments, such as companies, marketing groups, geographic locations, or any other user demographics.

FIG. 3 depicts example operations performed by CCM tags 110 according to various embodiments. At operation 370, a service provider 118 provides a list of form fields 374 for monitoring on webpages 376. At operation 372, CCM tags 110 are generated and loaded in webpages 376 on the service provider's 118 website. For example, CCM tag 110A is loaded onto a first webpage 376A of the service provider's 118 website and a CCM tag 110B is loaded onto a second webpage 376B of the service provider's 118 website. In one example, CCM tags 110 comprise JavaScript loaded into the webpage document object model (DOM).

The service provider 118 may download webpages 376, along with CCM tags 110, to user computers (e.g., computer 230 of FIG. 2) during sessions. Additionally or alternatively, the CCM tags 110 may be executed when the user computers access and/or load the webpages 376 (e.g., within a browser, mobile app, or other client application). CCM tag 110A captures the data entered into some of form fields 374A and CCM tag 110B captures data entered into some of form fields 374B.

A user enters information into form fields 374A and 374B during the session. For example, the user may enter an email address into one of form fields 374A during a user registration process or a shopping cart checkout process. CCM tags 110 may capture the email address at operation 378, validate and hash the email address, and then send the hashed email address to CCM 100 in event 108.

CCM tags 110 may first confirm the email address includes a valid domain syntax and then use a hash algorithm to encode the valid email address string. CCM tags 110 may also capture other anonymous user identifiers, such as a cookie identifier. If no identifiers exist, CCM tag 110 may create a unique identifier. Other data may be captured as well, such as client app data, data mined from other applications, and/or other data from the user computers.

CCM tags 110 may capture any information entered into fields 374. For example, CCM tags 110 may also capture user demographic data, such as organization (org) name, age, sex, postal address, etc. In one example, CCM tags 110 capture some the information for service provider contact list 120.

CCM tags 110 may also identify InOb 112 and associated event activities at operation 378. For example, CCM tag 110A may detect a user downloading the white paper 112A or registering for a seminar (e.g., through an online form or the like hosted by website1 or some other website or web app). CCM tag 110A captures the URL for white paper 112A and generates an event type identifier that identifies the event as a document download.

Depending on the application, CCM tag 110 at operation 378 sends the captured web session information in event 108 to service provider 118 and/or to CCM 100. For example, event 108 is sent to service provider 118 when CCM tag 110 is used for generating service provider contact list 120. In another example, the event 108 is sent to CCM 100 when CCM tag 110 is used for generating intent data.

CCM tags 110 may capture session information in response to the user leaving webpage 376, existing one of form fields 374, selecting a submit icon, moussing out of one of form fields 374, mouse clicks, an off focus, and/or any other user action. Note again that CCM 100 might never receive personally identifiable information (PII) since any PII data in event 108 is hashed by CCM tag 110.

FIG. 4 is a diagram showing how the CCM generates intent data 106 according to various embodiments. As mentioned previously, a CCM tag 110 may send a captured raw event 108 to CCM 100. For example, the CCM tag 110 may send event 108 to CCM 100 in response to a user downloading a white paper. In this example, the event 108 may include a timestamp indicating when the white paper was downloaded, an identifier (ID) for event 108, a user ID associated with the user that downloaded the white paper, a URL for the downloaded white paper, and a network address for the launching platform for the content. Event 108 may also include an event type indicating, for example, that the user downloaded an electronic document.

Event profiler 240 and event processor 244 may generate intent data 106 from one or more events 108. Intent data 106 may be stored in a structured query language (SQL) database or non-SQL database. In one example, intent data 106 is stored in user profile 104A and includes a user ID 452 and associated event data 454.

Event data 454A is associated with a user downloading a white paper. Event profiler 240 identifies a car topic 402 and a fuel efficiency topic 402 in the white paper. Event profiler 240 may assign a 0.5 relevancy value to the car topic and assign a 0.6 relevancy value to the fuel efficiency topic 402.

Event processor 244 may assign a weight value 464 to event data 454A. Event processor 244 may assign larger a weight value 264 to more assertive events, such as downloading the white paper. Event processor 244 may assign a smaller weight value 464 to less assertive events, such as viewing a webpage. Event processor 244 may assign other weight values 464 for viewing or downloading different types of media, such as downloading a text, video, audio, electronic books, on-line magazines and newspapers, etc.

CCM 100 may receive a second event 108 for a second piece of content accessed by the same user. CCM 100 generates and stores event data 454B for the second event 108 in user profile 104A. Event profiler 240 may identify a first car topic with a relevancy value of 0.4 and identify a second cloud computing topic with a relevancy value of 0.8 for the content associated with event data 454B. Event processor 244 may assign a weight value of 0.2 to event data 454B.

CCM 100 may receive a third event 108 for a third piece of content accessed by the same user. CCM 100 generates and stores event data 454C for the third event 108 in user profile 104A. Event profiler 240 identifies a first topic associated with electric cars with a relevancy value of 1.2 and identifies a second topic associated with batteries with a relevancy value of 0.8. Event processor 244 may assign a weight value of 0.4 to event data 454C.

Event data 454 and associated weighting values 264 may provide a better indicator of user interests/intent. For example, a user may complete forms on a service provider website indicating an interest in cloud computing. However, CCM 100 may receive events 108 for third party content accessed by the same user. Events 108 may indicate the user downloaded a whitepaper discussing electric cars and registered for a seminar related to electric cars.

CCM 100 generates intent data 106 based on received events 108. Relevancy values 466 in combination with weighting values 464 may indicate the user is highly interested in electric cars. Even though the user indicated an interest in cloud computing on the service provider website, CCM 100 determined from the third party content that the user was actually more interested in electric cars.

CCM 100 may store other personal user information from events 108 in user profile 104B. For example, event processor 244 may store third party identifiers 460 and attributes 462 associated with user ID 452. Third party identifiers 460 may include user names or any other identifiers used by third parties for identifying user 452. Attributes 462 may include an org name (e.g., employer company name), org size, country, job title, hashed domain name, and/or hashed email addresses associated with user ID 452. Attributes 462 may be combined from different events 108 received from different websites accessed by the user. CCM 100 may also obtain different demographic data in user profile 104 from third party data sources (whether sourced online or offline).

An aggregator may use user profile 104 to update and/or aggregate intent data for different segments, such as service provider contact lists, companies, job titles, etc. The aggregator may also create snapshots of intent data 106 for selected time periods.

Event processor 244 may generate intent data 106 for both known and unknown users. For example, the user may access a webpage and enter an email address into a form field in the webpage. A CCM tag 110 captures and hashes the email address and associates the hashed email address with user ID 452.

The user may not enter an email address into a form field. Alternatively, the CCM tag 110 may capture an anonymous cookie ID in event 108. Event processor 244 then associates the cookie ID with user identifier 452. The user may clear the cookie or access data on a different computer. Event processor 244 may generate a different user identifier 452 and new intent data 106 for the same user.

The cookie ID may be used to create a de-identified cookie data set. The de-identified cookie data set then may be integrated with ad platforms or used for identifying destinations for target advertising.

CCM 100 may separately analyze intent data 106 for the different anonymous user IDs. If the user ever fills out a form providing an email address, event processor then may re-associate the different intent data 106 with the same user identifier 452.

FIG. 5 depicts an example of how the CCM 100 generates a user intent vector 594 from the event data described previously in FIG. 4 according to various embodiments. The user intent vector 594 may be the same or similar as user intent vector 245 of FIG. 2. A user may use computer 530 (which may be the same or similar to the computer 230 of FIG. 2) to access different InObs 582 (including InObs 582A, 582B, and 582C). For example, the user may download a white paper 282A associated with storage virtualization, register for a network security seminar on a webpage 582B, and view a webpage article 582C related to virtual private networks (VPNs). As examples, InObs 582A, 582B, and 582C may come from the same website or come from different websites.

The CCM tags 110 capture three events 584A, 584B, and 584C associated with InObs 582A, 582B, and 582C, respectively. CCM 100 identifies topics 586 in content 582A, 582B, and/or 582C. Topics 586 include virtual storage, network security, and VPNs. CCM 100 assigns relevancy values 590 to topics 586 based on known algorithms For example, relevancy values 590 may be assigned based on the number of times different associated keywords are identified in content 582.

CCM 100 assigns weight values 588 to content 582 based on the associated event activity. For example, CCM 100 assigns a relatively high weight value of 0.7 to a more assertive off-line activity, such as registering for the network security seminar CCM 100 assigns a relatively low weight value of 0.2 to a more passive on-line activity, such as viewing the VPN webpage.

CCM 100 generates a user intent vector 594 in user profile 104 based on the relevancy values 590. For example, CCM 100 may multiply relevancy values 590 by the associated weight values 588. CCM 100 then may sum together the weighted relevancy values for the same topics to generate user intent vector 594.

CCM 100 uses intent vector 594 to represent a user, represent content accessed by the user, represent user access activities associated with the content, and effectively represent the intent/interests of the user. In another embodiment, CCM 100 may assign each topic in user intent vector 594 a binary score of 1 or 0. CCM 100 may use other techniques for deriving user intent vector 594. For example, CCM 100 may weigh the relevancy values based on timestamps.

FIG. 6 depicts an example of how the CCM 100 segments users according to various embodiments. CCM 100 may generate user intent vectors 594A and 594B for two different users, including user X and user Y in this example. A service provider 118 may want to email content 698 to a segment of interested users. The service provider submits content 698 to CCM 100. CCM 100 identifies topics 586 and associated relevancy values 600 for content 698.

CCM 100 may use any variety of different algorithms to identify a segment of user intent vectors 594 associated with content 698. For example, relevancy value 600B indicates content 698 is primarily related to network security. CCM 100 may identify any user intent vectors 594 that include a network security topic with a relevancy value above a given threshold value.

In this example, assume the relevancy value threshold for the network security topic is 0.5. CCM 100 identifies user intent vector 594A as part of the segment of users satisfying the threshold value. Accordingly, CCM 100 sends the service provider of content 698 a contact segment that includes the user ID associated with user intent vector 594A. As mentioned previously, the user ID may be a hashed email address, cookie ID, or some other encrypted or unencrypted identifier associated with the user.

In another example, CCM 100 calculates vector cross products between user intent vectors 594 and content 698. Any user intent vectors 594 that generate a cross product value above a given threshold value are identified by CCM 100 and sent to the service provider 118.

FIG. 7 depicts examples of how the CCM 100 aggregates intent data 106 according to various embodiments. In this example, a service provider 118 operating a computer 702 (which may be the same or similar as computer 230 and computer 530 of FIGS. 2 and 5) submits a search query 704 to CCM 100 asking what companies are interested in electric cars. In this example, CCM 100 associates five different topics 586 with user profiles 104. Topics 586 include storage virtualization, network security, electric cars, e-commerce, and finance.

CCM 100 generates user intent vectors 594 as described previously in FIG. 6. User intent vectors 594 have associated personal information, such as a job title 707 and an org (e.g., employer company) name 710. As explained previously, users may provide personal information, such as employer name and job title in form fields when accessing a service provider 118 or third party website.

The CCM tags 110 described previously capture and send the job title and employer name information to CCM 100. CCM 100 stores the job title and employer information in the associated user profile 104. CCM 100 searches user profiles 104 and identifies three user intent vectors 594A, 594B, and 594C associated with the same employer name 710. CCM 100 determines that user intent vectors 594A and 594B are associated with a same job title of analyst and user intent vector 594C is associated with a job title of VP of finance

In response to, or prior to, search query 704, CCM 100 generates a company intent vector 712A for company X. CCM 100 may generate company intent vector 712A by summing up the topic relevancy values for all of the user intent vectors 594 associated with company X.

In response to search query 704, CCM 100 identifies any company intent vectors 712 that include an electric car topic 586 with a relevancy value greater than a given threshold. For example, CCM 100 may identify any companies with relevancy values greater than 4.0. In this example, CCM 100 identifies Org X in search results 706.

In one example, intent is identified for a company at a particular zip code, such as zip code 11201. CCM 100 may take customer supplied offline data, such as from a Customer Relationship Management (CRM) database, and identify the users that match the company and zip code 11201 to create a segment.

In another example, service provider 118 may enter a query 705 asking which companies are interested in a document (DOC 1) related to electric cars. Computer 702 submits query 705 and DOC 1 to CCM 100. CCM 100 generates a topic vector for DOC 1 and compares the DOC 1 topic vector with all known company intent vectors 712A.

CCM 100 may identify an electric car topic in the DOC 1 with high relevancy value and identify company intent vectors 712 with an electric car relevancy value above a given threshold. In another example, CCM 100 may perform a vector cross product between the DOC 1 topics and different company intent vectors 712. CCM 100 may identify the names of any companies with vector cross product values above a given threshold value and display the identified company names in search results 706.

CCM 100 may assign weight values 708 for different job titles. For example, an analyst may be assigned a weight value of 1.0 and a vice president (VP) may be assigned a weight value of 7.0. Weight values 708 may reflect purchasing authority associated with job titles 707. For example, a VP of finance may have higher authority for purchasing electric cars than an analyst. Weight values 708 may vary based on the relevance of the job title to the particular topic. For example, CCM 100 may assign an analyst a higher weight value 708 for research topics.

CCM 100 may generate a weighted company intent vector 712B based on weighting values 708. For example, CCM 100 may multiply the relevancy values for user intent vectors 594A and 594B by weighting value 1.0 and multiply the relevancy values for user intent vector 594C by weighting value 3.0. The weighted topic relevancy values for user intent vectors 594A, 594B, and 594C are then summed together to generate weighted company intent vector 712B.

CCM 100 may aggregate together intent vectors for other categories, such as job title. For example, CCM 100 may aggregate together all the user intent vectors 594 with VP of finance job titles into a VP of finance intent vector 714. Intent vector 714 identifies the topics of interest to VPs of finance.

CCM 100 may also perform searches based on job title or any other category. For example, service provider 118 may enter a query LIST VPs OF FINANCE INTERESTED IN ELECTRIC CARS? The CCM 100 identifies all of the user intent vectors 594 with associated VP finance job titles 707. CCM 100 then segments the group of user intent vectors 594 with electric car topic relevancy values above a given threshold value.

CCM 100 may generate composite profiles 716. Composite profiles 716 may contain specific information provided by a particular service provider 118 or entity. For example, a first service provider 118 may identify a user as VP of finance and a second service provider 118 may identify the same user as VP of engineering. Composite profiles 716 may include other service provider 118 provided information, such as company size, company location, company domain.

CCM 100 may use a first composite profile 716 when providing user segmentation for the first service provider 118. The first composite profile 716 may identify the user job title as VP of finance. CCM 100 may use a second composite profile 716 when providing user segmentation for the second service provider 118. The second composite profile 716 may identify the job title for the same user as VP of engineering. Composite profiles 716 are used in conjunction with user profiles 104 derived from other third party content.

In yet another example, CCM 100 may segment users based on event type. For example, CCM 100 may identify all the users that downloaded a particular article, or identify all of the users from a particular company that registered for a particular seminar.

### 3. Consumption Scoring Embodiments

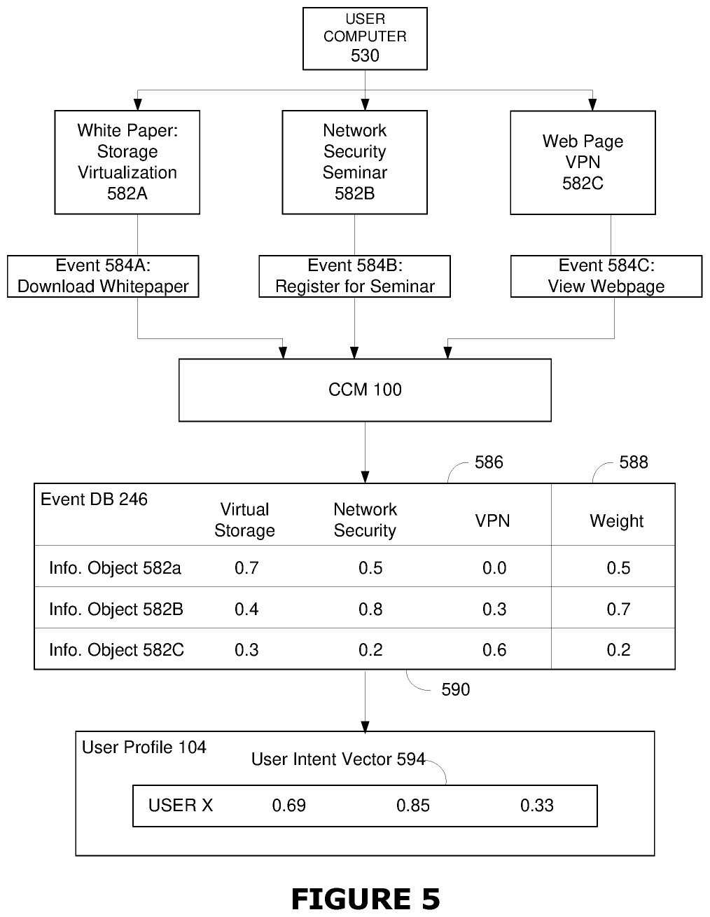

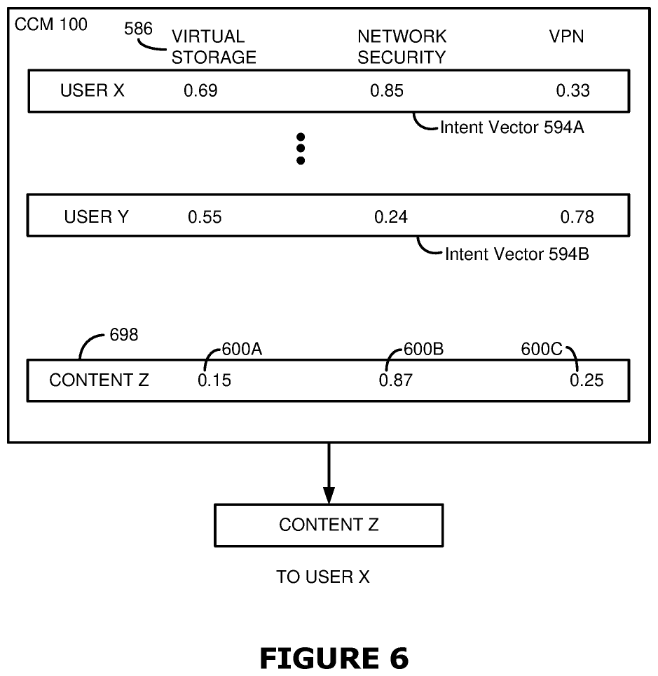

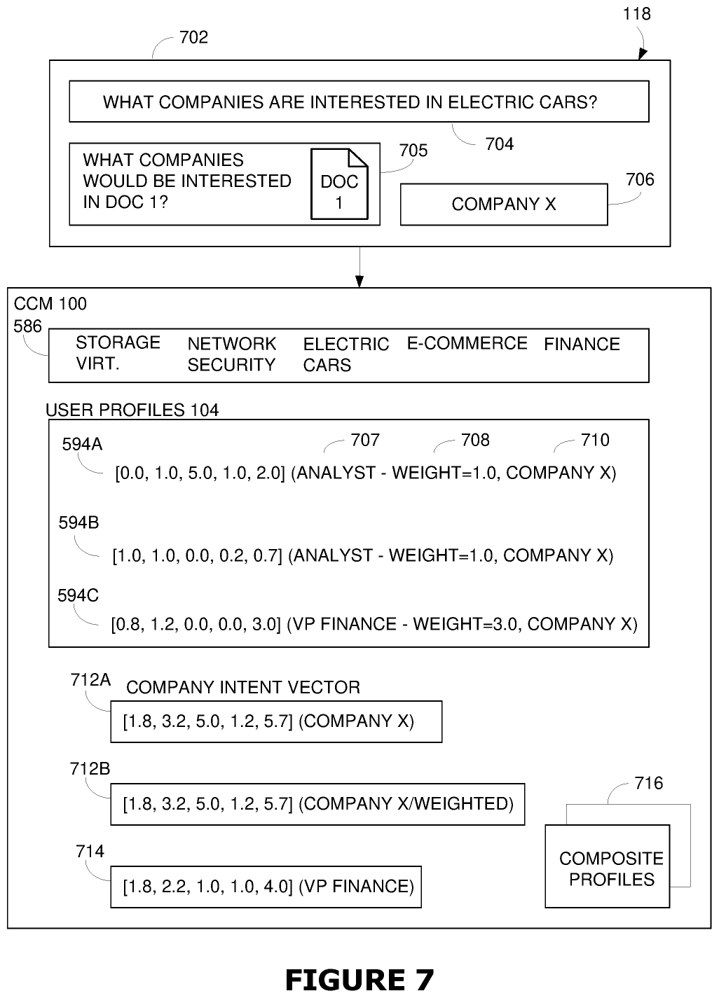

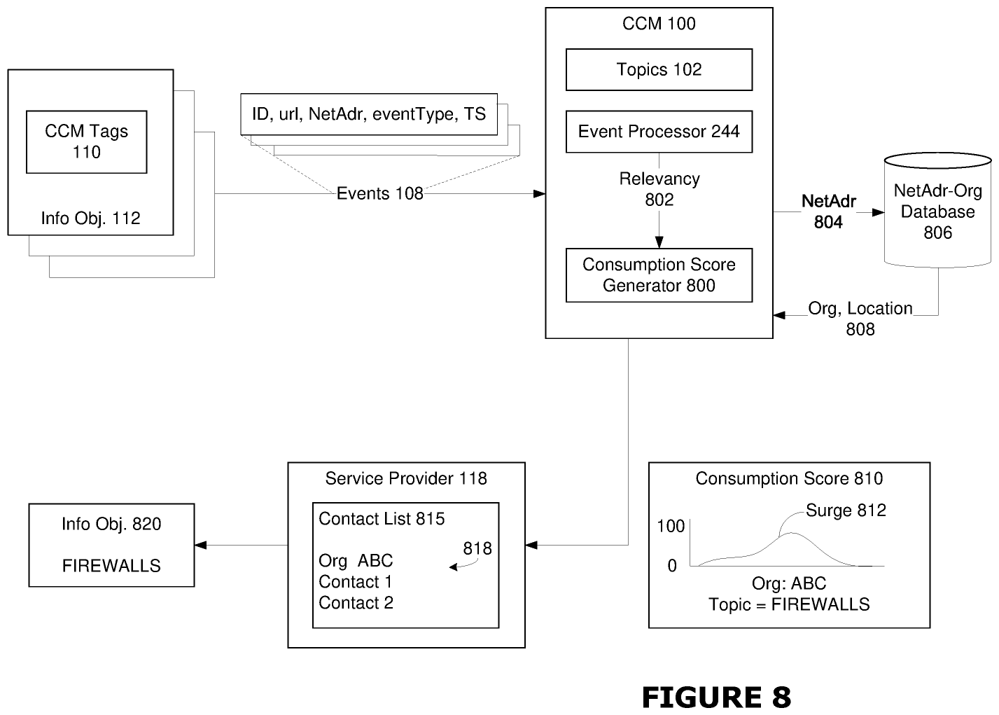

FIG. 8 depicts an example consumption score generator 800 used in CCM 100 according to various embodiments. As explained previously, CCM 100 may receive multiple events 108 associated with different InObs 112. For example, users may use client apps (e.g., web browsers, or any other application) to access or view InObs 112 from different resources (e.g., on different websites). The InObs 112 may include any webpage, electronic document, article, advertisement, or any other information viewable or audible by a user such as those discussed herein. In this example, InObs 112 may include a webpage article or a document related to network firewalls.

CCM tag 110 may capture events 108 identifying InObs 112 accessed by a user during a network or application session. For example, events 108 may include various event data such as an identifier (ID) (e.g., a user ID (userld), an application session ID, a network session ID, a device ID, a product ID, electronic product code (EPC), serial number, RFID tag ID, and/or the like), URL, network address (NetAdr), event type (eventType), and a timestamp (TS). The ID field may carry any suitable identifier associated with a user and/or user device, associated with a network session, an application, an app session, an app instance, an app session, an app-generated identifier, and/or a CCM tag 110 may generated identifier. For example, when a user ID is used, the user ID may be a unique identifier for a specific user on a specific client app and/or a specific user device. Additionally or alternatively, the userld may be or include one or more of a user ID (UID) (e.g., positive integer assigned to a user by a Unix-like OS), effective user ID (euid), file system user ID (fsuid), saved user id (suid), real user id (ruid), a cookie ID, a realm name, domain ID, logon user name, network credentials, social media account name, session ID, and/or any other like identifier associated with a particular user or device. The URL may be links, resource identifiers (e.g., Uniform Resource Identifiers (URIs)), or web addresses of InObs 112 accessed by the user during the session.

The NetAdr field includes any identifier associated with a network node. As examples, the NetAdr field may include any suitable network address (or combinations of network addresses) such as an internet protocol (IP) address in an IP network (e.g., IP version 4 (Ipv4), IP version 6 (IPv6), etc.), telephone numbers in a public switched telephone number, a cellular network address (e.g., international mobile subscriber identity (IMSI), mobile subscriber ISDN number (MSISDN), Subscription Permanent Identifier (SUPI), Temporary Mobile Subscriber Identity (TMSI), Globally Unique Temporary Identifier (GUTI), Generic Public Subscription Identifier (GPSI), etc.), an internet packet exchange (IPX) address, an X.25 address, an X.21 address, a port number (e.g., when using Transmission Control Protocol (TCP) or User Datagram Protocol (UDP)), a media access control (MAC) address, an Electronic Product Code (EPC) as defined by the EPCglobal Tag Data Standard, Bluetooth hardware device address (BD_ADDR), a Universal Resource Locator (URL), an email address, and/or the like. The NetAdr may be for a network device used by the user to access a network (e.g., the Internet, an enterprise network, etc.) and InObs 112.

As explained previously, the event type may identify an action or activity associated with InObs 112. In this example, the event type may indicate the user downloaded an electric document or displayed a webpage. The timestamp (TS) may identify a date and/or time the user accessed InObs 112, and may be included in the TS field in any suitable timestamp format such as those defined by ISO 8601 or the like.

Consumption score generator (CSG) 800 may access a NetAdr-Org database 806 to identify a company/entity and location 808 associated with NetAdr 804 in event 108. In one example, the NetAdr-Org database 806 may be a IP/company 806 when the NetAdr is a network address and the Orgs are entities such companies, enterprises, and/or the like. For example, existing services may provide databases 806 that identify the company and company address associated with network addresses. The NetAdr (e.g., IP address) and/or associated org may be referred to generally as a domain. CSG 800 may generate metrics from events 108 for the different companies 808 identified in database 806.

In another example, CCM tags 110 may include domain names in events 108. For example, a user may enter an email address into a webpage field during a web session. CCM 100 may hash the email address or strip out the email domain address. CCM 100 may use the domain name to identify a particular company and location 808 from database 806.

As also described previously, event processor 244 may generate relevancy scores 802 that indicate the relevancy of InObs 112 with different topics 102. For example, InObs 112 may include multiple words associate with topics 102. Event processor 244 may calculate relevancy scores 802 for InObs 112 based on the number and position words associated with a selected topic.

CSG 800 may calculate metrics from events 108 for particular companies 808. For example, CSG 800 may identify a group of events 108 for a current week that include the same NetAdr 804 associated with a same company and company location 808. CSG 800 may calculate a consumption score 810 for company 808 based on an average relevancy score 802 for the group of events 108. CSG 800 may also adjust the consumption score 810 based on the number of events 108 and the number of unique users generating the events 108.

CSG 800 generates consumption scores 810 for org 808 for a series of time periods. CSG 800 may identify a surge 812 in consumption scores 810 based on changes in consumption scores 810 over a series of time periods. For example, CSG 800 may identify surge 812 based on changes in content relevancy, number of unique users, number of unique user accesses for a particular InOb, a number of events over one or more time periods (e.g., several weeks), a number of particular types of user interactions with a particular InOb, and/or any other suitable parameters/criteria. It has been discovered that surge 812 corresponds with a unique period when orgs have heightened interest in a particular topic and are more likely to engage in direct solicitations related to that topic. The surge 812 (also be referred to as a “surge score 812” or the like) informs a service provider 118 when target orgs (e.g., org 808) are indicating active demand for the products or services that are offered by the service provider 118.

CCM 100 may send consumption scores 810 and/or any surge indicators 812 to service provider 118. Service provider 118 may store a contact list 815 that includes contacts 818 for org ABC. For example, contact list 815 may include email addresses or phone number for employees of org ABC. Service provider 118 may obtain contact list 815 from any source such as from a customer relationship management (CRM) system, commercial contact lists, personal contacts, third parties lead services, retail outlets, promotions or points of sale, or the like or any combination thereof.

In one example, CCM 100 may send weekly consumption scores 810 to service provider 118. In another example, service provider 118 may have CCM 100 only send surge notices 812 for companies on list 815 surging for particular topics 102.

Service provider 118 may send InOb 820 related to surge topics to contacts 818. For example, the InOb 820 sent by service provider 118 to contacts 818 may include email advertisements, literature, or banner ads related to firewall products/services. Alternatively, service provider 118 may call or send direct mailings regarding firewalls to contacts 818. Since CCM 100 identified surge 812 for a firewall topic at org ABC, contacts 818 at org ABC are more likely to be interested in reading and/or responding to content 820 related to firewalls. Thus, content 820 is more likely to have a higher impact and conversion rate when sent to contacts 818 of org ABC during surge 812.

In another example, service provider 118 may sell a particular product, such as firewalls. Service provider 118 may have a list of contacts 818 at org ABC known to be involved with purchasing firewall equipment. For example, contacts 418 may include the chief technology officer (CTO) and information technology (IT) manager at org ABC. CCM 100 may send service provider 118 a notification whenever a surge 812 is detected for firewalls at org ABC. Service provider 118 then may automatically send content 820 to specific contacts 818 at org ABC with job titles most likely to be interested in firewalls.

CCM 100 may also use consumption scores 810 for advertising verification. For example, CCM 100 may compare consumption scores 810 with advertising content 820 sent to companies or individuals. Advertising content 820 with a particular topic sent to companies or individuals with a high consumption score or surge for that same topic may receive higher advertising rates.

FIG. 9 shows a more detailed example of how the CCM 100 generates consumption scores 810 according to various embodiments. CCM 100 may receive millions of events 108 from millions of different users associated with thousands of different domains every day. CCM 100 may accumulate the events 108 for different time periods, such as daily, weekly, monthly, or the like. Week time periods are just one example and CCM 100 may accumulate events 108 for any selectable time period. CCM 100 may also store a set of topics 102 for any selectable subject matter. CCM 100 may also dynamically generate some of topics 102 based on the content identified in events 108 as described previously.

Events 108 as mentioned previously, and as shown by FIG. 9, may include an identifier (ID) 950 (e.g., a user ID, session ID, device ID, product ID/code, serial number, and/or the like), URL 952, network address 954, event type 956, and timestamp 958 (which may be collectively referred to as “event data” or the like). Event processor 244 identifies InObs 112 located at URL 942 and selects one of topics 102 for comparing with InObs 112. Event processor 244 may generate an associated relevancy score 802 indicating a relevancy of InObs 112 to selected topic 102. Relevancy score 802 may alternatively be referred to as a “topic score” or the like.

CSG 800 generates consumption data 960 from events 108. For example, CSG 800 may identify or determine an org 960A (e.g., “Org ABC” in FIG. 9) associated with network address 954. CSG 800 also calculates a relevancy score 960C between InObs 112 and the selected topic 960B. CSG 800 also identifies or determines a location 960D for with company 960A and identify a date 960E and time 960F when event 108 was detected.

CSG 800 generates consumption metrics 980 from consumption data 960. For example, CSG 800 may calculate a total number of events 970A associated with org 960A (e.g., Org ABC) and location 960D (e.g., location Y) for all topics during a first time period, such as for a first week. CSG 800 also calculates the number of unique users 972A generating the events 108 associated with org ABC and topic 960B for the first week. For example, CSG 800 may calculate for the first week a total number of events generated by org ABC for topic 960B (e.g., topic volume 974A). CSG 800 may also calculate an average topic relevancy 976A for the content accessed by org ABC and associated with topic 960B. CSG 800 may generate consumption metrics 980A-980C for sequential time periods, such as for three consecutive weeks.

CSG 800 may generate consumption scores 910 based on consumption metrics 980A-980C. For example, CSG 800 may generate a first consumption score 910A for week 1 and generate a second consumption score 910B for week 2 based in part on changes between consumption metrics 980A for week 1 and consumption metrics 980B for week 2. CSG 800 may generate a third consumption score 910C for week 3 based in part on changes between consumption metrics 980A, 980B, and 980C for weeks 1, 2, and 3, respectively. In one example, any consumption score 910 above as threshold value is identified as a surge 812.

Additionally or alternatively, the consumption metrics 980 may include metrics such as topic consumption by interactions, topic consumption by unique users, Topic relevancy weight, and engagement. Topic consumption by interactions is the number of interactions from an org in a given time period compared to a larger time period of historical data, for example, the number of interactions in a previous three week period compared to a previous 12 week period of historical data. Topic consumption by unique users refers to the number of unique individuals from an org researching relevant topics in a given time period compared to a larger time period of historical data, for example, the number of individuals from an org researching relevant topic in a previous three week period compared to a previous 12 week period of historical data. Topic relevancy weight refers to a measure of a content piece's ‘denseness’ in a topic of interest such as whether the topic is the focus of the content piece or sparsely mentioned in the content piece. Engagement refers to the depth of an org's engagement with the content, which may be based on an aggregate of engagement of individual users associated with the org. The engagement may be measured based on the user interactions with the InOb such as by measuring dwell time, scroll velocity, scroll depth, and/or any other suitable user interactions such as those discussed herein.

FIG. 10 depicts a process for identifying a surge in consumption scores according to various embodiments. At operation 1001, the CCM 100 identifies all domain events for a given time period. For example, for a current week the CCM 100 may accumulate all of the events for every network address (e.g., IP address, domain, or the like) associated with every topic 102.

The CCM 100 may use thresholds to select which domains to generate consumption scores. For example, for the current week the CCM 100 may count the total number of events for a particular domain (domain level event count (DEC)) and count the total number of events for the domain at a particular location (metro level event count (DMEC)).

The CCM 100 calculates the consumption score for domains with a number of events more than a threshold (DEC>threshold). The threshold can vary based on the number of domains and the number of events. The CCM 100 may use the second DMEC threshold to determine when to generate separate consumption scores for different domain locations. For example, the CCM 100 may separate subgroups of org ABC events for the cities of Atlanta, New York, and Los Angeles that have each a number of events DMEC above the second threshold.

At operation 1002, the CCM 100 determines an overall relevancy score for all selected domains for each of the topics. For example, the CCM 100 for the current week may calculate an overall average relevancy score for all domain events associated with the firewall topic.

At operation 1004, the CCM 100 determines a relevancy score for a specific domain. For example, the CCM 100 may identify a group of events 108 having a same network address associated with org ABC. The CCM 100 may calculate an average domain relevancy score for the org ABC events associated with the firewall topic.

At operation 1006, the CCM 100 generates an initial consumption score based on a comparison of the domain relevancy score with the overall relevancy score. For example, the CCM 100 may assign an initial low consumption score when the domain relevancy score is a certain amount less than the overall relevancy score. The CCM 100 may assign an initial medium consumption score larger than the low consumption score when the domain relevancy score is around the same value as the overall relevancy score. The CCM 100 may assign an initial high consumption score larger than the medium consumption score when the domain relevancy score is a certain amount greater than the overall relevancy score. This is just one example, and the CCM 100 may use any other type of comparison to determine the initial consumption scores for a domain/topic.

At operation 1008, the CCM 100 adjusts the consumption score based on a historic baseline of domain events related to the topic. This is alternatively referred to as consumption. For example, the CCM 100 may calculate the number of domain events for org ABC associated with the firewall topic for several previous weeks.

The CCM 100 may reduce the current week consumption score based on changes in the number of domain events over the previous weeks. For example, the CCM 100 may reduce the initial consumption score when the number of domain events fall in the current week and may not reduce the initial consumption score when the number of domain events rises in the current week.

At operation 1010, the CCM 100 further adjusts the consumption score based on the number of unique users consuming content associated with the topic. For example, the CCM 100 for the current week may count the number of unique user IDs (unique users) for org ABC events associated with firewalls. The CCM 100 may not reduce the initial consumption score when the number of unique users for firewall events increases from the prior week and may reduce the initial consumption score when the number of unique users drops from the previous week.

At operation 1012, the CCM 100 identifies or determines surges based on the adjusted weekly consumption score. For example, the CCM 100 may identify a surge when the adjusted consumption score is above a threshold.

FIG. 11 depicts in more detail the process for generating an initial consumption score according to various embodiments. It should be understood this is just one example scheme and a variety of other schemes may also be used in other embodiments.

At operation 1102, the CCM 100 calculates an arithmetic mean (M) and standard deviation (SD) for each topic over all domains. The CCM 100 may calculate M and SD either for all events for all domains that contain the topic, or alternatively for some representative (big enough) subset of the events that contain the topic. The CCM 100 may calculate the overall mean and standard deviation according to the following equations:

$$\begin{matrix}M = \frac{1}{n} * {\sum }_{1}^{n} {x}_{i} & [ Equation 1 ] \\ SD = \sqrt{\frac{1}{n - 1}} {\sum }_{1}^{n} {( {x}_{i} - M )}^{2} & [ Equation 2 ]\end{matrix}$$

Equation 1 may be used to determine a mean and equation may be used to determine a standard deviation (SD). In equations 1 and 2, xᵢ is a topic relevancy, and n is a total number of events.

At operation 1104, the CCM 100 calculates a mean (average) domain relevancy for each group of domain and/or domain/metro events for each topic. For example, for the past week the CCM 100 may calculate the average relevancy for org ABC events for firewalls.

At operation 1106, the CCM 100 compares the domain mean relevancy (DMR) with the overall mean (M) relevancy and over standard deviation (SD) relevancy for all domains. For example, the CCM 100 may assign at least one of three different levels to the DMR as shown by table 1.

TABLE 1

| | | |
|---|---|---|
| Low | DMR < M − 0.5 * SD | ~33% of all values |
| Medium | M − 0.5 * SD < DMR < M + 0.5 * SD | ~33% of all values |
| High | DMR > M + 0.5 * SD | ~33% of all values |

At operation 1108, the CCM 100 calculates an initial consumption score for the domain/topic based on the above relevancy levels. For example, for the current week the CCM 100 may assign one of the initial consumption scores shown by table 2 to the org ABC firewall topic. Again, this just one example of how the CCM 100 may assign an initial consumption score to a domain/topic.

TABLE 2

| Relevancy | Initial Consumption Score |
|---|---|
| High | 100 |
| Medium | 70 |
| Low | 40 |

FIG. 12 depicts one example of how the CCM 100 may adjust the initial consumption score according to various embodiments. These are also just examples and the CCM 100 may use other schemes for calculating a final consumption score in other embodiments. At operation 1201, the CCM 100 assigns an initial consumption score to the domain/location/topic as described previously in FIG. 11.

The CCM 100 may calculate a number of events for domain/location/topic for a current week. The number of events is alternatively referred to as consumption. The CCM 100 may also calculate the number of domain/location/topic events for previous weeks and adjust the initial consumption score based on the comparison of current week consumption with consumption for previous weeks.

At operation 1202, the CCM 100 determines if consumption for the current week is above historic baseline consumption for previous consecutive weeks. For example, the CCM 100 may determine is the number of domain/location/topic events for the current week is higher than an average number of domain/location/topic events for at least the previous two weeks. If so, the CCM 100 may not reduce the initial consumption value derived in FIG. 11.

If the current consumption is not higher than the average consumption at operation 542, the CCM 100 at operation 1204 determines if the current consumption is above a historic baseline for the previous week. For example, the CCM 100 may determine if the number of domain/location/topic events for the current week is higher than the average number of domain/location/topic events for the previous week. If so, the CCM 100 at operation 1206 reduces the initial consumption score by a first amount.

If the current consumption is not above than the previous week consumption at operation 1204, the CCM 100 at operation 1208 determines if the current consumption is above the historic consumption baseline but with interruption. For example, the CCM 100 may determine if the number of domain/location/topic events has fallen and then risen over recent weeks. If so, the CCM 100 at operation 1210 reduces the initial consumption score by a second amount.

If the current consumption is not above than the historic interrupted baseline at operation 1208, the CCM 100 at operation 1212 determines if the consumption is below the historic consumption baseline. For example, the CCM 100 may determine if the current number of domain/location/topic events is lower than the previous week. If so, the CCM 100 at operation 1214 reduces the initial consumption score by a third amount.

If the current consumption is above the historic base line at operation 1212, the CCM 100 at operation 1216 determines if the consumption is for a first-time domain. For example, the CCM 100 may determine the consumption score is being calculated for a new company or for a company that did not previously have enough events to qualify for calculating a consumption score. If so, the CCM 100 at operation 1218 may reduce the initial consumption score by a fourth amount.

In one example, the CCM 100 may reduce the initial consumption score by the following amounts. The CCM 100 may use any values and factors to adjust the consumption score in other embodiments.

Consumption above historic baseline consecutive weeks (operation 542). −0

Consumption above historic baseline past week (operation 544). −20 (first amount).

Consumption above historic baseline for multiple weeks with interruption (operation 548) −30 (second amount).

Consumption below historic baseline (operation 552). −40 (third amount).

First time domain (domain/metro) observed (operation 556). −30 (fourth amount).

As explained above, the CCM 100 may also adjust the initial consumption score based on the number of unique users. The CCM tags 110 in FIG. 8 may include cookies placed in web browsers that have unique identifiers. The cookies may assign the unique identifiers to the events captured on the web browser. Therefore, each unique identifier may generally represent a web browser for a unique user. The CCM 100 may identify the number of unique identifiers for the domain/location/topic as the number of unique users. The number of unique users may provide an indication of the number of different domain users interested in the topic.

At operation 1220, the CCM 100 compares the number of unique users for the domain/location/topic for the current week with the number of unique users for the previous week. The CCM 100 may not reduce the consumption score if the number of unique users increases over the previous week. When the number of unique users decrease, the CCM 100 at operation 1222 may further reduce the consumption score by a fifth amount. For example, the CCM 100 may reduce the consumption score by 10.

The CCM 100 may normalize the consumption score for slower event days, such as weekends. Again, the CCM 100 may use different time periods for generating the consumption scores, such as each month, week, day, hour, etc. The consumption scores above a threshold are identified as a surge or spike and may represent a velocity or acceleration in the interest of a company or individual in a particular topic. The surge may indicate the company or individual is more likely to engage with a service provider 118 who presents content similar to the surge topic. The surge helps service providers 118 identify the orgs in active research mode for the service providers' 118 products/services so the service providers 118 can proactively coordinate sales and marketing activities around orgs with active intent, and/or obtain or deliver better results with highly targeted campaigns that focus on orgs demonstrating intent around a certain topic.

### 4. Consumption DNA

One advantage of domain-based surge detection is that a surge can be identified for an org without using personally identifiable information (PII), sensitive data, or confidential data of the org personnel (e.g., company employees). The CCM 100 derives the surge data based on an org's network address without using PII, sensitive data, or confidential data associated with the users generating the events 108.

In another example, the user may provide PII, sensitive data, and/or confidential data during network/web sessions. For example, the user may agree to enter their email address into a form prior to accessing content. As described previously, the CCM 100 may anonymize (e.g., hash, or the like) the PII, sensitive data, or confidential data and include the anonymized data either with org consumption scores or with individual consumption scores.

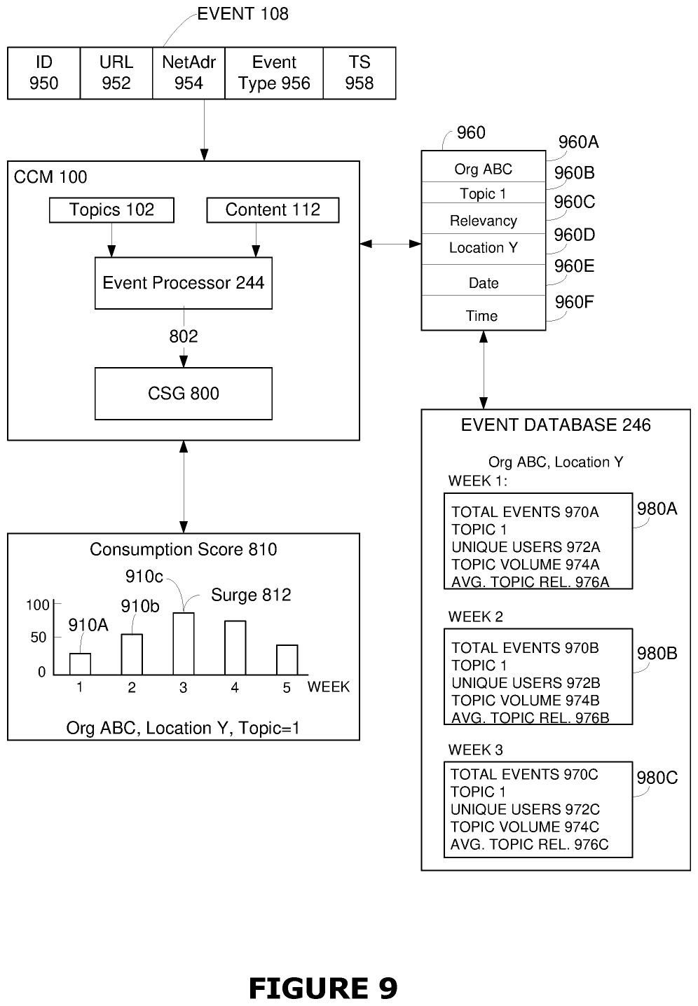

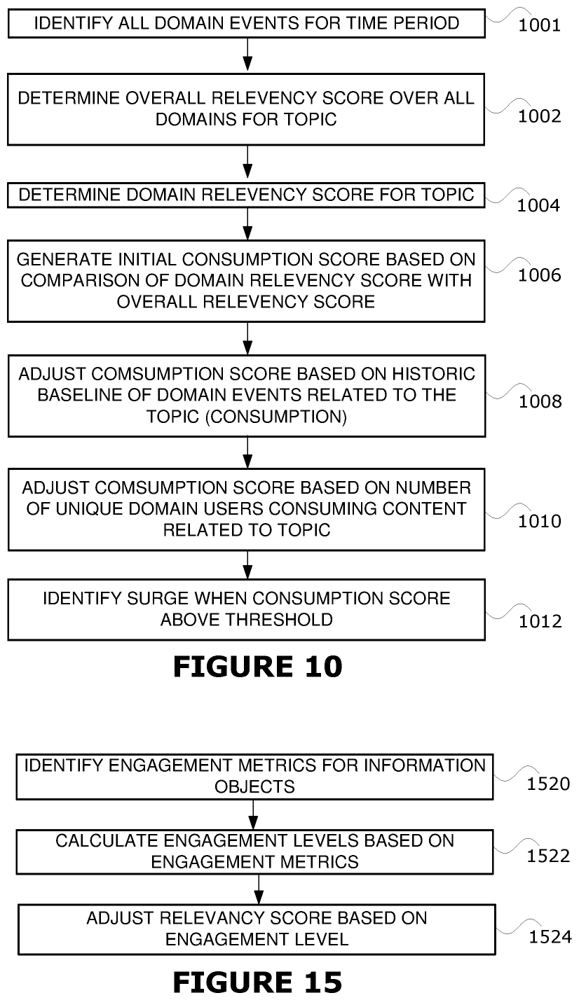

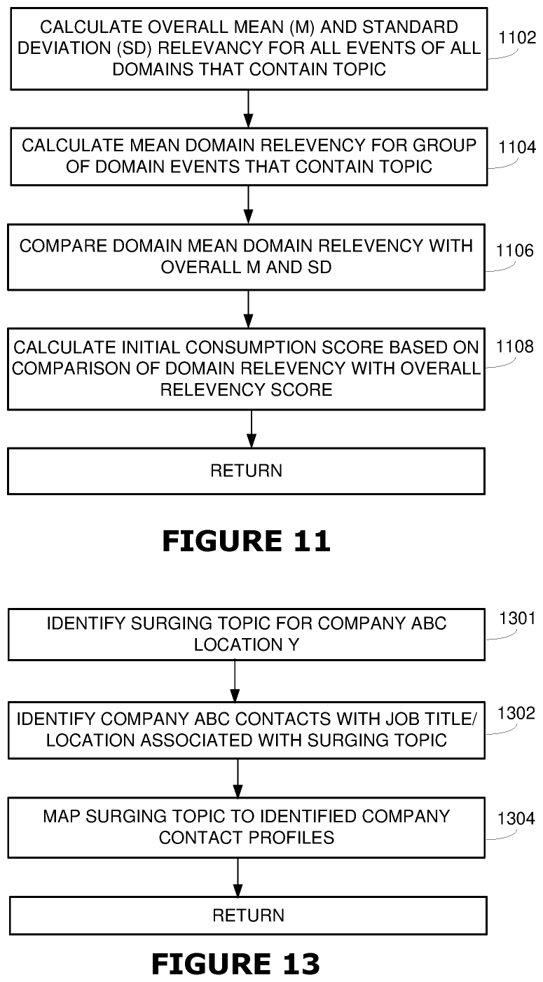

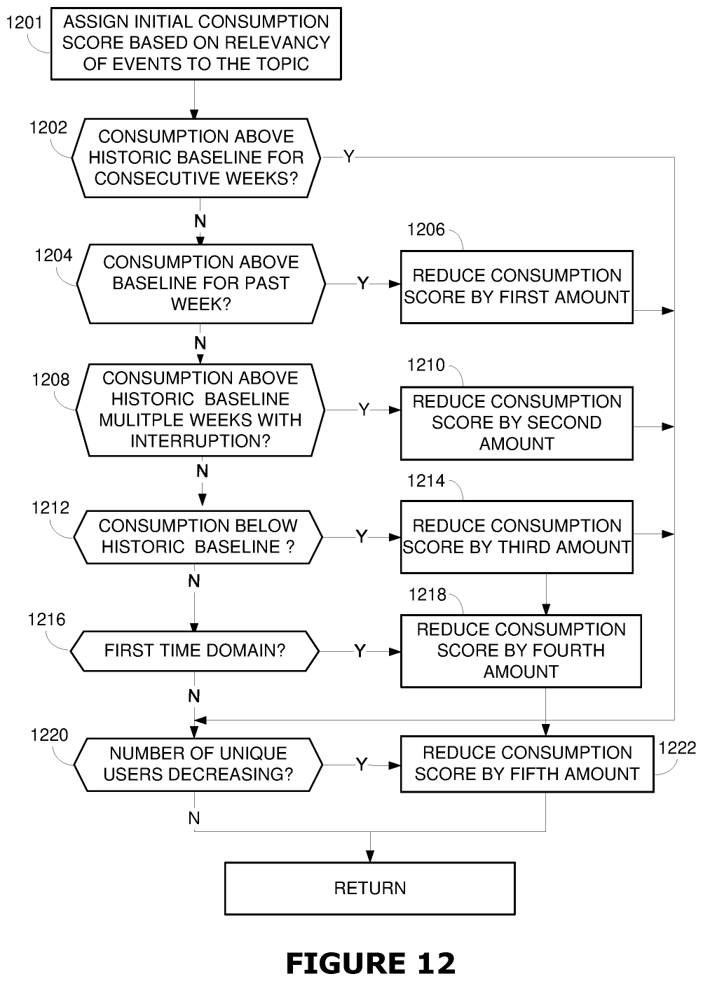

FIG. 13 shows an example process for mapping domain consumption data to individuals according to various embodiments. At operation 1301, the CCM 100 identifies or determines a surging topic for an org (e.g., org ABC at location Y) as described previously. For example, the CCM 100 may identify a surge 812 for org ABC in New York for firewalls.

At operation 1302, the CCM 100 identifies or determines users associated with org ABC. As mentioned previously, some org ABC personnel may have entered personal, sensitive, or confidential data, such as their office location and/or job titles into fields of webpages during events 108. In another example, a service provider 118 or other party may obtain contact information for employees of org ABC from CRM customer profiles or third party lists.

Either way, the CCM 100 or service provider 118 may obtain a list of employees/users associated with org ABC at location Y. The list may also include job titles and locations for some of the employees/users. The CCM 100 or service provider 118 may compare the surge topic with the employee job titles. For example, the CCM 100 or service provider may determine that the surging firewall topic is mostly relevant to users with a job title such as engineer, chief technical officer (CTO), or information technology (IT).

At operation 1304, the CCM 100 or service provider 118 maps the surging topic (e.g., firewall in this example) to profiles of the identified personnel of org ABC. In another example, the CCM 100 or service provider 118 may not be as discretionary and map the firewall surge to any user associated with org ABC. The CCM 100 or service provider then may direct content associated with the surging topic to the identified users. For example, the service provider may direct banner ads or emails for firewall seminars, products, and/or services to the identified users.

Consumption data identified for individual users is alternatively referred to as “Dino DNA” and the general domain consumption data is alternatively referred to as “frog DNA.” Associating domain consumption and surge data with individual users associated with the domain may increase conversion rates by providing more direct contact to users more likely interested in the topic.

The example embodiments described herein provide improvements to the functioning of computing devices and computing networks by providing specific mechanisms of collecting network session events 118 from user devices (e.g., computers 232 and 1404 of FIGS. 2 and 14, and platform 2100 of FIG. 21), accessing InObs 112, 114, determining the amount of traffic individual websites receive from user devices at or related to a specific domain name or network addresses at specific periods of time, and identifying spikes (surges 812). The collected data can be used to analyze the cause of the surge (e.g., relevant topics in specific InObs 112, 114), which provides a specific improvement over prior systems, resulting in improved network/traffic monitoring capabilities and resource consumption efficiencies. The embodiments discussed herein allows for the discovery of information from extremely large amounts of data that was not previously possible in conventional computing architectures.

Identifying spikes (e.g., surges) in traffic in this way allows content providers to better serve their content to specific users. Serving content to numerous users (e.g., responding to network request for content and the like) without targeting can be computationally intensive and can consume large amounts of computing and network resources, at least from the perspective of content providers, service providers, and network operators. The improved network/traffic monitoring and resource efficiencies provided by the present claims is a technological improvement in that content providers, service providers, and network operators can reduce network and computational resource overhead associated with serving content to users by reducing the overall amount of content served to users by focusing on the relevant content. Additionally, the content providers, service providers, and network operators could use the improved network/traffic monitoring to better adapt the allocation of resources to serve users a peak times in order to smooth out their resource consumption over time.

### 5. Intent Measurement

FIG. 14 depicts how CCM 100 may calculate consumption scores based on user engagement. A computer 1400 may operate a client app 1404 (e.g., a browser, desktop/mobile app, etc.) to access InObs 112, for example, by sending appropriate HTTP messages or the like, and in response, server-side application(s) may dynamically generate and provide code, scripts, markup documents, and/or other InOb(s) 112 to the client app 1404 to render and display InObs 112 within the client app 1404. As alluded to previously, InObs 112 may be a webpage or web app comprising a graphical user interface (GUI) including graphical control elements (GCEs) for accessing and/or interacting with a service provider (e.g., a service provider 118). The server-side applications may be developed with any suitable server-side programming languages or technologies, such as PHP; Java™ based technologies such as Java Servlets, JavaServer Pages (JSP), JavaServer Faces (JSF), etc.; ASP.NET; Ruby or Ruby on Rails; a platform-specific and/or proprietary development tool and/or programming languages; and/or any other like technology that renders HyperText Markup Language (HTML). The computer 1400 may be a laptop, smartphone, tablet, and/or any other device such as any of those discussed herein. In this example, a user may open the client app 1404 on a screen 1402 of computer 1400.

CCM tag 110 may operate within client app 1404 and monitor user web sessions. As explained previously, CCM tag 110 may generate events 108 for the web/network session that includes various event data 950-958 such as an ID 950 (e.g., a user ID, session ID, app ID, etc.), a URL 952 for accessed InObs 112, a network address 954 of a user/user device that accessed the InObs 112, an event type 956 that identifies an action or activity associated with the accessed InObs 112, and timestamp 958 of the events 108. For example, CCM tag 110 may add an event type identifier into event 108 indicating the user downloaded an InOb 112. In some embodiments, the events 108 may include also include an engagement metrics (EM) field 1410 to include engagement metrics (the data field/data element that carries engagement metrics, and the engagement metrics themselves may be referred to herein as “engagement metrics 1410” or “EM 1410”)

In one example, CCM tag 110 may generate a set of impressions, which is alternatively referred to as engagement metrics 1410, indicating actions taken by the user while consuming InObs 112 (e.g., user interactions). For example, engagement metrics 1410 may indicate how long the user dwelled on InObs 112, how the user scrolled through InObs 112, and/or the like. Engagement metrics 1410 may indicate a level of engagement or interest a user has in InObs 112. For example, the user may spend more time on the webpage and scroll through webpage at a slower speed when the user is more interested in the InObs 112.

In embodiments, the CCM 100 calculates an engagement score 1412 for InObs 112 based on engagement metrics 1410. CCM 100 may use engagement score 1412 to adjust a relevancy score 802 for InObs 112. For example, CCM 100 may calculate a larger engagement score 1412 when the user spends a larger amount of time carefully paging through InObs 112. CCM 100 then may increase relevancy score 802 of InObs 112 based on the larger engagement score 1412. CSG 800 may adjust consumption scores 910 based on the increased relevancy 802 to more accurately identify domain surge topics. For example, a larger engagement score 1412 may produce a larger relevancy 802 that produces a larger consumption score 910.

FIG. 15 depicts an example process for calculating the engagement score for content according to various embodiments. At operation 1520, the CCM 100 identifies or determines engagement metrics 1410 for InObs 112. In embodiments, the CCM 100 may receive events 100 that include content engagement metrics 1410 for one or more InObs 112. The engagement metrics 1410 for InObs 112 may be content impressions or the like. As examples, the engagement metrics 1410 may indicate any user interaction with InObs 112 including tab selections that switch to different pages, page movements, mouse page scrolls, mouse clicks, mouse movements, scroll bar page scrolls, keyboard page movements, touch screen page scrolls, eye tracking data (e.g., gaze locations, gaze times, gaze regions of interest, eye movement frequency, speed, orientations, etc.), touch data (e.g., touch gestures, etc.), and/or any other content movement or content display indicator(s).

At operation 1522, the CCM 100 identifies or determines engagement levels based on the engagement metrics 1410. In one example at operation 1522, the CCM 100 identifies/determines a content dwell time. The dwell time may indicate how long the user actively views a page of content. In one example, tag 110 may stop a dwell time counter when the user changes page tabs or becomes inactive on a page. Tag 110 may start the dwell time counter again when the user starts scrolling with a mouse or starts tabbing. Additionally or alternatively at operation 1522, the CCM 100 identifies/determines, from the events 108, a scroll depth for the content. For example, the CCM 100 may determine how much of a page the user scrolled through or reviewed. In one example, the CCM tag 110 or CCM 100 may convert a pixel count on the screen into a percentage of the page. Additionally or alternatively at operation 1522, the CCM 100 identifies/determines an up/down scroll speed. For example, dragging a scroll bar may correspond with a fast scroll speed and indicate the user has less interest in the content. Using a mouse wheel to scroll through content may correspond with a slower scroll speed and indicate the user is more interested in the content. Additionally or alternatively at operation 1522, the CCM 100 identifies/determines various other aspects/levels of the engagement based on some or all of the engagement metrics 1410 such as any of those discussed herein. In some embodiments, the CCM 100 may assign higher values to engagement metrics 1410 (e.g., impressions) that indicate a higher user interest and assign lower values to engagement metrics that indicate lower user interest. For example, the CCM 100 may assign a larger value at operation 1522 when the user spends more time actively dwelling on a page and may assign a smaller value when the user spends less time actively dwelling on a page.

At operation 1524, the CCM 100 calculates the content engagement score 1412 based on the values derived at operations 1520-1522. For example, the CCM 100 may add together and normalize the different values derived at operations 1520-1522. Other operations may be performed on these values in other embodiments.

At operation 1526, the CCM 100 adjusts relevancy values (e.g., relevancy scores 802) described previously in FIGS. 1-14 based on the content engagement score 1412. For example, the CCM 100 may increase the relevancy values (e.g., relevancy scores 802) when the InOb(s) 112 has/have a high engagement score and decrease the relevancy (e.g., relevancy scores 802) for a lower engagement scores.

CCM 100 or CCM tag 110 in FIG. 14 may adjust the values assigned at operations 1520-1524 based on the type of device 1400 used for viewing the content. For example, the dwell times, scroll depths, and scroll speeds, may vary between smartphone, tablets, laptops and desktop computers. CCM 100 or tag 110 may normalize or scale the engagement metric values so different devices provide similar relative user engagement results.

By providing more accurate intent data and consumptions scores in the ways discussed herein allows service providers 118 to conserve computational and network resources by providing a means for better targeting users so that unwanted and seemingly random content is not distributed to users that do not want such content. This is a technological improvement in that it conserves network and computational resources of service providers 118 and/or other organizations (orgs) that distribute this content by reducing the amount of content generated and sent to end-user devices. End-user devices may reduce network and computational resource consumption by reducing or eliminating the need for using such resources to obtain (download) and view unwanted content. Additionally, end-user devices may reduce network and computational resource consumption by reducing or eliminating the need to implement spam filters and reducing the amount of data to be processed when analyzing and/or deleting such content.

Furthermore, unlike conventional targeting technologies, the embodiments herein provide user targeting based on surges in interest with particular content, which allows service providers 118 to tailor the timing of when to send content to individual users to maximize engagement, which may include tailoring the content based on the determined locations. This allows content providers to spread out the content distribution over time. Spreading out content distribution reduces congestion and overload conditions at various nodes within a network, and therefore, the embodiments herein also reduce the computational burdens and network resource consumption on the content providers 118, content distribution platforms, and Internet Service Providers (ISPs) at least when compared to existing/conventional mass/bulk distribution technologies.

### 6. Machine Learning Model and Hyperparameter Optimization Embodiments

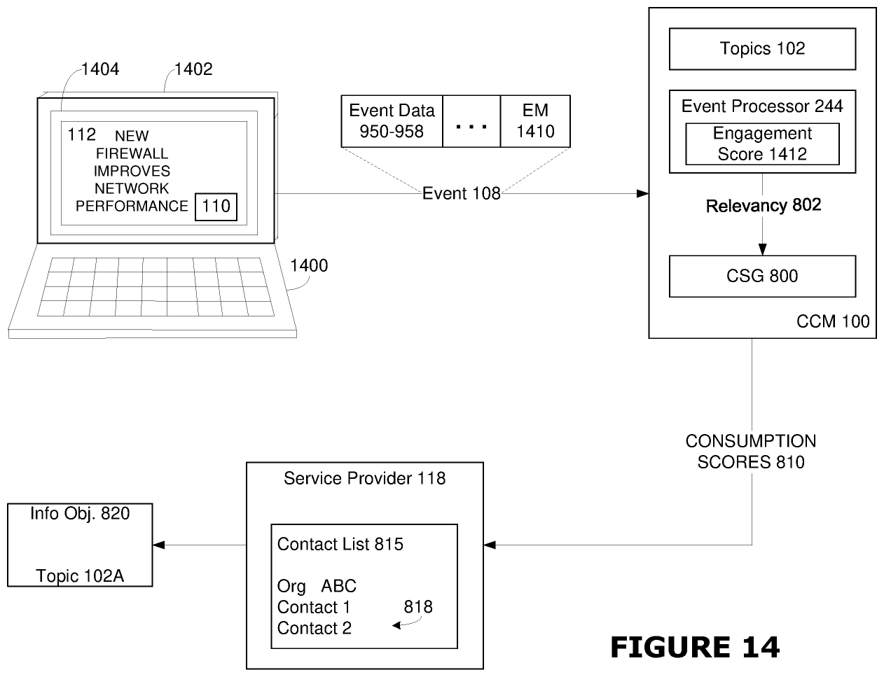

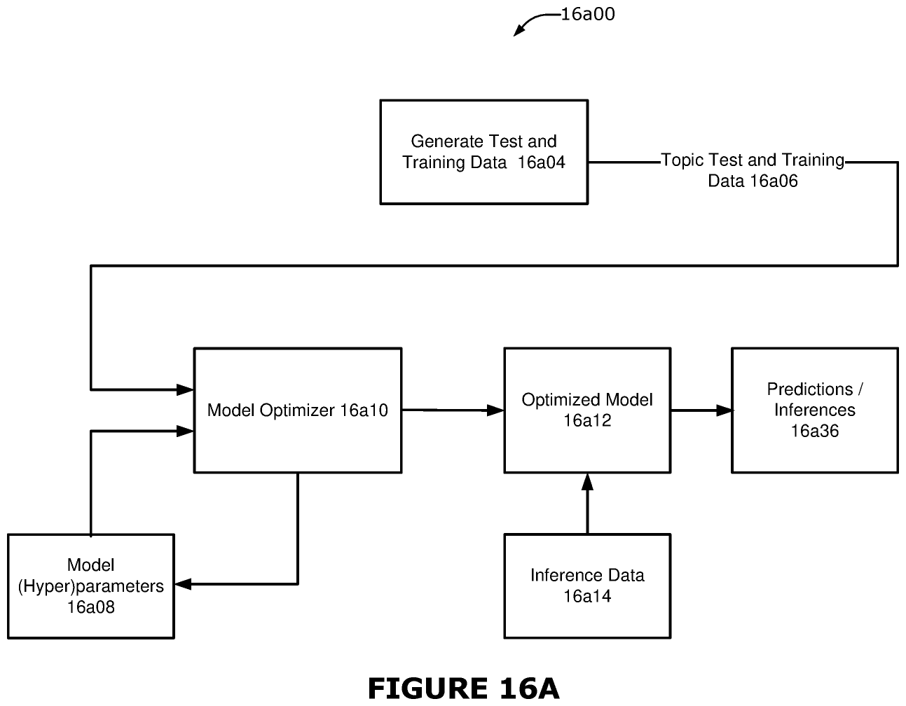

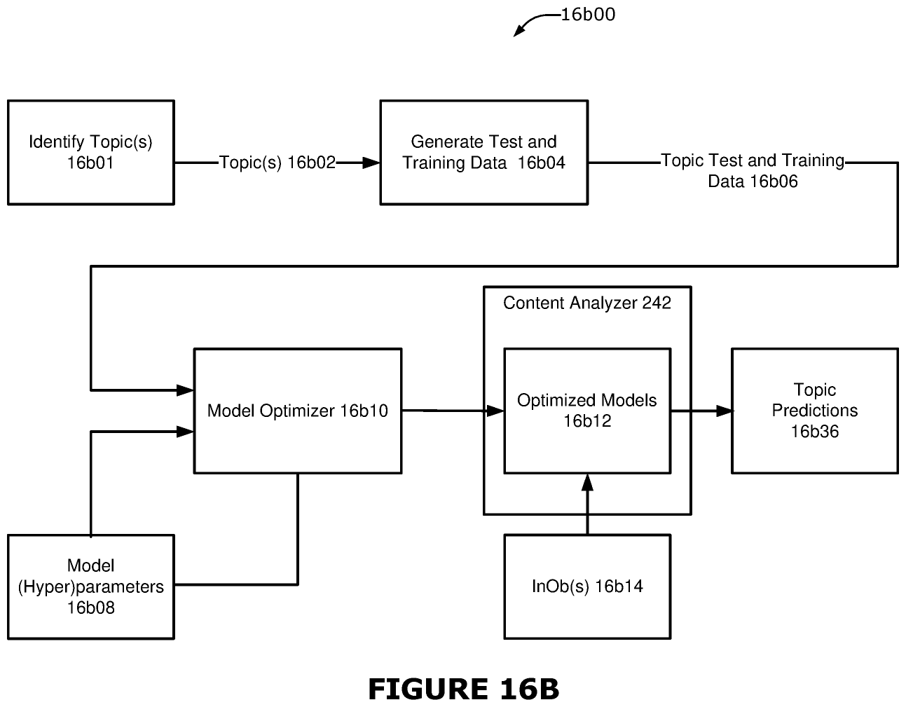

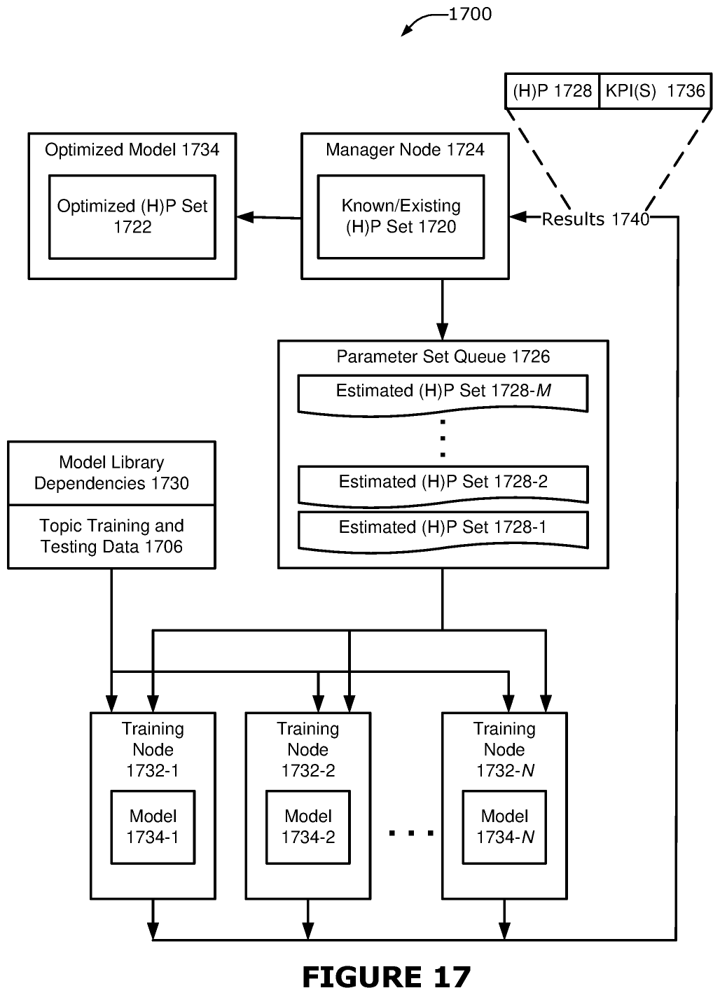

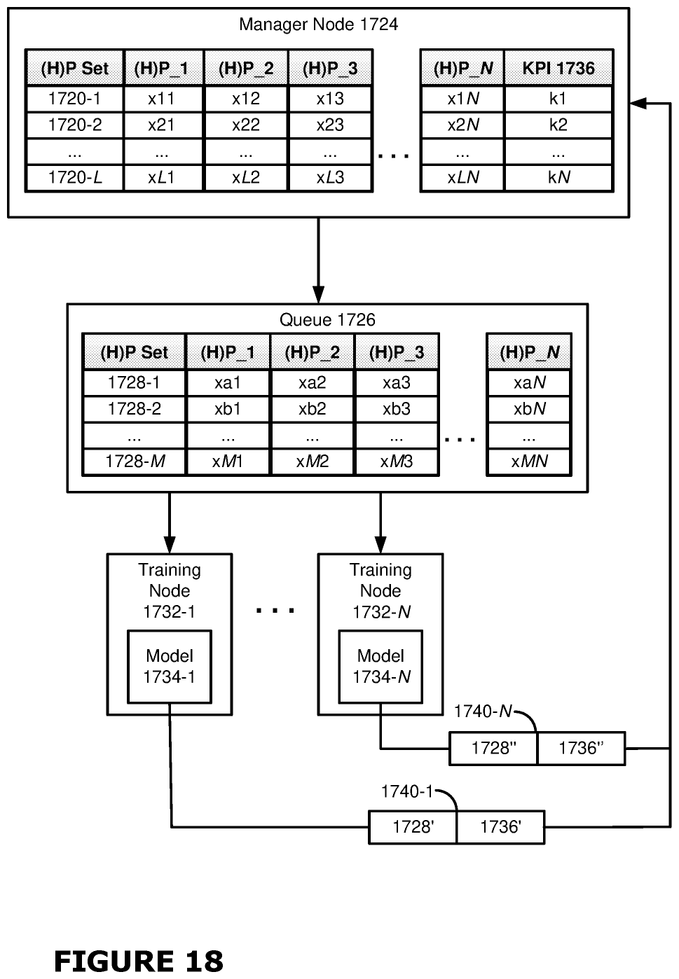

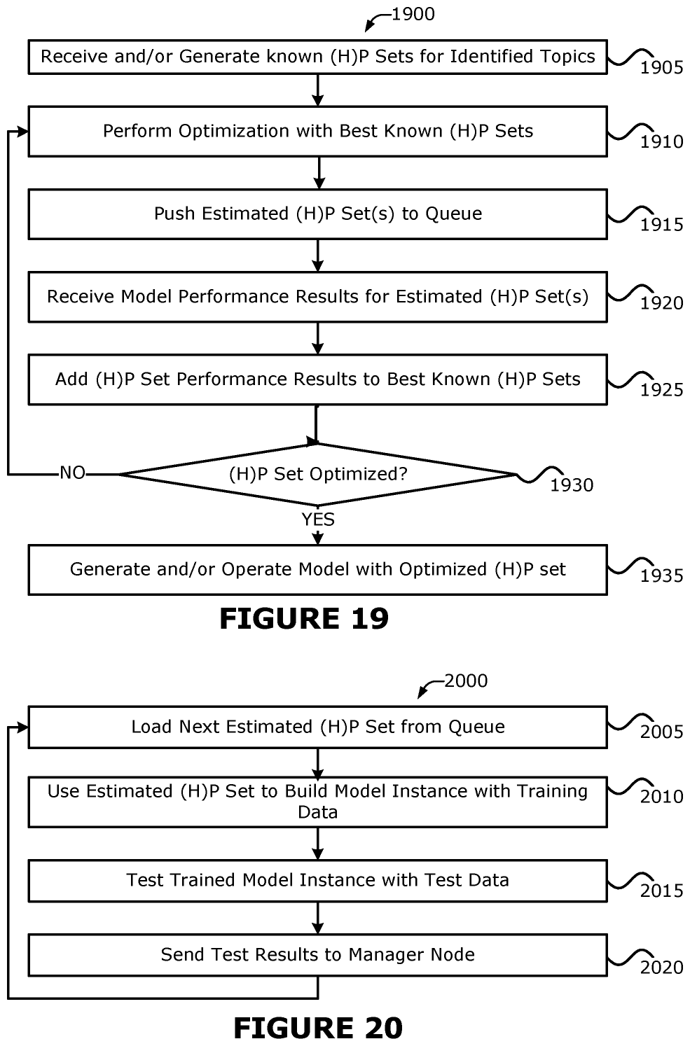

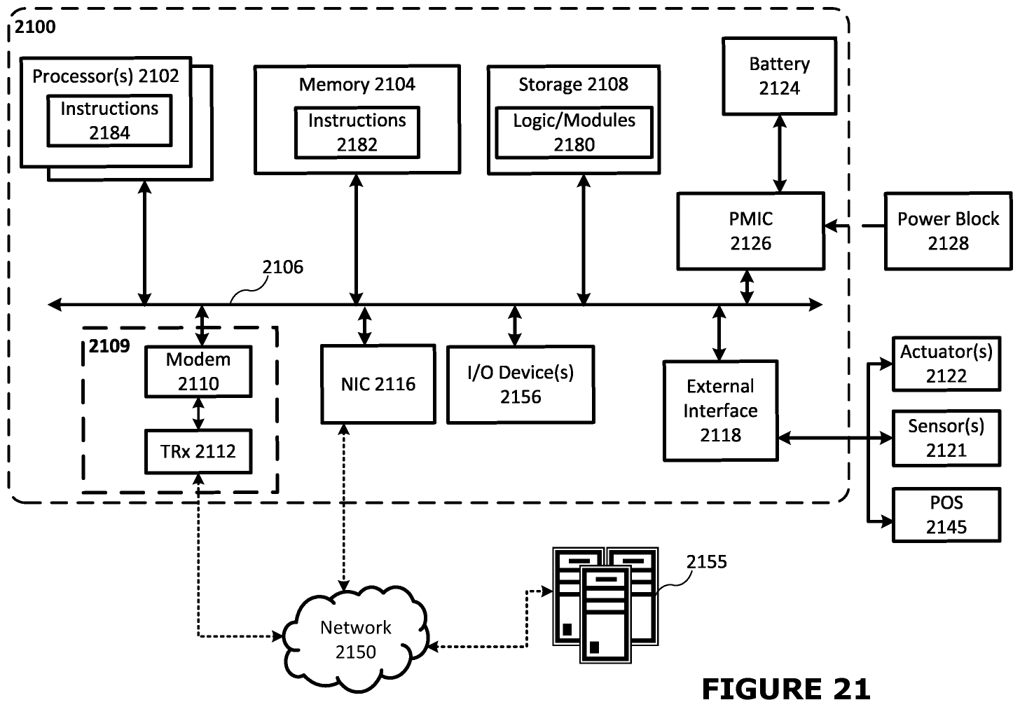

FIG. 16a shows model optimization architecture 16a00 according to various embodiments. Model optimizer 16a10 is used to improve predictions and/or inferences 16a36 generated by one or more ML models 16a12. In some implementations, the ML model 16a12 may be developed to address a specific use case using ML algorithms during operation. In some implementations, the ML model 16a12 and/or the model optimization architecture 16a00 as a whole may be part of an ML workflow. An ML workflow refers to one or more processes for developing an ML model (e.g., ML model 16a12) including, for example, data collection, data preparation/processing, model building, model training, model deployment, model execution, model validation, and continuous model self-monitoring and self-learning/retraining (e.g., backpropagation and the like).

In this example, model optimization architecture 16a00 includes generation 16a04 of a set of training and test data 16a06. The training/test data set 16b06 are generated for training and testing the model 16a12. The training/test data set 16a06 includes training data for supervised training of the model 16a12. The model 16a12 is initially fit on the training data (or a training dataset), which is a set of examples used to fit the parameters of the model 16a12.

The training dataset may include multiple data pairs, each of which including an input vector (or scalar) and the corresponding output vector (or scalar), where an answer key is commonly denoted as the “target” or “label”. The model 16a12 is run with the training dataset and produces a result, which is then compared with the target, for each input vector in the training dataset. Based on the result of the comparison and the specific ML algorithm being used, the parameters of the model are adjusted. The model fitting can include both variable selection and parameter estimation. Additionally, the training/test data set 16a06 may include validation data (or a validation dataset). The fitted model 16a12 is used to predict the responses for the observations in the validation dataset. The validation dataset provides an unbiased evaluation of the model's 16a12 fit on the training dataset while tuning the model's 16a12 HPs (e.g., the number of hidden units, layers, and layer widths in a neural network and/or the like). Additionally or alternatively, the training/test data set 16a06 includes a test dataset, which is a dataset used to provide an unbiased evaluation of a final model 16a12 fit on the training dataset. The term “validation dataset” is sometimes used instead of “test dataset” (e.g., if the original dataset was partitioned into only two subsets)

The model optimizer 16a10 also obtains model parameters and/or hyperparameters 16a08 (collectively referred to as “(hyper)parameters” or “(H)Ps” 16a08) for operating and/or training model 16a12. In various implementations, the initial set of (H)Ps 16a08 may be selected by a developer/data scientist, selected at random, learned from another ML model, and/or be based on and/or included with the training/test data set 16a06. The model optimizer 16a10 generates a new/different set of (H)Ps 16a08 using a suitable optimization process. The model optimizer 16a10 optimizes the (H)Ps 16a08 in an iterative process until a most optimal set of (H)Ps 16a08 are determined.

As examples, (H)Ps 16a08 may include and/or specify model coefficients, independent variables, dependent variables, weights, biases, batch size, momentum parameter, vector attributes (e.g., size, dimension, etc.), number of vectors, number of epochs (e.g., training iterations), minimum error (e g , minimum mean square error of an epoch), weight initialization, activation function type, cost function type, optimizer type, learning rate, decay rate, dropout rate, unit type (e.g., sigmoid, tanh etc.), number of inputs of a layer, number of outputs from a layer, whether or not a layer contains biases, weights of connections (e.g., when neural networks are used), number of neurons/processing elements (PEs) per hidden layer (e.g., when neural networks are used), number of hidden layers (e.g., when neural networks are used), neuron/PE network topology (e.g., when neural networks are used), a degree of polynomial features to be used for a linear model, a maximum depth allowed for a decision tree, minimum number of samples required at a leaf node in a decision tree, number of trees to be included in a random forest, and/or any other (H)Ps such as those discussed herein. Model optimizer 16a10 uses (H)Ps 16a08 to train model 16a12 with training data 16b06. Generally, training models with training data is known to those skilled in the art and is therefore not explained in further detail.

In some implementations, the model optimizer 16a10 may use a Bayesian optimization to more efficiently identify optimal (H)Ps 16a08 in a multi-dimensional parameter space. In these implementations, the model optimizer 16a10 manages the next area of search (or search space). In particular, the model optimizer 16a10 attempts to find an n dimensional parameter space (where n is a number). Model optimizer 16a10 may use a Bayesian optimization on multiple sets of (H)Ps with known performance values to predict a next improved set of model parameters. As discussed in more detail infra, the model optimizer 16a10 performs (H)P optimization in parallel using a manager node (also referred to as a “main node” or the like) and set of worker nodes. The manager node provides a different set of (H)Ps 16a08 to each worker node, and each worker trains the model 16a12 using their respective (H)P sets 16a08. Each worker node performs the training by calling and operating a training function that is defined in terms of one or more precision metrics. Using the optimized (H)Ps 16a08, one or more optimized models 16a12 are produced, which are used to generate predictions/inferences 16a36 using inference data 16a14. The inference data 16a14 may include any information/data to be used as input for the ML model 16a12 for producing predictions/inferences 16a36. The inference data 16a14 and training data 16a06 may largely overlap in some cases, however, these data are logically different.

Model optimizer 16a10 may use a suitable optimization technique (e.g., Bayesian optimization) in combination with the distributed model training and testing architecture to more quickly identify a set of (H)Ps 16a08 that optimize the performance of the model 16a12. This combination yields more optimal results, uses less computational resources, and is magnitudes faster than using Bayesian optimization alone or using any other (H)P optimization technique.

FIG. 16b shows another example model optimization architecture 16b00 according to various embodiments. In this embodiments, a model optimizer 16b10 is used in or by CCM 100 to enhance topic predictions. The model optimizer 16b10 may be the same or similar as model optimizer 16a10 and CCM 100 may operate as discussed previously with respect to FIGS. 1-15. Model optimizer 16b10 may improve topic predictions 16b36 generated by a topic classification (TC) model 16b12 used by content analyzer 242. TC model 16b12 may refer to any analytic tool used for detecting topics in content and in at least one example may refer to an analytic tool that generates topic prediction values 16b36 that predict the likelihood content 114 refers to different topics 16b02.

In this example, model optimization architecture 16b00 includes identification 16b01 of a set of topics 16b02. The set of topics 16b02 may be identified using one or more suitable topic identification ML techniques, such as by topic classification, topic modeling, NLP, and/or NLU techniques. In one example, an org may identify a set of topics 16b02 related to products or services the company is interested in selling to consumers. Topics 16b02 may include any subject or include any information that an entity wishes to identify in InOb(s) 16b14. In one example, an entity may wish to identify users that access InOb(s) 16b14 that includes particular topics 16b02 as described previously.

The model optimization architecture 16b00 also includes generation 16b04 of a set of training and test data 16b06 for training and testing model 16b12. Generation 16b04 of training and test data 16b06 may be done in a same or similar manner as generation 16a04 of training and test data 16a06 discussed previously. In one example, a technician may select a sample set of webpages, white papers, technical documents, etc. that discuss or refer to selected topics 16b02. Training and test data 16b06 may use different words, phrases, contexts, terminologies, etc. to describe or discuss topics 16b02. Model optimizer 16b10 may generate model (H)Ps 16b08 for training model 16b12. As examples, (H)Ps 16b08 may specify a number of words to analyze, content length, word vectors (e.g., size, dimension, etc.), number of vectors (e,g, word vectors), number of epochs, number of hidden layers (e.g., when neural networks are used), number of neurons per hidden layer (e.g., when neural networks are used), weight initialization, activation function type, cost function type, optimizer type, learning rate, decay rate, dropout rate, and/or any other suitable (H)Ps such as those discussed herein (e.g., (H)Ps 16a08 or the like). Model optimizer 16b10 uses (H)Ps 16b08 to train model 16b12 with training data 16b06. Generally, training models with training data is known to those skilled in the art and is therefore not explained in further detail.

In one example implementation, a continuous representation is used to represent words of InOb(s) 16b14. Conventional topic model techniques represent each word using a digit. In this example implementation, each word is represented as a vector referred to as a “word vector”. The word vector can be or store a combination of numbers and/or other information where all of the numbers and/or other information in the word vector are trained. Normally, the length of a vector represents how much information that the vector could contain, and may include information such as grammar, semantics, or higher concepts. In this example implementation, before the training process begins, the word vectors are initialized randomly, or to include random information, and the model 16b12 (or word vectors) will eventually be populated with values that contain useful information during model training. For example, the values that populate the word vector(s) may include male-female relationships, which may be formed where the distance between “king” and “queen” would be the same as the distance between “men” and “women.” In another example, verb tense relationships may be formed where the distance between “swimming” to “swim” is the same as the distance between “walking” and “walked.” In another example, geographic and/or political relationships may be formed where countries to capitals are expressed. In another example, synonyms and/or antonyms may have same or similar distances from one another. Additionally or alternatively, numbers, languages (e.g., English, French, Italian, etc.), and/or any other semantic elements may be clustered together and be represented in the word vector(s).

Additional or alternative features or feature vectors of InOb(s) 16b14 may be used to train model 16b12. Examples of such features may include, but are not limited to the features described in Table F1.

TABLE F1

| | Feature | |
|---|---|---|
| Feature | Name | Description |
| Feature | Structural | structural semantics F1 may be generated based on |
| F1 | Semantics | the structural relationships between InOb(s) 16b14 |
| | | such as webpages provided by references/links such |
| | | as hyperlinks |
| Feature | Content | Content semantics F2 may capture the language and |
| F2 | Semantics | metadata semantics of content contained within |
| | | InOb(s) 16b14 such as webpages. |
| Feature | Topics | Topic features include identified topics contained |
| F3 | Semantics | in InOb(s) 16b14. Semantic features may include |
| | | semantic relationships between two or more words |
| | | or topics. |
| Feature | Content | Content interaction behavior is alternatively |
| F4 | Interaction | referred to as content consumption or content use |
| | Behavior | |
| Feature | Entity | The entity type feature identifies types or locations |
| F5 | Type | of industries, companies, organizations, bot-based |
| | | applications or users accessing the InOb(s) 16b14 |
| Feature | Lexical | Lexical semantics refers to the grammatical structure |
| F6 | Semantics | of information objects 16b14, and the relationships |
| | | between individual words in a particular context. |

Content semantics (feature F2) capture the language and metadata semantics of content contained within InOb(s) 16b14. For example, a trained NLP/NLU ML model may predict topics associated with the InOb(s) 16b14, such as sports, religion, politics, fashion, or travel. Of course, any other topic taxonomy may be considered to predict topics from webpage content. In addition, content metadata, such as the breath of content, number of pages of content, number of words in webpage content, number of topics in InOb(s) 16b14, number of changes in webpage content, etc., can be identified/determined. Content semantics F2 also may include any other HTML elements that may be associated with different types of resources, such as Iframes, document object models (DOMs), etc.

Topic semantics (feature F3) may involve identifying topics and generating associated topic vectors as described previously with respect to FIGS. 1-15. For example, CCM 100 may identify different business-related topics (e.g., B2b topics) in each InOb(s) 16b14, such as, for example, network security, servers, virtual private networks, and/or any other topic(s).

Content interaction behavior (feature F4) identifies patterns of user interaction/consumption with InOb(s) 16b14. Types of user consumption reflected in feature F4 may include, but is not limited to time of day, day of week, total amount of content consumed/viewed by the user, device type, percentages of different device types used for accessing InOb(s) 16b14, duration of time users spend on a particular InOb 16b14, total engagement a user has on the InOb(s) 16b14, the number of distinct user profiles accessing the InOb(s) 16b14 vs. total number of events for the InOb(s) 16b14, dwell time, scroll depth, scroll velocity, variance in content consumption over time, tab selections that switch to different InOb(s) 16b14, page movements, mouse page scrolls, mouse clicks, mouse movements, scroll bar page scrolls, keyboard page movements, touch screen page scrolls, eye tracking data (e.g., gaze locations, gaze times, gaze regions of interest, eye movement frequency, speed, orientations, etc.), touch data (e.g., touch gestures, etc.), and/or the like. Identifying different event types associated with these different user content interaction behaviors (consumption) and associated engagement scores is described in more detail herein. For example, the content interaction feature F4 may be based on the event types and engagement metrics identified in events 108 associated with each InOb 16b14.

In one example for Feature F5, the entity type feature identifies types or locations of industries, companies, organizations, bot-based applications or users accessing a particular InOb 16b14. For example, the CCM 100 may identify each user event 108 as associated with a particular enterprise, institution, mobile network operator, bots/crawls and/or other applications, and the like. Details on how to identify types of orgs and/or locations from which InOb(s) 16b14 are accessed is described in U.S. application Ser. No. 17/153,673, filed Jan. 20, 2021, which is hereby incorporated by reference in its entirety.

Lexical semantics (feature F6) may be derived from an initial NLP/NLU analysis of the InOb(s) 16b14 to identify lexical aspects of the InOb(s) 16b14. As examples, these lexical aspects may include hyponyms (specific lexical items of a generic lexical item (hypernym), meronom (a logical arrangement of text and words that denotes a constituent part of or member of something), polysemy (a relationship between the meanings of words or phrases, although slightly different, share a common core), synonyms (words that have the same sense or nearly the same meaning as another), antonyms (words that have close to opposite meanings), homonyms (two words that are sound the same and are spelled alike but have a different meaning), and/or the like.

Each word vector and/or feature may represent an instance of a natural language structure for a set of InOb(s) 16b14. Suitable word embedding techniques in NLP, such as Word2Vec (see e.g., Mikolov et al., “Efficient Estimation of Word Representations in Vector Space.” arXiv preprint arXiv:1301.3781 (16 Jan. 2013), which is hereby incorporated by reference in its entirety) are used to convert individual words found across numerous examples of sentences within a corpus of documents into low-dimensional vectors, capturing the semantic structure of their proximity to other words, as exists in human language. Similarly, website/network (graph) embedding techniques such as Large-scale Information Network Embedding (LINE), Graph Neural Network (GNN) such as DeepWalk (see e.g., Perozzi et al., “DeepWalk: Online Learning of Social Representations”, arXiv:1403.6652v2 (27 Jun. 2014), available at: https://arxiv.org/pdf/1403.6652.pdf; 10 pages, which is hereby incorporated by reference in its entirety), GraphSAGE (see e.g., Hamilton et al., “Inductive Representation Learning on Large Graphs”, arXiv:1706.02216v4 (10 Sep. 2018), which is hereby incorporated by reference in its entirety), or the like can be used to convert sequences of InObs 112 found across a collection of InObs 112 (e.g., a collection of referenced websites) into low-dimensional vectors, capturing the semantic structure of their relationship to other pages.

As discussed previously, it may take a substantial amount of time and a substantial amount of computing resources to generate an optimized set of (H)Ps 16b08. For example, an NLP/NLU system may use hundreds of (H)Ps 16b08 and take several hours to train topic model 16b12 for a topic taxonomy or specific corpus. A brute force method (e.g., grid-search) may train model 16b12 with incremental changes in each model parameter 16b08 until model 16b12 provides sufficient accuracy. Another technique (e.g., random search) may randomly select model parameter values and take hours to produce a model 16b12 that provides a desired performance level.

As discussed previously, the model optimizer 16b10 may use a Bayesian optimization to more efficiently identify optimal (H)Ps 16b08 in a multi-dimensional parameter space. Model optimizer 16b10 may use a suitable optimization technique (e.g., Bayesian optimization) in combination with the distributed model training and testing architecture to more quickly identify a set of (H)Ps 16b08. Model optimizer 16b10 may use a Bayesian optimization in combination with a distributed model training and testing architecture 16b00 to more quickly identify a set of (H)Ps 16b08 that optimize the topic classification performance of model 16b12. This combination yields more optimal results, uses less computational resources, and is magnitudes faster than using Bayesian optimization alone or using any other (H)P optimization technique.

FIG. 17 depicts components of an model optimizer 1700 according to various embodiments. The model optimizer 1700 may correspond to the model optimizer 16a00 and/or model optimizer 16b10 of FIGS. 16a and 16b, respectively. The model optimizer 1700 may optimize a set of (H)Ps (“(H)P set”) 1720 to produce an optimized (H)P set 1722 for operating an ML model 1734 (which may correspond to, or may be the same or similar to model 16a12 and/or model 16b12 of FIGS. 16a and 16b, respectively).

In some embodiments, the model optimizer 1700 may start with a known or existing (H)P set 1720 for a particular model 1734 (e.g., for selected topics of a TC model or the like). The known or existing (H)P set 1720 may be considered to be a “best known” (H)P set 1720. For example, model optimizer 1700 may use a previously used (H)P set 1720 as an initial guess for generating a new (H)P set 1720 for a new/different model 1734. Additionally or alternatively, the model optimizer 1700 may use an (H)P set 1720 that was manually set or otherwise provided by a ML developer, operator, technician, data scientist, etc. In another example, the model optimizer 1700 may use a predefined or default (H)P set 1720.

A manager node 1724 (also referred to as “primary node”, “main node”, “manager”, or the like) uses the best-known (H)P set 1720 to predict or make an initial guess at a more optimized or estimated (H)P set 1728. In embodiments where Bayesian optimization is used, this initial guess may be referred to as a “Bayesian guess.” For example, manager 1724 may use Bayesian optimization to estimate or guess a first (H)P set 1728-1 for use with topic classification model 1734. Bayesian optimization is described in Snoek et al., “Practical Bayesian Optimization of Machine Learning Algorithms”, Advances in neural information processing systems (Aug. 29, 2012), which is hereby incorporated by reference in its entirety. Bayesian optimization is known to those skilled in the art and is therefore not described in further detail. Additionally or alternatively, the number of estimated (H)Ps in the (H)P set 1728 may be the same or different than the number of (H)Ps in the best-known (H)P set 1720.

In the example of FIG. 17, estimated (H)P set 1728-1 is downloaded by one of the trainer nodes 1732-1-1732-N (where N is a number). Each model training node 1732 may include a software image that includes model library dependencies 1730 used by model 1734. The software image may also include training and testing data 1706 (which may be the same or similar to training/testing data 16a06 and/or training/testing data 16b06 discussed previously). Each model training node 1732 trains a respective instance of model 1734 using the training and testing data 1706 (or respective copies of the training and testing data 1706). In the example of FIG. 17, training node 1732-1 trains model instance 1734-1, training node 1732-2 trains model instance 1734-2, and so forth until training node 1732-N trains model instance 1734-N.

In one example, the training and testing data 1706 may include InOb(s) related to selected topics such as content, media, webpages, white papers, text, news articles, online product literature, sales content, etc. including and/or describing one or more topics. In this example, the model 1734 is a TC model 1734, and the training nodes 1732 are TC model training nodes 1732. Topic training and testing data 1706 also includes topic labels that model training nodes 1732 use to determine how well TC models 1734 predict the correct topics with the respective estimated (H)P sets 1728. The topic labels are associated with the content in the training and test dataset 1706 and allow human-based labeling of particular training examples of content. A relatively small set of content may be used as test data and the rest of data 1706 may be used for training TC models 1734.

In one example implementation, the model optimizer 1700 may distribute model training nodes 1732 on (or to) one or more containers using a suitable container engine, such as Google® Container Engine service (also known as Google® Kubernetes Engine or “GKE”), Oracle® Container Engine for Kubernetes™, Docker® Engine, Container Runtime Interface using the Open Container Initiative runtime (CRI-O), Linux Containers or “LXD” container engine, rkt (pronounced like a “rocket”), Railcar, and/or the like. A container engine is a software engine, module, or other like collection of functionality that provides cluster management and container orchestration services to run and manage containers (e.g., Kubernetes® containers, Docker® containers, and the like). Container engines also provide a managed environment for deploying containerized applications. In these implementations, each model trainer node 1732 may be run in a respective container. The containers may be spun up using a container image (or worker node image), which contains the necessary training libraries that the model uses to run the training algorithm and the training data set on which to train. Additionally, the main (manager) node 1724 may run inside its own container, which is spun up using the same or different container image discussed previously. Furthermore, a command line input to the container engine may start the model training process, where the command line input indicates the number of model trainer nodes 1732 and the respective training data sets and/or (H)P sets on which each model trainer node 1732 is to train.

The manager 1724 communicates with the distributed model training nodes 1732 via a (H)P queue 1726. The (H)P queue 1726 may be implemented using any suitable message queue (MQ) application/package and/or publish-subscribe (pub/sub) protocol such as Message Queuing Telemetry Transport (MQTT) protocol, Message-oriented middleware (MOM) systems/protocols, Apache® Kafka, Apache® Qpid, IBM® MQ, Java Message Service, Google® PubSub service, RabbitMQ, Redis™, Enduro/X, and/or any other suitable queuing and/or protocol implementation.

The manager 1724 places each estimated (H)P sets 1728-1 to 1728-M (where M is a number) on the top of queue 1726. Each model trainer node 1732 may take a next available estimated (H)P set 1728 from the bottom of queue 1726. In the example of FIG. 17, a first model trainer node 1732-1 may extract the next estimated (H)P set 1728-1 from the bottom of queue 1726 via a suitable API and/or according to a pub/sub protocol. After (H)P set 1728-1 is extracted from the bottom of queue 1726 by model trainer node 1732-1, a next lowest (H)P set 1728-2 is extracted from the bottom of queue 1726 by a next available model trainer node 1732-2 or 1732-N, and so forth to a most-recently added (H)P set 1728-M.

In other words, queue 1726 may operate similar to a first in-first out (FIFO) queue where the manager node 1724 pushes the estimated (H)P sets 1728 on top of the queue 1726 and the estimated (H)P sets 1728 move sequentially down the queue 1726 and are pulled out of a bottom end of the queue 1726 by individual training nodes 1732. Other types of priority schemes may be used for processing estimated (H)P sets 1728 in other embodiments.

Each model trainer node 1732 uses their downloaded estimated (H)P set 1728 to train an associated instance of model 1734. For example, model trainer node 1732-1 may download estimated (H)P set 1728-1 to train TC model 1734A, model trainer node 1732-2 may download estimated (H)P set 1728-2 to train TC model 1734B, and so forth.

Where topic-related ML techniques are used, TC model instances 1734A-1734N may include identifying term frequencies, calculating inverse document frequency, matrix factorization, semantic analysis, and latent Dirichlet allocation (LDA). One example technique for training TC model instances 1734A-1734N is discussed in McCallum et al., “A Comparison of Event Models for Naive Bayes Text Classification”, The Fifteenth National Conference on

Artificial Intelligence (AAAI-98) workshop on learning for text categorization, Vol. 752. No. 1. (26 Jul. 1998), which is hereby incorporated by reference in its entirety.

The model instances 1734A-1734N generate inferences/predictions from test data 1706 and the model training nodes 1732 generate performance scores 1736 (e.g., key performance indicators (KPIs), etc.) based on the performance of the trained model instances 1734 and/or performance of operating the model instances 1734. One example includes using training accuracy to determine the performance scores 1736 such as by comparing the predictions/inferences with a known set of data/information for the test data 1706 (e.g., predicted topics from one or more InObs compared with known topics associated with the one or more InObs). In this example, inferences/predictions that are closer or more similar to the known data may have increased (higher) performance scores 1736 than inferences/predictions that are further from or less similar to the known data. Additionally or alternatively, the accuracy performance scores 1736 may be based on a ratio of a number of correct predictions/inferences divided to a total number of predictions made.

Additionally or alternatively, the performance scores/KPIs 1736 may include logarithmic loss (log loss), confusion matrices, Area Under Curve (AUC) (e.g., an AUC of a model 1734 is equal to the probability that the model 1734 will rank a randomly chosen positive example higher than a randomly chosen negative example), true positive rate (sensitivity), true negative rate (specificity), false positive rate, false negative rate, harmonic mean (e.g., between precision and recall, where precision is the number of correct positive results divided by the number of positive results predicted by the model 1734, and recall is the number of correct positive results divided by the number of all relevant samples), mean absolute error, mean squared error (MSE), and/or the like. Additionally or alternatively, the performance scores/KPIs 1736 may be based on other metrics and/or measurements such as resources consumption of the training process, for example, in terms of processor utilization, memory or storage utilization, power consumption, speed and/or time consumed for training, and/or the like. ML-derived KPIs may also be used, such as KPIs developed as discussed in Marcus Thorström, “Applying Machine Learning to Key Performance Indicators”, Master's thesis in Software Engineering, Department of Computer Science and Engineering, Chalmers Univ. of Tech., Univ. of Gothenburg (2017), which is hereby incorporated by reference in its entirety. Additionally or alternatively, the performance indicators/KPIs 1736 can be derived from a sequence of historical values for measurement. These raw sets of traditional and alternative data values can be fed into systems designed to aggregate, normalize, interpolate, and extrapolate the raw data into ML friendly factors.

Each training node 1732 generates respective results 1740 based on the training of their respective model instance 1734 using the training data 1706. The results 1740 include one or more performance value(s) 1736 for an associated estimated (H)P set 1728. The results 1740 are fed back into the best-known parameter (H)P set 1720. Once a result 1740 is generated by a particular training node 1732, that training node 1732 downloads or otherwise obtains the next available estimated (H)P set 1728 from the queue 1726, and begins training its model instance 1734 using the newly obtained estimated (H)P set 1728.

The manager 1724 uses the results 1740 received from each model trainer node 1732 to generate a next estimated (H)P set 1728. For example, the manager 1724 may use a suitable optimization algorithm (e.g., Bayesian optimization and/or the like) to (attempt to) derive a new (H)P set 1728 that improves the previously generated model performance value 1736 and/or one or more selected performance values 1736. The manager 1724 places the new estimated (H)P set 1728 in the queue 1726 for subsequent processing by one of the training nodes 1732.

The aforementioned process repeats until the manager 1724 determines/identifies a convergence of one or more performance values 1736 and/or identifies one or more performance values 1736 that reaches one or more threshold values. The manager 1724 determines or selects the estimated (H)P set 1728 that produces the converged or threshold performance value(s) 1736 as the optimized model parameter set 1722. Where topic-related ML techniques are used, the model optimizer 1700 uses the TC model 1734 with the optimized model parameter set 1722 in content analyzer 242 of FIGS. 2-16b to generate topic predictions 16b36. Model optimizer 1700 may conduct a new model optimization for any topic taxonomy update or for any newly identified topic.

FIG. 18 illustrates an example of how the model optimizer 1700 of FIG. 17 generates and/or derives estimated parameter sets 1728 according to various embodiments. As described previously, the manager 1724 derives estimated (H)P set 1728 from a best known (H)P set 1720 for a particular model 1734 (e.g., and/or for selected topics). In the example of FIG. 18, the (H)P set 1720 includes multiple (H)Ps labelled (H)P_1 to (H)P_N (where N is a number) and performance values 1736 for each of the (H)Ps in the (H)P set 1720. The values of each (H)P may include digits, characters, media/content, InObs, and/or combinations thereof.

As examples, the (H)Ps in the (H)P set 1720 include a number of words, content length, n-grams and/or word n-grams, word vector size, epochs, and/or any other suitable (H)Ps such as those discussed herein. An n-gram is a contiguous sequence of n items from a given sample of text or speech (where n is a number). The items can be phonemes, syllables, letters, words, base pairs, etc., according to the application, The n-grams are typically collected from a text or speech corpus. Additionally or alternatively, the (word) n-grams may define the maximum number of consecutive words used to tokenize an InOb.

The word vector size defines the dimension of a word representation. Each word contained in training data may be represented as a vector, where the length of the vector represents the amount of information that the vector contains. The word vector may include information like grammar, semantics (e.g., lexical semantics (feature F6)), higher concepts, etc. The word vector defines how the model 1734 looks across a piece of content and defines how the model 1734 converts data into a numerical representation. For example, the word vector is used to understand relationships between verb tense, grammatical gender (e.g., masculine vs. feminine nouns), countries, etc. For example, a word vector provides the ability to understand relationships between words like “king” and “men”, “queen” and “women”, and so forth. The (H)P set 1720, 1728 identifies the sizes and dimensions that the model uses for building the word vectors. One example technique for generating word vectors is described in Mikolov et al., “Efficient Estimation of Word Representations in Vector Space”, arXiv preprint arXiv:1301.3781 (7 Sep. 2013), which is incorporated by reference in its entirety.

Next, the manager 1724 optimizes the (H)P set 1720 (e.g., by performing Bayesian optimization on (H)Ps 1720) to generate a next estimated (H)P set 1728. The manager 1724 pushes the next estimated (H)P set 1728 in to the queue 1726 for distribution to one of the multiple different model trainer nodes 1732 as described previously. Each model training node 1732 trains a respective model instance 1734 using the estimated (H)P set 1728 downloaded from the bottom of queue 1726.

Each training node 1732 output a result pair 1740 that includes model performance value 1736 for an associated model instance 1734 and an estimated (H)P set 1728 used for training the model instance 1734. Result pairs 1740 are sent back to the manager 1724 and added to the existing (H)P set 1720. After the existing (H)P set 1720 is updated with a result pair 1740, the manager 1724 generates a new estimated (H)P set 1728 based on the new group of known (H)Ps/(H)P sets 1720. In some embodiments, result pairs 1740 may replace one of the previous best-known model (H)P sets 1720. For example, a result pair 1740 may replace an (H)P set 1720 having a lowest performance value 1736 among the (H)P sets 1720 stored by the manager 1724, an (H)P set 1720 having an oldest timestamp among the (H)P sets 1720 stored by the manager 1724, and/or according to some other parameter and/or combinations thereof.

In a first example operation of FIG. 18, the manager 1724 may start with a single (H)P set 1720-1 and may produce an (H)P set 1728-1 using a suitable optimization algorithm. The manager 1724 then stores the (H)P set 1728-1 in the queue 1726. The training nodes 1732 may then obtain the (H)P set 1728-1 from the queue 1726 and train their respective model instance(s) 1734 using the (H)P set 1728-1. In this example, training node 1732-1 may finish training its respective model instance 1734-1 before other training nodes 1732, and sends its result set 1740-1 to the manager 1724. In this example, the result set 1740-1 includes an (H)P set 1728′ and performance value 1736′, which are stored by the manager 1724 as (H)P set 1720-2. The manager 1724 performs the optimization on (H)P set 1720-2 to produce an (H)P set 1728-2, stores the (H)P set 1728-2 in the queue 1726, which is then downloaded by an available training node 1732. Prior to, simultaneously with, or after the (H)P set 1728-2 is produced, the training node 1732-N may finish training its respective model instance 1734-N, and sends its result set 1740-N to the manager 1724. In this example, the result set 1740-N includes an (H)P set 1728′ and performance value 1736′, which are stored by the manager 1724 as (H)P set 1720-3. The manager 1724 performs the optimization on (H)P set 1720-3 to produce an (H)P set 1728-3, stores the (H)P set 1728-3 in the queue 1726, which is then downloaded by an available training node 1732. This process then repeats until a convergence on an (H)P set 1728 occurs.

In a second example operation of FIG. 18, the manager 1724 may start with a single (H)P set 1720-1 and may produce each of (H)P sets 1728-1 to 1728-M using the optimization algorithm, which are then stored in the queue 1726, as each (H)P set 1728 is generated. The manager 1724 may optimize the (H)P set 1720-1 in different ways to produce each of the (H)P sets 1728. The training nodes 1732-1 to 1732-N may then obtain respective (H)P sets 1728-1 to 1728-M from the queue 1726 and train their respective model instances 1734 using the respective (H)P sets 1728-1 to 1728-M. In this example, training node 1732-1 may finish training its respective model instance 1734-1 before the other training nodes 1732, and sends its result set 1740-1 to the manager 1724. In this example, the result set 1740-1 includes an (H)P set 1728′ and performance value 1736′, which are stored by the manager 1724 as (H)P set 1720-2. The manager 1724 performs the optimization on (H)P set 1720-2 to produce an (H)P set 1728-(M+1) (not shown by FIG. 18), stores the (H)P set 1728-(M+1) in the queue 1726, which is then downloaded by an available training node 1732. Prior to, simultaneously with, or after the (H)P set 1728-(M+1) is produced and stored in the queue 1726, the training node 1732-N may finish training its respective model instance 1734-N, and sends its result set 1740-N to the manager 1724. In this example, the result set 1740-N includes an (H)P set 1728″ and performance value 1736″, which are stored by the manager 1724 as (H)P set 1720-3 (not shown by FIG. 18). The manager 1724 performs the optimization on (H)P set 1720-3 to produce an (H)P set-(M+2), stores the (H)P set 1728-(M+2) in the queue 1726, which is then downloaded by an available training node 1732. This process then repeats until a convergence on an (H)P set 1728 occurs.

In a third example operation of FIG. 18, the manager 1724 may start with multiple (H)P sets 1720-1 to 1720-L (where L is a number) and may produce (H)P set 1728-1 from optimizing (H)P set 1720-1, produce (H)P set 1728-2 from optimizing (H)P set 1720-2, and so forth in turn until producing an (H)P set 1728-M from optimizing (H)P set 1720- L (in this example, M=L). The manager 1724 then stores each (H)P set 1728-1 to 1728-M in the queue 1726, as each (H)P set 1728 is generated. The training nodes 1732-1 to 1732-N may then obtain respective (H)P sets 1728-1 to 1728-M from the queue 1726 and train their respective model instances 1734 using the respective (H)P sets 1728-1 to 1728-M. In this example, training node 1732-1 may finish training its respective model instance 1734-1 before the other training nodes 1732, and sends its result set 1740-1 to the manager 1724. In this example, the result set 1740-1 includes an (H)P set 1728′ and performance value 1736′, which are stored by the manager 1724 as (H)P set 1720-(L+1) (not shown by FIG. 18). The manager 1724 performs the optimization on (H)P set 1720-(L+1) to produce an (H)P set 1728-(M+1) (not shown by FIG. 18), stores the (H)P set 1728-(M+1) in the queue 1726, which is then downloaded by an available training node 1732. Prior to, simultaneously with, or after the (H)P set 1728-(M+1) is produced and stored in the queue 1726, the training node 1732-N may finish training its respective model instance 1734-N, and sends its result set 1740-N to the manager 1724. In this example, the result set 1740-N includes an (H)P set 1728′ and performance value 1736″, which are stored by the manager 1724 as (H)P set 1720-(L+2) (not shown by FIG. 18). The manager 1724 performs the optimization on (H)P set 1720-(L+2) to produce an (H)P set-(M+2), stores the (H)P set 1728-(M+2) in the queue 1726, which is then downloaded by an available training node 1732. This process then repeats until a convergence on an (H)P set 1728 occurs.

each model instance 1734 produces a result set 1740 comprising an (H)P set 1728 with a corresponding performance metric 1736. Once a model instance 1734 produces a result set 1740, that model instance 1734 (or its training node 1732) provides the result set 1740 to the manager 1724

Model optimizer 1700 repeats the optimization process until performance values 1736 converge or reach a threshold value. In one example, model optimizer 1700 may repeat the optimization process for a threshold period of time period or for a threshold number of iterations/epochs. In various embodiments, the model optimizer 1700 may select a trained model 1734 having a highest performance value 1736 as the optimized model 1722. For example, the model optimizer 1700 may select a trained model with the highest performance value 1736 to be used as a model 1734 to identify topics in the CCM 100.

As mentioned previously, conventional tuning and training an ML model may consume large amounts of computing and/or processing resources, and may take a relatively long amount of time to complete. Distributing tuning and/or training to multiple parallel training nodes 1732 substantially reduces the overall processing resources and processing time for deriving optimized TC model 1734. By using a (Bayesian) optimization, manager 1724 also may reduce the number of iterations or epochs needed for identifying the (H)P set 1728 that produces a desired model performance value 1736.

FIG. 19 shows an example process 1900 performed by the manager node 1724 of the model optimizer 1700 according to various embodiments. Process 1900 begins at operation 1905 where the manager node 1724 receives and/or generates (H)P sets 1720 for an ML model. In one example, the manager node 1724 receives one or more previously used HP sets 1720 for a particular ML model. In another example, the manager node 1724 generates one or more HP sets 1720 for a particular ML model. In another example, the manager node 1724 receives and/or generates (H)P sets 1720 for a set of identified topics for a TC model. As explained previously, the initial parameter sets may be from a similar topic list or may be a predetermined set of (H)Ps 1720.

At operation 1910, the manager node 1724 performs an optimization process with the known (H)P sets 1720, generating (estimating) a next-best (H)P set 1728. In one example, the manager node 1724 performs Bayesian optimization on known (H)P sets 1720 to produce the next-best (H)P set 1728. In another example, the manager node 1724 performs (Bayesian) optimization on known (H)P sets 1720 to produce multiple different next-best (H)P sets 1728. At operation 1915, the estimated next-best (H)P set 1728 is pushed onto the (H)P set queue 1726. Individual training nodes 1732 then pull the oldest estimated (H)P sets 1728 from the bottom of the queue 1726 for training their respective model instances 1734.

At operation 1920, the manager node 1724 receives a performance result 1740 for the a model instance 1734 trained using one of the estimated (H)P sets 1728, where the result 1740 includes the estimated (H)P set 1728 and a corresponding performance value 1736. At operation 1925, the manager node 1724 adds the results 1740 to the best-known parameter sets 1720.

At operation 1930, the manager node 1724 determines if the result 1740 optimized (or includes an optimal (H)P set 1728). In some embodiments, the manager node 1724 may determine that the (H)P set 1728 included in the result 1740 converges. An ML model reaches convergence when it achieves a state during training in which loss settles to within an error range around a final value. In other words, a model converges when additional training will not improve the predictions/inferences produced by the model. In one example, the manager node 1724 may determine that the (H)P set 1728 included in the result 1740 converges with previous results 1740 or converges to a predetermined value. In one example where Bayesian optimization is used, the manager node 1724 may declare a convergence or otherwise stop the optimization process using a maximum budget and/or some other artificial criteria. Additionally or alternatively, an Infill Criterion (IC) may be computed where high IC values correspond to a relatively high potential of minimization improvement and low IC values indicate relatively low potential of minimization improvement. Additionally or alternatively, the manager node 1724 may identify the (H)P set 1728 that produces a highest model performance value after some predetermined time period or after a predetermined number of optimization iterations/epochs.

If an optimized (H)P set 1722 is not determined, as defined by the optimization stopping/ending criteria, defined previously, the manager node 1724 performs another optimization iteration using the (H)P set 1728 at operation 1910. When an optimized (H)P set 1722 is identified at operation 1930, the manager node 1724 proceeds to operation 1935 to generate and/or operate an optimized model 1734 using the optimal (H)P set 1722. Alternatively, the manager node 1724 operation 1935 provides the optimized model 1734 with the optimal (H)P set 1722 (or only the optimal (H)P set 1722) to another entity for producing predictions/inferences. For example, the manager node 1724 operation 1935 may send the optimized model 1734 to the content analyzer 242 for predicting a new set of topics in InObs 112, 114.

FIG. 20 shows an example process 2000 for operating one or more training nodes 1732 according to various embodiments. Process 2000 begins at operation 2005, where a training node 1732 downloads an estimated (H)P set 1728 from an (H)P set queue 1726. At operation 2005, the training node 1732 uses the estimated (H)P set 1728 and training data 1706 to train its local instance of the ML model 1734. For example, when the ML model 1734 is a topic classification (TC) model, the training node 1732 may create a set of word relationship vectors that are associated with topics in the training data and trains the TC model according to the (H)Ps defined by the (H)P set 1728 downloaded at operation 2005.

At operation 2015, the training node 1732 tests the built and/or trained model instance 1734 with a set of test data 1706. For example, when the ML model 1734 is a TC model, the test data 1706 may include a list of known topics and their associated content, and the training node 1732 may generate a model performance score 1736 based on the number of topics correctly identified in the test data 1706 by the trained TC model 1734. Additionally or alternatively, the training node 1732 may generate the model performance score 1736 based on the speed of generating the predictions/inferences the topics and/or the amount of resources consumed when making the predictions/inferences. At operation 2020, the training node 1732 generates and sends a test result 1740 to the manager node 1724, which includes the tested (H)P set 1728 and the associated performance score 1736. The test result 1740 is then used by the manager node 1724 to generate additional (H)P set 1728 estimations. The training node 1732 may then proceed back to operation 2000 to obtain another estimated (H)P set 1728 to use for training its local ML model instance 1734.

Process 2000 may be performed by multiple training nodes 1732 in parallel, each of which may end/terminate process 2000 when the manager node 1724 determines an optimal (H)P set 1722. In some embodiments, the manager node 1724 may notify the training nodes 1732 to stop training and/or that an optimal (H)P set 1722 has been discovered. In other embodiments, the manager node 1724 may simply stop adding new estimated (H)P sets 1728 to the queue 1726. Other mechanisms may be used in other embodiments.

### 7. Example Hardware and Software Configurations and Implementations

FIG. 21 illustrates an example of an computing system 2100 (also referred to as “computing device 2100,” “platform 2100,” “device 2100,” “appliance 2100,” “server 2100,” or the like) in accordance with various embodiments. The computing system 2100 may be suitable for use as any of the computer devices discussed herein and performing any combination of processes discussed previously. As examples, the computing device 2100 may operate in the capacity of a server or a client machine in a server-client network environment, or as a peer machine in a peer-to-peer (or distributed) network environment. Additionally or alternatively, the system 2100 may represent the CCM 100, user computer(s) 230, 530, 1400, and 702, network devices, model optimizer 1700, application server(s) (e.g., owned/operated by service providers 118), a third party platform or collection of servers that hosts and/or serves InObs 112, and/or any other system or device discussed previously. Additionally or alternatively, various combinations of the components depicted by FIG. 21 may be included depending on the particular system/device that system 2100 represents. For example, when system 2100 represents a user or client device, the system 2100 may include some or all of the components shown by FIG. 21. In another example, when the system 2100 represents the CCM 100 or a server computer system, the system 2100 may not include the communication circuitry 2109 or battery 2124, and instead may include multiple NICs 2116 or the like. As examples, the system 2100 and/or the remote system 2155 may comprise desktop computers, workstations, laptop computers, mobile cellular phones (e.g., “smartphones”), tablet computers, portable media players, wearable computing devices, server computer systems, web appliances, network appliances, an aggregation of computing resources (e.g., in a cloud-based environment), or some other computing devices capable of interfacing directly or indirectly with network 2150 or other network, and/or any other machine or device capable of executing instructions (sequential or otherwise) that specify actions to be taken by that machine.

The components of system 2100 may be implemented as an individual computer system, or as components otherwise incorporated within a chassis of a larger system. The components of system 2100 may be implemented as integrated circuits (ICs) or other discrete electronic devices, with the appropriate logic, software, firmware, or a combination thereof, adapted in the computer system 2100. Additionally or alternatively, some of the components of system 2100 may be combined and implemented as a suitable System-on-Chip (SoC), System-in-Package (SiP), multi-chip package (MCP), or the like.

The system 2100 includes physical hardware devices and software components capable of providing and/or accessing content and/or services to/from the remote system 2155. The system 2100 and/or the remote system 2155 can be implemented as any suitable computing system or other data processing apparatus usable to access and/or provide content/services from/to one another. The remote system 2155 may have a same or similar configuration and/or the same or similar components as system 2100. The system 2100 communicates with remote systems 2155, and vice versa, to obtain/serve content/services using, for example, Hypertext Transfer Protocol (HTTP) over Transmission Control Protocol (TCP)/Internet Protocol (IP), or one or more other common Internet protocols such as File Transfer Protocol (FTP); Session Initiation Protocol (SIP) with Session Description Protocol (SDP), Real-time Transport Protocol (RTP), or Real-time Streaming Protocol (RTSP); Secure Shell (SSH), Extensible Messaging and Presence Protocol (XMPP); WebSocket; and/or some other communication protocol, such as those discussed herein.

As used herein, the term “content” refers to visual or audible information to be conveyed to a particular audience or end-user, and may include or convey information pertaining to specific subjects or topics. Content or content items may be different content types (e.g., text, image, audio, video, etc.), and/or may have different formats (e.g., text files including Microsoft® Word® documents, Portable Document Format (PDF) documents, HTML documents; audio files such as MPEG-4 audio files and WebM audio and/or video files; etc.). As used herein, the term “service” refers to a particular functionality or a set of functions to be performed on behalf of a requesting party, such as the system 2100. As examples, a service may include or involve the retrieval of specified information or the execution of a set of operations. In order to access the content/services, the system 2100 includes components such as processors, memory devices, communication interfaces, and the like. However, the terms “content” and “service” may be used interchangeably throughout the present disclosure even though these terms refer to different concepts.

Referring now to system 2100, the system 2100 includes processor circuitry 2102, which is configurable or operable to execute program code, and/or sequentially and automatically carry out a sequence of arithmetic or logical operations; record, store, and/or transfer digital data. The processor circuitry 2102 includes circuitry such as, but not limited to one or more processor cores and one or more of cache memory, low drop-out voltage regulators (LDOs), interrupt controllers, serial interfaces such as serial peripheral interface (SPI), inter-integrated circuit (I²C) or universal programmable serial interface circuit, real time clock (RTC), timer-counters including interval and watchdog timers, general purpose input-output (I/O), memory card controllers, interconnect (IX) controllers and/or interfaces, universal serial bus (USB) interfaces, mobile industry processor interface (MIPI) interfaces, Joint Test Access Group (JTAG) test access ports, and the like. The processor circuitry 2102 may include on-chip memory circuitry or cache memory circuitry, which may include any suitable volatile and/or non-volatile memory, such as DRAM, SRAM, EPROM, EEPROM, Flash memory, solid-state memory, and/or any other type of memory device technology, such as those discussed herein. Individual processors (or individual processor cores) of the processor circuitry 2102 may be coupled with or may include memory/storage and may be configurable or operable to execute instructions stored in the memory/storage to enable various applications or operating systems to run on the system 2100. In these embodiments, the processors (or cores) of the processor circuitry 2102 are configurable or operable to operate application software (e.g., logic/modules 2180) to provide specific services to a user of the system 2100. In some embodiments, the processor circuitry 2102 may include special-purpose processor/controller to operate according to the various embodiments herein.

In various implementations, the processor(s) of processor circuitry 2102 may include, for example, one or more processor cores (CPUs), graphics processing units (GPUs), Tensor Processing Units (TPUs), reduced instruction set computing (RISC) processors, Acorn RISC Machine (ARM) processors, complex instruction set computing (CISC) processors, digital signal processors (DSP), programmable logic devices (PLDs), field-programmable gate arrays (FPGAs), Application Specific Integrated Circuits (ASICs), SoCs and/or programmable SoCs, microprocessors or controllers, or any suitable combination thereof. As examples, the processor circuitry 2102 may include Intel® Core™ based processor(s), MCU-class processor(s), Xeon® processor(s); Advanced Micro Devices (AMD) Zen® Core Architecture processor(s), such as Ryzen® or Epyc® processor(s), Accelerated Processing Units (APUs), MxGPUs, or the like; A, S, W, and T series processor(s) from Apple® Inc., Snapdragon™ or Centrig™ processor(s) from Qualcomm® Technologies, Inc., Texas Instruments, Inc.® Open Multimedia Applications Platform (OMAP)™ processor(s); Power Architecture processor(s) provided by the OpenPOWER® Foundation and/or IBM®, MIPS Warrior M-class, Warrior I-class, and Warrior P-class processor(s) provided by MIPS Technologies, Inc.; ARM Cortex-A, Cortex-R, and Cortex-M family of processor(s) as licensed from ARM Holdings, Ltd.; the ThunderX2® provided by Cavium™, Inc.; GeForce®, Tegra®, Titan X®, Tesla®, Shield®, and/or other like GPUs provided by Nvidia®; or the like. Other examples of the processor circuitry 2102 may be mentioned elsewhere in the present disclosure.

In some implementations, the processor(s) of processor circuitry 2102 may be, or may include, one or more media processors comprising microprocessor-based SoC(s), FPGA(s), or DSP(s) specifically designed to deal with digital streaming data in real-time, which may include encoder/decoder circuitry to compress/decompress (or encode and decode) Advanced Video Coding (AVC) (also known as H.264 and MPEG-4) digital data, High Efficiency Video Coding (HEVC) (also known as H.265 and MPEG-H part 2) digital data, and/or the like.

In some implementations, the processor circuitry 2102 may include one or more hardware accelerators. The hardware accelerators may be microprocessors, configurable hardware (e.g., FPGAs, programmable ASICs, programmable SoCs, DSPs, etc.), or some other suitable special-purpose processing device tailored to perform one or more specific tasks or workloads, for example, specific tasks or workloads of the subsystems of the CCM 100, IP2D resolution system 850, and/or some other system/device discussed herein, which may be more efficient than using general-purpose processor cores. In some embodiments, the specific tasks or workloads may be offloaded from one or more processors of the processor circuitry 2102. In these implementations, the circuitry of processor circuitry 2102 may comprise logic blocks or logic fabric including and other interconnected resources that may be programmed to perform various functions, such as the procedures, methods, functions, etc. of the various embodiments discussed herein. Additionally, the processor circuitry 2102 may include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 2102 may include hardware elements specifically tailored for machine learning functionality, such as for operating the subsystems of the CCM 100 discussed previously with regard to FIG. 2. In these implementations, the processor circuitry 2102 may be, or may include, an AI engine chip that can run many different kinds of AI instruction sets once loaded with the appropriate weightings and training code. Additionally or alternatively, the processor circuitry 2102 may be, or may include, AI accelerator(s), which may be one or more of the aforementioned hardware accelerators designed for hardware acceleration of AI applications, such as one or more of the subsystems of CCM 100, IP2D resolution system 850, and/or some other system/device discussed herein. As examples, these processor(s) or accelerators may be a cluster of artificial intelligence (AI) GPUs, tensor processing units (TPUs) developed by Google® Inc., Real AI Processors (RAPs™) provided by AlphalCs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 2102 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin 970 provided by Huawei®, and/or the like.

In some implementations, the processor(s) of processor circuitry 2102 may be, or may include, one or more custom-designed silicon cores specifically designed to operate corresponding subsystems of the CCM 100, IP2D resolution system 850, and/or some other system/device discussed herein. These cores may be designed as synthesizable cores comprising hardware description language logic (e.g., register transfer logic, verilog, Very High Speed Integrated Circuit hardware description language (VHDL), etc.); netlist cores comprising gate-level description of electronic components and connections and/or process-specific very-large-scale integration (VLSI) layout; and/or analog or digital logic in transistor-layout format. In these implementations, one or more of the subsystems of the CCM 100, IP2D resolution system 850, and/or some other system/device discussed herein may be operated, at least in part, on custom-designed silicon core(s). These “hardware-ized” subsystems may be integrated into a larger chipset but may be more efficient that using general purpose processor cores.

The system memory circuitry 2104 comprises any number of memory devices arranged to provide primary storage from which the processor circuitry 2102 continuously reads instructions 2182 stored therein for execution. In some embodiments, the memory circuitry 2104 is on-die memory or registers associated with the processor circuitry 2102. As examples, the memory circuitry 2104 may include volatile memory such as random access memory (RAM), dynamic RAM (DRAM), synchronous DRAM (SDRAM), etc. The memory circuitry 2104 may also include nonvolatile memory (NVM) such as high-speed electrically erasable memory (commonly referred to as “flash memory”), phase change RAM (PRAM), resistive memory such as magnetoresistive random access memory (MRAM), etc. The memory circuitry 2104 may also comprise persistent storage devices, which may be temporal and/or persistent storage of any type, including, but not limited to, non-volatile memory, optical, magnetic, and/or solid state mass storage, and so forth.

In some implementations, some aspects (or devices) of memory circuitry 2104 and storage circuitry 2108 may be integrated together with a processing device 2102, for example RAM or FLASH memory disposed within an integrated circuit microprocessor or the like. In other implementations, the memory circuitry 2104 and/or storage circuitry 2108 may comprise an independent device, such as an external disk drive, storage array, or any other storage devices used in database systems. The memory and processing devices may be operatively coupled together, or in communication with each other, for example by an I/O port, network connection, etc. such that the processing device may read a file stored on the memory.

Some memory may be “read only” by design (ROM) by virtue of permission settings, or not. Other examples of memory may include, but may be not limited to, WORM, EPROM, EEPROM, FLASH, etc. which may be implemented in solid state semiconductor devices. Other memories may comprise moving parts, such a conventional rotating disk drive. All such memories may be “machine-readable” in that they may be readable by a processing device.

Storage circuitry 2108 is arranged to provide persistent storage of information such as data, applications, operating systems (OS), and so forth. As examples, the storage circuitry 2108 may be implemented as hard disk drive (HDD), a micro HDD, a solid-state disk drive (SSDD), flash memory cards (e.g., SD cards, microSD cards, xD picture cards, and the like), USB flash drives, on-die memory or registers associated with the processor circuitry 2102, resistance change memories, phase change memories, holographic memories, or chemical memories, and the like.

The storage circuitry 2108 is configurable or operable to store computational logic 2180 (or “modules 2180”) in the form of software, firmware, microcode, or hardware-level instructions to implement the techniques described herein. The computational logic 2180 may be employed to store working copies and/or permanent copies of programming instructions, or data to create the programming instructions, for the operation of various components of system 2100 (e.g., drivers, libraries, application programming interfaces (APIs), etc.), an OS of system 2100, one or more applications, and/or for carrying out the embodiments discussed herein. The computational logic 2180 may be stored or loaded into memory circuitry 2104 as instructions 2182, or data to create the instructions 2182, which are then accessed for execution by the processor circuitry 2102 to carry out the functions described herein. The processor circuitry 2102 accesses the memory circuitry 2104 and/or the storage circuitry 2108 over the interconnect (IX) 2106. The instructions 2182 to direct the processor circuitry 2102 to perform a specific sequence or flow of actions, for example, as described with respect to flowchart(s) and block diagram(s) of operations and functionality depicted previously. The various elements may be implemented by assembler instructions supported by processor circuitry 2102 or high-level languages that may be compiled into instructions 2184, or data to create the instructions 2184, to be executed by the processor circuitry 2102. The permanent copy of the programming instructions may be placed into persistent storage devices of storage circuitry 2108 in the factory or in the field through, for example, a distribution medium (not shown), through a communication interface (e.g., from a distribution server (not shown)), or over-the-air (OTA).

The operating system (OS) of system 2100 may be a general purpose OS or an OS specifically written for and tailored to the computing system 2100. For example, when the system 2100 is a server system or a desktop or laptop system 2100, the OS may be Unix or a Unix-like OS such as Linux e.g., provided by Red Hat Enterprise, Windows 10™ provided by Microsoft Corp.®, macOS provided by Apple Inc.®, or the like. In another example where the system 2100 is a mobile device, the OS may be a mobile OS, such as Android° provided by Google Inc.®, iOS® provided by Apple Inc.®, Windows 10 Mobile° provided by Microsoft Corp.®, KaiOS provided by KaiOS Technologies Inc., or the like.

The OS manages computer hardware and software resources, and provides common services for various applications (e.g., one or more loci/modules 2180). The OS may include one or more drivers or APIs that operate to control particular devices that are embedded in the system 2100, attached to the system 2100, or otherwise communicatively coupled with the system 2100. The drivers may include individual drivers allowing other components of the system 2100 to interact or control various I/O devices that may be present within, or connected to, the system 2100. For example, the drivers may include a display driver to control and allow access to a display device, a touchscreen driver to control and allow access to a touchscreen interface of the system 2100, sensor drivers to obtain sensor readings of sensor circuitry 2121 and control and allow access to sensor circuitry 2121, actuator drivers to obtain actuator positions of the actuators 2122 and/or control and allow access to the actuators 2122, a camera driver to control and allow access to an embedded image capture device, audio drivers to control and allow access to one or more audio devices. The OSs may also include one or more libraries, drivers, APIs, firmware, middleware, software glue, etc., which provide program code and/or software components for one or more applications to obtain and use the data from other applications operated by the system 2100, such as the various subsystems of the CCM 100, IP2D resolution system 850, and/or some other system/device discussed previously.

The components of system 2100 communicate with one another over the interconnect (IX) 2106. The IX 2106 may include any number of IX technologies such as industry standard architecture (ISA), extended ISA (EISA), inter-integrated circuit (I²C), an serial peripheral interface (SPI), point-to-point interfaces, power management bus (PMBus), peripheral component interconnect (PCI), PCI express (PCIe), Intel® Ultra Path Interface (UPI), Intel® Accelerator Link (IAL), Common Application Programming Interface (CAPI), Intel® QuickPath Interconnect (QPI), Intel® Omni-Path Architecture (OPA) IX, RapidIOTM system interconnects, Ethernet, Cache Coherent Interconnect for Accelerators (CCIA), Gen-Z Consortium IXs, Open Coherent Accelerator Processor Interface (OpenCAPI), and/or any number of other IX technologies. The IX 2106 may be a proprietary bus, for example, used in a SoC based system.

The communication circuitry 2109 is a hardware element, or collection of hardware elements, used to communicate over one or more networks (e.g., network 2150) and/or with other devices. The communication circuitry 2109 includes modem 2110 and transceiver circuitry (“TRx”) 812. The modem 2110 includes one or more processing devices (e.g., baseband processors) to carry out various protocol and radio control functions. Modem 2110 may interface with application circuitry of system 2100 (e.g., a combination of processor circuitry 2102 and CRM 860) for generation and processing of baseband signals and for controlling operations of the TRx 2112. The modem 2110 may handle various radio control functions that enable communication with one or more radio networks via the TRx 2112 according to one or more wireless communication protocols. The modem 2110 may include circuitry such as, but not limited to, one or more single-core or multi-core processors (e.g., one or more baseband processors) or control logic to process baseband signals received from a receive signal path of the TRx 2112, and to generate baseband signals to be provided to the TRx 2112 via a transmit signal path. In various embodiments, the modem 2110 may implement a real-time OS (RTOS) to manage resources of the modem 2110, schedule tasks, etc.

The communication circuitry 2109 also includes TRx 2112 to enable communication with wireless networks using modulated electromagnetic radiation through a non-solid medium. TRx 2112 includes a receive signal path, which comprises circuitry to convert analog RF signals (e.g., an existing or received modulated waveform) into digital baseband signals to be provided to the modem 2110. The TRx 2112 also includes a transmit signal path, which comprises circuitry configurable or operable to convert digital baseband signals provided by the modem 2110 to be converted into analog RF signals (e.g., modulated waveform) that will be amplified and transmitted via an antenna array including one or more antenna elements (not shown). The antenna array may be a plurality of microstrip antennas or printed antennas that are fabricated on the surface of one or more printed circuit boards. The antenna array may be formed in as a patch of metal foil (e.g., a patch antenna) in a variety of shapes, and may be coupled with the TRx 2112 using metal transmission lines or the like.

The TRx 2112 may include one or more radios that are compatible with, and/or may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDM2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10) , 3GPP Rel. 11 (3rd Generation Partnership Project Release 11), 3GPP Rel. 12 (3rd Generation Partnership Project Release 12), 3GPP Rel. 8 (3rd Generation Partnership Project Release 8), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDM2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic

Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Bluetooth(r), Bluetooth Low Energy (BLE), IEEE 802.15.4 based protocols (e.g., IPv6 over Low power Wireless Personal Area Networks (6LoWPAN), WirelessHART, MiWi, Thread, 1600.11a, etc.) WiFi-direct, ANT/ANT+, ZigBee, Z-Wave, 3GPP device-to-device (D2D) or Proximity Services (ProSe), Universal Plug and Play (UPnP), Low-Power Wide-Area-Network (LPWAN), LoRaWANTM (Long Range Wide Area Network), Sigfox, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others, the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non- safety applications in the frequency range 5,855 GHz to 5,875 GHz), ITS-G5C (i.e., Operation of ITS applications in the frequency range 5,470 GHz to 5,725 GHz)), etc. In addition to the standards listed previously, any number of satellite uplink technologies may be used for the TRx 2112 including, for example, radios compliant with standards issued by the ITU (International Telecommunication Union), or the ETSI (European Telecommunications Standards Institute), among others, both existing and not yet formulated.

Network interface circuitry/controller (NIC) 2116 may be included to provide wired communication to the network 2150 or to other devices using a standard network interface protocol. The standard network interface protocol may include Ethernet, Ethernet over GRE Tunnels, Ethernet over Multiprotocol Label Switching (MPLS), Ethernet over USB, or may be based on other types of network protocols, such as Controller Area Network (CAN), Local Interconnect Network (LIN), DeviceNet, ControlNet, Data Highway+, PROFIBUS, or PROFINET, among many others. Network connectivity may be provided to/from the system 2100 via NIC 2116 using a physical connection, which may be electrical (e.g., a “copper interconnect”) or optical. The physical connection also includes suitable input connectors (e.g., ports, receptacles, sockets, etc.) and output connectors (e.g., plugs, pins, etc.). The NIC 2116 may include one or more dedicated processors and/or FPGAs to communicate using one or more of the aforementioned network interface protocols. In some implementations, the NIC 2116 may include multiple controllers to provide connectivity to other networks using the same or different protocols. For example, the system 2100 may include a first NIC 2116 providing communications to the cloud over Ethernet and a second NIC 2116 providing communications to other devices over another type of network. In some implementations, the NIC 2116 may be a high-speed serial interface (HSSI) NIC to connect the system 2100 to a routing or switching device.

Network 2150 comprises computers, network connections among various computers (e.g., between the system 2100 and remote system 2155), and software routines to enable communication between the computers over respective network connections. In this regard, the network 2150 comprises one or more network elements that may include one or more processors, communications systems (e.g., including network interface controllers, one or more transmitters/receivers connected to one or more antennas, etc.), and computer readable media. Examples of such network elements may include wireless access points (WAPs), a home/business server (with or without radio frequency (RF) communications circuitry), a router, a switch, a hub, a radio beacon, base stations, picocell or small cell base stations, and/or any other like network device. Connection to the network 2150 may be via a wired or a wireless connection using the various communication protocols discussed infra. As used herein, a wired or wireless communication protocol may refer to a set of standardized rules or instructions implemented by a communication device/system to communicate with other devices, including instructions for packetizing/depacketizing data, modulating/demodulating signals, implementation of protocols stacks, and the like. More than one network may be involved in a communication session between the illustrated devices. Connection to the network 2150 may require that the computers execute software routines which enable, for example, the seven layers of the OSI model of computer networking or equivalent in a wireless (or cellular) phone network.

The network 2150 may represent the Internet, one or more cellular networks, a local area network (LAN) or a wide area network (WAN) including proprietary and/or enterprise networks, Transfer Control Protocol (TCP)/Internet Protocol (IP)-based network, or combinations thereof. In such embodiments, the network 2150 may be associated with network operator who owns or controls equipment and other elements necessary to provide network-related services, such as one or more base stations or access points, one or more servers for routing digital data or telephone calls (e.g., a core network or backbone network), etc. Other networks can be used instead of or in addition to the Internet, such as an intranet, an extranet, a virtual private network (VPN), an enterprise network, a non-TCP/IP based network, any LAN or WAN or the like.

The external interface 2118 (also referred to as “I/O interface circuitry” or the like) is configurable or operable to connect or coupled the system 2100 with external devices or subsystems. The external interface 2118 may include any suitable interface controllers and connectors to couple the system 2100 with the external components/devices. As an example, the external interface 2118 may be an external expansion bus (e.g., Universal Serial Bus (USB), FireWire, Thunderbolt, etc.) used to connect system 2100 with external (peripheral) components/devices. The external devices include, inter alia, sensor circuitry 2121, actuators 2122, and positioning circuitry 2145, but may also include other devices or subsystems not shown by FIG. 21.

The sensor circuitry 2121 may include devices, modules, or subsystems whose purpose is to detect events or changes in its environment and send the information (sensor data) about the detected events to some other a device, module, subsystem, etc. Examples of such sensors 621 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras); light detection and ranging (LiDAR) sensors; proximity sensors (e.g., infrared radiation detector and the like), depth sensors, ambient light sensors, ultrasonic transceivers; microphones; etc.

The external interface 2118 connects the system 2100 to actuators 2122, which allow system 2100 to change its state, position, and/or orientation, or move or control a mechanism or system. The actuators 2122 comprise electrical and/or mechanical devices for moving or controlling a mechanism or system, and/or converting energy (e.g., electric current or moving air and/or liquid) into some kind of motion. The actuators 2122 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 2122 may include one or more electromechanical devices such as pneumatic actuators, hydraulic actuators, electromechanical switches including electromechanical relays (EMRs), motors (e.g., DC motors, stepper motors, servomechanisms, etc.), wheels, thrusters, propellers, claws, clamps, hooks, an audible sound generator, and/or other like electromechanical components. The system 2100 may be configurable or operable to operate one or more actuators 2122 based on one or more captured events and/or instructions or control signals received from a service provider and/or various client systems. In embodiments, the system 2100 may transmit instructions to various actuators 2122 (or controllers that control one or more actuators 2122) to reconfigure an electrical network as discussed herein.

The positioning circuitry 2145 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 2145 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 2145 may include a Micro-Technology for Positioning, Navigation, and Timing (Micro-PNT) IC that uses a master timing clock to perform position tracking/estimation without GNSS assistance. The positioning circuitry 2145 may also be part of, or interact with, the communication circuitry 2109 to communicate with the nodes and components of the positioning network. The positioning circuitry 2145 may also provide position data and/or time data to the application circuitry, which may use the data to synchronize operations with various infrastructure (e.g., radio base stations), for turn-by-turn navigation, or the like.

The input/output (I/O) devices 2156 may be present within, or connected to, the system 2100. The I/O devices 2156 include input device circuitry and output device circuitry including one or more user interfaces designed to enable user interaction with the system 2100 and/or peripheral component interfaces designed to enable peripheral component interaction with the system 2100. The input device circuitry includes any physical or virtual means for accepting an input including, inter alia, one or more physical or virtual buttons (e.g., a reset button), a physical keyboard, keypad, mouse, touchpad, touchscreen, microphones, scanner, headset, and/or the like. The output device circuitry is used to show or convey information, such as sensor readings, actuator position(s), or other like information. Data and/or graphics may be displayed on one or more user interface components of the output device circuitry. The output device circuitry may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the system 2100. The output device circuitry may also include speakers or other audio emitting devices, printer(s), and/or the like. In some embodiments, the sensor circuitry 2121 may be used as the input device circuitry (e.g., an image capture device, motion capture device, or the like) and one or more actuators 2122 may be used as the output device circuitry (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a universal serial bus (USB) port, an audio jack, a power supply interface, etc.

A battery 2124 may be coupled to the system 2100 to power the system 2100, which may be used in embodiments where the system 2100 is not in a fixed location, such as when the system 2100 is a mobile or laptop client system. The battery 2124 may be a lithium ion battery, a lead-acid automotive battery, or a metal-air battery, such as a zinc-air battery, an aluminum-air battery, a lithium-air battery, a lithium polymer battery, and/or the like. In embodiments where the system 2100 is mounted in a fixed location, such as when the system is implemented as a server computer system, the system 2100 may have a power supply coupled to an electrical grid. In these embodiments, the system 2100 may include power tee circuitry to provide for electrical power drawn from a network cable to provide both power supply and data connectivity to the system 2100 using a single cable.

Power management integrated circuitry (PMIC) 2126 may be included in the system 2100 to track the state of charge (SoCh) of the battery 2124, and to control charging of the system 2100. The PMIC 2126 may be used to monitor other parameters of the battery 2124 to provide failure predictions, such as the state of health (SoH) and the state of function (SoF) of the battery 2124. The PMIC 2126 may include voltage regulators, surge protectors, power alarm detection circuitry. The power alarm detection circuitry may detect one or more of brown out (under-voltage) and surge (over-voltage) conditions. The PMIC 2126 may communicate the information on the battery 2124 to the processor circuitry 2102 over the IX 2106. The PMIC 2126 may also include an analog-to-digital (ADC) convertor that allows the processor circuitry 2102 to directly monitor the voltage of the battery 2124 or the current flow from the battery 2124. The battery parameters may be used to determine actions that the system 2100 may perform, such as transmission frequency, mesh network operation, sensing frequency, and the like.

A power block 2128, or other power supply coupled to an electrical grid, may be coupled with the PMIC 2126 to charge the battery 2124. In some examples, the power block 2128 may be replaced with a wireless power receiver to obtain the power wirelessly, for example, through a loop antenna in the system 2100. In these implementations, a wireless battery charging circuit may be included in the PMIC 2126. The specific charging circuits chosen depend on the size of the battery 2124 and the current required.

The system 2100 may include any combinations of the components shown by FIG. 21, however, some of the components shown may be omitted, additional components may be present, and different arrangement of the components shown may occur in other implementations. In one example where the system 2100 is or is part of a server computer system, the battery 2124, communication circuitry 2109, the sensors 2121, actuators 2122, and/or POS 2145, and possibly some or all of the I/O devices 2156 may be omitted.

Furthermore, the embodiments of the present disclosure may take the form of a computer program product or data to create a computer program, with the computer program or data embodied in any tangible or non-transitory medium of expression having the computer-us able program code (or data to create the computer program) embodied in the medium.

For example, the memory circuitry 2104 and/or storage circuitry 2108 may be embodied as non-transitory computer-readable storage media (NTCRSM) that may be suitable for use to store programming instructions (prog_ins) or data that creates the prog_ins that cause an apparatus (e.g., any of the devices/components/systems described with regard to FIGS. 1-21), in response to execution of the instructions by the apparatus, to perform various programming operations associated with operating system functions, one or more applications, and/or aspects of the present disclosure. In various embodiments, the prog_ins may correspond to any of the computational logic 2180, instructions 2182 and 2184. Additionally or alternatively, the prog_ins (or data to create the prog_ins) may be disposed on multiple NTCRSM. Additionally or alternatively, prog_ins (or data to create the prog_ins) may be disposed on (or encoded in) computer-readable transitory storage media, such as, signals. The prog_ins embodied by a machine-readable medium may be transmitted or received over a communications network using a transmission medium via a network interface device (e.g., communication circuitry 2109 and/or NIC 2116) utilizing any one of a number of transfer protocols (e.g., HTTP, etc.).

Any combination of one or more computer usable or computer readable media may be utilized as or instead of the NTCRSM including, for example but not limited to, one or more electronic, magnetic, optical, electromagnetic, infrared, or semiconductor systems, apparatuses, devices, or propagation media. For instance, the NTCRSM may be embodied by devices described herein, an electrical connection having one or more wires, a portable computer diskette, a hard disk, RAM, ROM, EPROM, flash memory, optical fiber, compact disc, an optical storage device, a transmission media, a magnetic storage device, or any number of other hardware devices. In the context of the present disclosure, a computer-usable or computer-readable medium may be any medium that can contain, store, communicate, propagate, or transport the program (or data to create the program) for use by or in connection with the instruction execution system, apparatus, or device. The computer-usable medium may include a propagated data signal with the computer-usable program code (e.g., the aforementioned prog_ins) or data to create the program code embodied therewith, either in baseband or as part of a carrier wave. The computer usable program code or data to create the program may be transmitted using any appropriate medium, including but not limited to wireless, wireline, optical fiber cable, RF, etc.

In various embodiments, the program code (or data to create the program code) described herein may be stored in one or more of a compressed format, an encrypted format, a fragmented format, a packaged format, etc. The program code or data to create the program code as described herein may require one or more of installation, modification, adaptation, updating, combining, supplementing, configuring, decryption, decompression, unpacking, distribution, reassignment, etc. in order to make them directly readable and/or executable by a computing device and/or other machine. For example, the program code or data to create the program code may be stored in multiple parts, which are individually compressed, encrypted, and stored on separate computing devices, wherein the parts when decrypted, decompressed, and combined form a set of executable instructions that implement the program code or the data to create the program code, such as those described herein. In another example, the program code or data to create the program code may be stored in a state in which they may be read by a computer, but require addition of a library (e.g., a dynamic link library), a software development kit (SDK), an application programming interface (API), etc. in order to execute the instructions on a particular computing device or other device. In another example, the program code or data to create the program code may need to be configured (e.g., settings stored, data input, network addresses recorded, etc.) before the program code or data to create the program code can be executed/used in whole or in part. In this example, the program code (or data to create the program code) may be unpacked, configured for proper execution, and stored in a first location with the configuration instructions located in a second location distinct from the first location. The configuration instructions can be initiated by an action, trigger, or instruction that is not co-located in storage or execution location with the instructions enabling the disclosed techniques. Accordingly, the disclosed program code or data to create the program code are intended to encompass such machine readable instructions and/or program(s) or data to create such machine readable instruction and/or programs regardless of the particular format or state of the machine readable instructions and/or program(s) when stored or otherwise at rest or in transit. The program code and/or the prog_ins may execute entirely on the system 2100, partly on the system 2100 as a stand-alone software package, partly on the system 2100 and partly on a remote computer (e.g., remote system 2155), or entirely on the remote computer (e.g., remote system 2155). In the latter scenario, the remote computer may be connected to the system 2100 through any type of network (e.g., network 2150)

The program code and/or the prog_ins for carrying out operations of the present disclosure may be implemented as software code to be executed by one or more processors using any suitable computer language such as, for example, Python, PyTorch, NumPy, Ruby, Ruby on Rails, Scala, Smalltalk, JavaTM, C++, C#, “C”, Kotlin, Swift, Rust, Go (or “Golang”), ECMAScript, JavaScript, TypeScript, Jscript, ActionScript, Server-Side JavaScript (SSJS), PHP, Pearl, Lua, Torch/Lua with Just-In Time compiler (LuaJIT), Accelerated Mobile Pages Script (AMPscript), VBScript, JavaServer Pages (JSP), Active Server Pages (ASP), Node.js, ASP.NET, JAMscript, Hypertext Markup Language (HTML), extensible HTML (XHTML), Extensible Markup Language (XML), XML User Interface Language (XUL), Scalable Vector Graphics (SVG), RESTful API Modeling Language (RAML), wiki markup or Wikitext, Wireless Markup Language (WML), Java Script Object Notion (JSON), Apache® MessagePack™, Cascading Stylesheets (CSS), extensible stylesheet language (XSL), Mustache template language, Handlebars template language, Guide Template Language (GTL), Apache® Thrift, Abstract Syntax Notation One (ASN.1), Google® Protocol Buffers (protobuf), Bitcoin Script, EVM® bytecode, SolidityTM, Vyper (Python derived), Bamboo, Lisp Like Language (LLL), Simplicity provided by BlockstreamTM, Rholang, Michelson, Counterfactual, Plasma, Plutus, Sophia, Salesforce® Apex®, Salesforce® Lightning®, and/or any other programming language, markup language, script, code, etc. In some implementations, a suitable integrated development environment (IDE) or SDK may be used to develop the program code or software elements discussed herein such as, for example, Android® Studio™ IDE, Apple® iOS® SDK, or development tools including proprietary programming languages and/or development tools.

While only a single computing device 2100 is shown, the computing device 2100 may include any collection of devices or circuitry that individually or jointly execute a set (or multiple sets) of instructions to perform any one or more of the operations discussed previously. Computing device 2100 may be part of an integrated control system or system manager, or may be provided as a portable electronic device configurable or operable to interface with a networked system either locally or remotely via wireless transmission. Some of the operations described previously may be implemented in software and other operations may be implemented in hardware. One or more of the operations, processes, or methods described herein may be performed by an apparatus, device, or system similar to those as described herein and with reference to the illustrated figures.

### 8. Example Implementations

Additional examples of the presently described embodiments include the following, non-limiting example implementations. Each of the non-limiting examples may stand on its own, or may be combined in any permutation or combination with any one or more of the other examples provided below or throughout the present disclosure.

Example A01 includes a distributed model generation method for generating a topic classification (TC) model, comprising: receiving, by a master node, one or more known parameter sets for the TC model; estimating, by the master node, parameter sets for the TC model based on the known parameter sets; and loading, by the master node, the estimated parameter sets into a queue.

Example A01.5 includes the method of example A01 and/or some other example(s) herein, further comprising: operating individual training nodes of multiple training nodes to: download different ones of the estimated parameter sets from the queue; train associated TC models using the downloaded estimated parameter sets; generate model performance values for the trained TC models, the model performance values associated with the estimated parameter sets used for training the TC models, and send the model performance values to the master node, wherein the master node is further to use the model performance values and the associated estimated parameter sets to estimate additional parameter sets.

Example A02 includes the method of examples A01-A01.5 and/or some other example(s) herein, further comprising: using, by the master node, Bayesian optimization to estimate the parameter sets.

Example A03 includes the method of examples A01-A02 and/or some other example(s) herein, further comprising: repeatedly estimating, by the master node, new parameter sets based on the model performance values generated by the training nodes and the associated estimated parameter sets; and loading, by the master node, the new estimated parameter sets into the queue until at least one of the estimated parameter sets produces a target model performance value.

Example A04 includes the method of example A03 and/or some other example(s) herein, wherein the target model performance value converges with other model performance values or reaches a threshold value.

Example A05 includes the method of examples A01.5-A04 and/or some other example(s) herein, further comprising: automatically downloading, by the individual training nodes, additional estimated parameter sets from the queue after generating the model performance values for the trained TC models.

Example A06 includes the method of examples A01-A05 and/or some other example(s) herein, wherein the queue operates as a first in-first out queue, and the method comprises: placing, by the master node, the estimated parameter sets in the queue, wherein the estimated parameter sets move through the queue and are taken from the queue by the individual training nodes.

Example A07 includes the method of examples A01-A06 and/or some other example(s) herein, further comprising: sending, by the master node, an optimal TC model of the TC models, the optimal TC model producing a highest one of the model performance values to a content analyzer for estimating topics in content.

Example A08 includes the method of example A07 and/or some other example(s) herein, wherein the content analyzer operates in a content consumption monitor (CCM), and the method further comprises: identifying, by the CCM, events from a domain; identifying, by the CCM, a number of the events; identifying, by the CCM, content associated with the events; identifying, by the CCM, a topic; using, by the CCM, the optimal TC model to identify a relevancy of the content to the topic; and generating, by the CCM, a consumption score for the domain and topic based on the number of events and the relevancy of the content to the topic.

Example A09 includes the method of examples A01-A08 and/or some other example(s) herein, wherein the individual training nodes operate in parallel and each individual training node includes an instance of one or more of model library dependencies; topic training data; and topic testing data.

Example A10 includes a topic classification (TC) model training method, comprising: estimating parameter sets for the TC model; distributing the estimated parameter sets to multiple different training nodes for separately training associated TC models; receiving model performance values for the trained TC models back from the training nodes, the model performance values each associated with one of the estimated parameter sets; and using the model performance values and the associated estimated parameter sets to generate additional estimated parameter sets for distributing to the training nodes

Example A11 includes the method of example A10 and/or some other example(s) herein, further comprising: using a Bayesian optimization to estimate the parameter sets.

Example A12 includes the method of examples A10-A11 and/or some other example(s) herein, further comprising: loading the estimated parameter sets into a queue for distribution to the training nodes.

Example A13 includes the method of examples A10-A12 and/or some other example(s) herein, further comprising: automatically download another one of the estimated parameter sets from the queue after generating the model performance values for a previously downloaded one of the estimated parameter sets.

Example A14 includes the method of examples A10-A13 and/or some other example(s) herein, wherein the estimated parameter sets are placed in the queue until downloaded by the training nodes.

Example A15 includes the method of examples A10-A14 and/or some other example(s) herein, further comprising: repeatedly generating new estimated parameter sets until the model performance values converge or at least one of the model performance values reaches a threshold value.

Example A16 includes the method of examples A10-A15 and/or some other example(s) herein, further comprising: sending one of the trained TC models producing a highest one of the performance values to a content analyzer for estimating topics in content.

Example A17 includes a machine learning (ML) model training method, comprising: accessing a queue to download an estimated parameter set for the ML model; training the ML model using the estimated parameter set; calculating a model performance value for the trained ML model, the performance value associated with the estimated parameter set used for training the ML model; and sending the model performance value and the estimated parameter set to a master node for generating an additional estimated parameter set for training the ML models.

Example A18 includes the method of example A17 and/or some other example(s) herein, wherein the master node uses a Bayesian optimization to estimate the parameter set.

Example A19 includes the method of examples A17-A18 and/or some other example(s) herein, further comprising: automatically downloading an additional estimated parameter set from the queue for retraining the ML model after generating the model performance value for the previously trained ML model.

Example A20 includes the method of examples A17-A19 and/or some other example(s) herein, further comprising: loading multiple instances of training nodes on a server system, each of the training nodes are configured and/or operable to: download different estimated parameter sets from the queue; train associated ML models in parallel using the different downloaded parameter sets; calculate in parallel model performance values for the associated trained ML models; and send the model performance values to the master node for estimating new parameter sets

Example B01 includes a method of machine learning (ML) using a distributed ML system, the distributed ML system comprising a manager node and a plurality of training nodes, each training node of the plurality of training nodes is to train a corresponding ML model, the method comprising: identifying, by the manager node, a known hyperparameter (HP) set for the model, the known HP set including HPs for controlling properties of a training process for training the model; optimizing, by the manager node using an optimization algorithm, one or more estimated HP sets for the model based on the known HP set; and storing, by the manager node, the one or more estimated HP sets into respective slots of a queue.

Example B02 includes the method of example B01 and/or some other example(s) herein, further comprising: downloading, by individual training nodes of the plurality of training nodes, respective estimated HP sets from the queue; training, by the individual training nodes, the corresponding model in parallel with each other training node using the respective estimated HP sets; generating, by the individual training nodes, model performance values for the corresponding model based on the training; and sending, by the individual training nodes, the estimated HP sets with the model performance values to the manager node.

Example B03 includes the method of example B02 and/or some other example(s) herein, further comprising: operating, by the manager node, the optimization algorithm on each received estimated HP sets based on the corresponding model performance values to estimate respective additional HP sets until a trained model produces model performance values for a corresponding HP set that converges with other model performance values or reaches a threshold value; and loading, by the manager node, the additional model parameter sets into the queue to repeatedly have the individual training nodes continue to train their corresponding models and produce corresponding model performance values.

Example B04 includes the method of example B03 and/or some other example(s) herein, wherein each of the one or more estimated HP sets include HPs predicted to control the properties of the ML training process faster and/or consuming fewer computing resources than using the known model parameters.

Example B05 includes the method of example B04 and/or some other example(s) herein, wherein each of the respective additional model parameter sets include HPs predicted to control the properties of the ML training process faster and/or consuming fewer computing resources than using the estimated model parameters.

Example B06 includes the method of examples B03-B05 and/or some other example(s) herein, wherein the trained model that produces model performance values for a corresponding HP set that converges is an optimized ML model to be used to make predictions on new datasets.

Example B07 includes the method of examples B01-B06 and/or some other example(s) herein, further comprising: using, by the manager node, a Bayesian optimization to estimate the HP sets.

Example B08 includes the method of examples B01-B07 and/or some other example(s) herein, further comprising: repeatedly estimating, by the master node, new HP sets based on the estimated hyperparamter sets and their associated model performance values, and loading the new estimated hyperparamter sets into the queue until at least one of the estimated HP sets produces a target model performance value.

Example B09 includes the method of examples B01-B08 and/or some other example(s) herein, further comprising: automatically downloading, by the training nodes, additional estimated hyperparamter sets from the queue after generating the model performance values for the trained models.

Example B10 includes the method of examples B01-B09 and/or some other example(s) herein, wherein the queue operates as a first in-first out queue, and the method further comprises: placing, by the master node, the estimated hyperparamter sets in the queue, and the estimated hyperparamter sets are to move through the queue as the estimated hyperparamter sets are downloaded from the queue by respective training nodes.

Example B11 includes the method of examples B06-B10 and/or some other example(s) herein, further comprising: sending, by the master node, the optimized ML model to an analyzer to make predictions on the new datasets.

Example B12 includes the method of examples B01-B11 and/or some other example(s) herein, wherein each of the training nodes includes a same instance of: model library dependencies; training data; and testing data.

Example B13 includes the method of examples B01-B12 and/or some other example(s) herein, wherein: the model is a topic classification (TC) configured to identify topics from different words, phrases, and contexts in text; the known hyperparamters include sizes and dimensions that the TC model uses for building word vectors; the hyperparamters of the estimated hyperparamter set include estimated sizes and dimensions for building the word vectors to improve identification of the topics in documents by the TC model over the known hyperparamters; the hyperparamters of the additional hyperparamters include new estimated sizes and dimensions for building the word vectors to improve identification of the topics in documents by the TC model over existing estimated hyperparamters; the new datasets include textural content; and the identified model is to be used to estimate topics in the textual content.

Example B14 includes the method of example B13 and/or some other example(s) herein, wherein the analyzer is a content analyzer that operates in a content consumption monitor, and the method comprises: identifying, by the content analyzer, events from a domain; identifying, by the content analyzer, a number of the events; identifying, by the content analyzer, content associated with the events; identifying, by the content analyzer, a topic; using, by the content analyzer, the identified model to identify a relevancy of the content to the topic; and generating, by the content analyzer, a consumption score for the domain and topic based on the number of events and the relevancy of the content to the topic.

Example B15 includes a method of operating a manger node in a distributed machine learning (ML) model tuning system, the method comprising: estimating hyperparamter sets for an ML model from known hyperparamters, wherein the known hyperparamters control properties of a training process for training the ML model, the estimated hyperparamter set includes hyperparamters predicted to control the properties of the ML training process using fewer computing resources and/or faster than using the known hyperparamters; distributing the estimated hyperparamter sets to multiple training nodes such that each ML training node of the multiple training nodes separately trains a respective instance of the ML model using an individual estimated hyperparamter set of the estimated hyperparamter sets and such that each training node performs training in parallel with other ones of the multiple training nodes; receiving, from each training node, respective performance values calculated from training the respective instances; in response to receipt of each performance value until a performance value of an identified ML model instance of the respective instances of the ML model converges with other performance values or reaches a threshold value, perform optimization prediction calculations from the model performance value and the corresponding estimated hyperparamter set to estimate an additional hyperparamter set with new hyperparamters predicted to control the properties of the ML training process in using fewer computing resources and/or faster than using the hyperparamters of previously estimated hyperparamter sets; distribute the additional hyperparamter set to an available training node of the multiple training nodes to generate a new performance value from training the available training node's corresponding TC model; and after the convergence or the threshold value being met, provide the identified ML model instance to an analyzer to make predictions on new datasets.

Example B16 includes the method of example B15 and/or some other example(s) herein, wherein the estimating the hyperparamter sets comprises estimating the HP sets using Bayesian optimization.

Example B17 includes the method of examples B15-B16 and/or some other example(s) herein, further comprising: loading the estimated hyperparamter sets into a queue for distribution of the estimated hyperparamter sets to the ML training nodes.

Example B18 includes the method of examples B15-B17 and/or some other example(s) herein, wherein each training node automatically downloads another one of the estimated hyperparamter sets from the queue after generating the performance value for a previously downloaded one of the estimated hyperparamter sets.

Example B19 includes the method of examples B15-B18 and/or some other example(s) herein, wherein the analyzer is to use the identified ML model instance to make predictions and/or inferences on the new datasets.

Example B20 includes the method of example B19 and/or some other example(s) herein, wherein: the model is a topic classification (TC) configured to identify topics from different words, phrases, and contexts in text; the known hyperparamters include sizes and dimensions that the TC model uses for building word vectors; the hyperparamters of the estimated hyperparamter set include estimated sizes and dimensions for building the word vectors to improve identification of the topics in documents by the TC model over the known hyperparamters; the hyperparamters of the additional hyperparamters include new estimated sizes and dimensions for building the word vectors to improve identification of the topics in documents by the TC model over existing estimated hyperparamters; the new datasets include textural content; the identified model is a trained TC model to be used to estimate topics in the textual content; and the analyzer is a content analyzer.

Example B21 includes the method of example B20 and/or some other example(s) herein, further comprising: sending the identified model to the content analyzer for estimating topics in content.

Example B22 includes a method of operating a training node in a distributed machine learning (ML) model tuning system, the method comprising: accessing a queue to download an estimated hyperparamter set for training an ML model, the estimate hyperparamter set being estimated by a master node in the distributed ML model tuning system from known hyperparamters, the estimated hyperparamter set including hyperparamters predicted to control properties of the training in using fewer computing resources and/or faster than using the known hyperparamters; training the ML model using the hyperparamters of the estimated hyperparamter set in parallel with other training nodes of the multiple training nodes; calculating a performance value for the estimated hyperparamter set based on performance of training the ML model with the hyperparamters of the estimated hyperparamter set; sending the performance value and the estimated hyperparamter set to the master node; and repeating the accessing, the training, the calculating, and the sending until convergence of the ML model takes place.

Example B23 includes the method of example B22 and/or some other example(s) herein, wherein the master node is to perform Bayesian optimization on the estimated hyperparamter set based on the performance value, and generate an additional estimated hyperparamter set for training the ML model, the additional estimated hyperparamter set having hyperparamters predicted to control the properties of the training using fewer computing resources and/or faster than using the hyperparamters of previously estimated hyperparamter sets.

Example B24 includes the method of examples B22-B23 and/or some other example(s) herein, further comprising: automatically downloading the additional estimated hyperparamter set from the queue for retraining the ML model.

Example B25 includes the method of examples B22-B24 and/or some other example(s) herein, further comprising: downloading an estimated hyperparamter set from the queue that is different than estimated hyperparamter sets downloaded from the queue by other training nodes; training the model in parallel with the other training nodes such that each training node uses the different downloaded hyperparamter sets; and calculating the model performance value for the trained model in parallel with the other training nodes.

Example B26 includes the method of examples B22-B25 and/or some other example(s) herein, wherein each training node includes a same instance of model library dependencies, training data, and testing data.

Example B27 includes the method of examples B15-B25 and/or some other example(s) herein, wherein each of the training nodes includes a same instance of a model library dependencies, training data, and testing data.

Example B28 includes the method of examples A01-A20, B01-B27, and/or some other example(s) herein, wherein a network address of the manager node and/or the training nodes is/are internet protocol (IP) addresses, telephone numbers in a public switched telephone number, a cellular network addresses, internet packet exchange (IPX) addresses, X.25 addresses, X.21 addresses, Transmission Control Protocol (TCP) or User Datagram Protocol (UDP) port numbers, media access control (MAC) addresses, Electronic Product Codes (EPCs), Bluetooth hardware device addresses, a Universal Resource Locators (URLs), and/or email addresses.

Example Z01 includes one or more computer readable media comprising instructions, wherein execution of the instructions by processor circuitry is to cause the processor circuitry to perform the method of any one of examples A01-A20, B01-B28, and/or some other example(s) herein. Example Z02 includes a computer program comprising the instructions of example Z01. Example Z03a includes an Application Programming Interface defining functions, methods, variables, data structures, and/or protocols for the computer program of example Z02. Example Z03b includes an API or specification defining functions, methods, variables, data structures, protocols, etc., defining or involving use of any of examples A01-A20, B01-B28, or portions thereof, or otherwise related to any of examples A01-A20, B01-B28, or portions thereof. Example Z04 includes an apparatus comprising circuitry loaded with the instructions of example Z01. Example Z05 includes an apparatus comprising circuitry operable to run the instructions of example Z01. Example Z06 includes an integrated circuit comprising one or more of the processor circuitry of example Z01 and the one or more computer readable media of example Z01.

Example Z07 includes a computing system comprising the one or more computer readable media and the processor circuitry of example Z01. Example Z08 includes a computing system of example Z07 and/or one or more other example(s) herein, wherein the computing system is a System-in-Package (SiP), Multi-Chip Package (MCP), a System-on-Chips (SoC), a digital signal processors (DSP), a field-programmable gate arrays (FPGA), an Application Specific Integrated Circuits (ASIC), a programmable logic device (PLD), a complex PLD (CPLD), a Central Processing Unit (CPU), a Graphics Processing Unit (GPU), and/or the computing system comprises two or more of SiPs, MCPs, SoCs, DSPs, FPGAs, ASICs, PLDs, CPLDs, CPUs, GPUs interconnected with one another

Example Z09 includes an apparatus comprising means for executing the instructions of example Z01. Example Z10 includes a signal generated as a result of executing the instructions of example Z01. Example Z11 includes a data unit generated as a result of executing the instructions of example Z01. Example Z12 includes the data unit of example Z11 and/or some other example(s) herein, wherein the data unit is a datagram, network packet, data frame, data segment, a Protocol Data Unit (PDU), a Service Data Unit (SDU), a message, or a database object. Example Z13 includes a signal encoded with the data unit of examples Z11 and/or Z12. Example Z14 includes an electromagnetic signal carrying the instructions of example Z01. Example Z15 includes an apparatus comprising means for performing the method of any one of examples A01-A20, B01-B28, and/or some other example(s) herein.

Any of the previously-described examples may be combined with any other example (or combination of examples), unless explicitly stated otherwise.

### 9. Terminology

The terminology used herein is for the purpose of describing particular embodiments only and is not intended to be limiting of the disclosure. The present disclosure has been described with reference to flowchart illustrations and/or block diagrams of methods, apparatus (systems), and/or computer program products according to embodiments of the present disclosure. In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” which may each refer to one or more of the same or different embodiments. Furthermore, the terms “comprising,” “including,” “having,” and the like, as used with respect to embodiments of the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “circuitry” refers to a circuit or system of multiple circuits configurable or operable to perform a particular function in an electronic device. The circuit or system of circuits may be part of, or include one or more hardware components, such as a logic circuit, a processor (shared, dedicated, or group) and/or memory (shared, dedicated, or group), an ASIC, a FPGA, programmable logic controller (PLC), SoC, SiP, multi-chip package (MCP), DSP, etc., that are configurable or operable to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. The term “processor circuitry” may refer to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” as used herein refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data. “Computer-readable storage medium” (or alternatively, “machine-readable storage medium”) may include all of the foregoing types of memory, as well as new technologies that may arise in the future, as long as they may be capable of storing digital information in the nature of a computer program or other data, at least temporarily, in such a manner that the stored information may be “read” by an appropriate processing device. The term “computer-readable” may not be limited to the historical usage of “computer” to imply a complete mainframe, mini-computer, desktop, wireless device, or even a laptop computer. Rather, “computer-readable” may comprise storage medium that may be readable by a processor, processing device, or any computing system. Such media may be any available media that may be locally and/or remotely accessible by a computer or processor, and may include volatile and non-volatile media, and removable and non-removable media.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “element” refers to a unit that is indivisible at a given level of abstraction and has a clearly defined boundary, wherein an element may be any type of entity including, for example, one or more devices, systems, controllers, network elements, modules, etc., or combinations thereof. The term “device” refers to a physical entity embedded inside, or attached to, another physical entity in its vicinity, with capabilities to convey digital information from or to that physical entity. The term “entity” refers to a distinct component of an architecture or device, or information transferred as a payload. The term “controller” refers to an element or entity that has the capability to affect a physical entity, such as by changing its state or causing the physical entity to move.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configurable or operable to share computing and/or networking resources.

The term “cloud computing” or “cloud” refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like). The term “computing resource” or simply “resource” refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems, virtual machines (VMs), software/applications, computer files, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The terms “instantiate,” “instantiation,” and the like as used herein refers to the creation of an instance. An “instance” also refers to a concrete occurrence of an object, which may occur, for example, during execution of program code.

The term “information object” (or “InOb”) refers to a data structure that includes one or more data elements. each of which includes one or more data values. Examples of InObs include electronic documents, database objects, data files, resources, webpages, web forms, applications (e.g., web apps), services, web services, media, or content, and/or the like. InObs may be stored and/or processed according to a data format. Data formats define the content/data and/or the arrangement of data elements for storing and/or communicating the InObs. Each of the data formats may also define the language, syntax, vocabulary, and/or protocols that govern information storage and/or exchange. Examples of the data formats that may be used for any of the InObs discussed herein may include Accelerated Mobile Pages Script (AMPscript), Abstract Syntax Notation One (ASN.1), Backus-Naur Form (BNF), extended BNF, Bencode, BSON, ColdFusion Markup Language (CFML), comma-separated values (CSV), Control Information Exchange Data Model (C2IEDM), Cascading Stylesheets (CSS), DARPA Agent Markup Language (DAML), Document Type Definition (DTD), Electronic Data Interchange (EDI), Extensible Data Notation (EDN), Extensible Markup Language (XML), Efficient XML Interchange (EXI), Extensible Stylesheet Language (XSL), Free Text (FT), Fixed Word Format (FWF), Cisco® Etch, Franca, Geography Markup Language (GML), Guide Template Language (GTL), Handlebars template language, Hypertext Markup Language (HTML), Interactive Financial Exchange (IFX), Keyhole Markup Language (KML), JAMscript, Java Script Object Notion (JSON), JSON Schema Language, Apache® MessagePackTM, Mustache template language, Ontology Interchange Language (OIL), Open Service Interface Definition, Open Financial Exchange (OFX), Precision Graphics Markup Language (PGML), Google® Protocol Buffers (protobuf), Quicken® Financial Exchange (QFX), Regular Language for XML Next Generation (RelaxNG) schema language, regular expressions, Resource Description Framework (RDF) schema language, RESTful Service Description Language (RSDL), Scalable Vector Graphics (SVG), Schematron, Tactical Data Link (TDL) format (e.g., J-series message format for Link 16; JREAP messages; Multifuction Advanced Data Link (MADL), Integrated Broadcast Service/Common Message Format (IBS/CMF), Over-the-Horizon Targeting Gold (OTH-T Gold), Variable Message Format (VMF), United States Message Text Format (USMTF), and any future advanced TDL formats), VBScript, Web Application Description Language (WADL), Web Ontology Language (OWL), Web Services Description Language (WSDL), wiki markup or Wikitext, Wireless Markup Language (WML), extensible HTML (XHTML), XPath, XQuery, XML DTD language, XML Schema Definition (XSD), XML Schema Language, XSL Transformations (XSLT), YAML (“Yet Another Markup Language” or “YANL Ain't Markup Language”), Apache® Thrift, and/or any other data format and/or language discussed elsewhere herein.

Additionally or alternatively, the data format for the InObs may be document and/or plain text, spreadsheet, graphics, and/or presentation formats including, for example, American National Standards Institute (ANSI) text, a Computer-Aided Design (CAD) application file format (e.g., “.c3d”, “.dwg”, “.dft”, “.iam”, “.iaw”, “.tct”, and/or other like file extensions), Google® Drive® formats (including associated formats for Google Docs®, Google Forms®, Google Sheets®, Google Slides®, etc.), Microsoft® Office® formats (e.g., “.doc”, “.ppt”, “.xls”, “.vsd”, and/or other like file extension), OpenDocument Format (including associated document, graphics, presentation, and spreadsheet formats), Open Office XML (OOXML) format (including associated document, graphics, presentation, and spreadsheet formats), Apple® Pages®, Portable Document Format (PDF), Question Object File Format (QUOX), Rich Text File (RTF), TeX and/or LaTeX (“.tex” file extension), text file (TXT), TurboTax® file (“.tax” file extension), You Need a Budget (YNAB) file, and/or any other like document or plain text file format.

Additionally or alternatively, the data format for the InObs may be archive file formats that store metadata and concatenate files, and may or may not compress the files for storage. As used herein, the term “archive file” refers to a file having a file format or data format that combines or concatenates one or more files into a single file or InOb. Archive files often store directory structures, error detection and correction information, arbitrary comments, and sometimes use built-in encryption. The term “archive format” refers to the data format or file format of an archive file, and may include, for example, archive-only formats that store metadata and concatenate files, for example, including directory or path information; compression-only formats that only compress a collection of files; software package formats that are used to create software packages (including self-installing files), disk image formats that are used to create disk images for mass storage, system recovery, and/or other like purposes; and multi-function archive formats that can store metadata, concatenate, compress, encrypt, create error detection and recovery information, and package the archive into self-extracting and self-expanding files. For the purposes of the present disclosure, the term “archive file” may refer to an archive file having any of the aforementioned archive format types. Examples of archive file formats may include Android® Package (APK); Microsoft® Application Package (APPX); Genie Timeline Backup Index File (GBP); Graphics Interchange Format (GIF); gzip (.gz) provided by the GNU ProjectTM; Java® Archive (JAR); Mike O′Brien Pack (MPQ) archives; Open Packaging Conventions (OPC) packages including OOXML files, OpenXPS files, etc.; Rar Archive (RAR); Red Hat® package/installer (RPM); Google® SketchUp backup File (SKB); TAR archive (“.tar”); XPlnstall or XPI installer modules; ZIP (.zip or .zipx); and/or the like.

The term “data element” refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” may refer to a data type that contains one single data. Data elements may store data, which may be referred to as the data element's content (or “content items”). Content items may include text content, attributes, properties, and/or other elements referred to as “child elements.” Additionally or alternatively, data elements may include zero or more properties and/or zero or more attributes, each of which may be defined as database objects (e.g., fields, records, etc.), object instances, and/or other data elements. An “attribute” may refer to a markup construct including a name—value pair that exists within a start tag or empty element tag. Attributes contain data related to its element and/or control the element's behavior.

The term “personal data,” “personally identifiable information,” “PII,” or the like refers to information that relates to an identified or identifiable individual. Additionally or alternatively, “personal data,” “personally identifiable information,” “PII,” or the like refers to information that can be used on its own or in combination with other information to identify, contact, or locate a person, or to identify an individual in context. The term “sensitive data” may refer to data related to racial or ethnic origin, political opinions, religious or philosophical beliefs, or trade union membership, genetic data, biometric data, data concerning health, and/or data concerning a natural person's sex life or sexual orientation. The term “confidential data” refers to any form of information that a person or entity is obligated, by law or contract, to protect from unauthorized access, use, disclosure, modification, or destruction. Additionally or alternatively, “confidential data” may refer to any data owned or licensed by a person or entity that is not intentionally shared with the general public or that is classified by the person or entity with a designation that precludes sharing with the general public.

The term “pseudonymization” or the like refers to any means of processing personal data or sensitive data in such a manner that the personal/sensitive data can no longer be attributed to a specific data subject (e.g., person or entity) without the use of additional information. The additional information may be kept separately from the personal/sensitive data and may be subject to technical and organizational measures to ensure that the personal/sensitive data are not attributed to an identified or identifiable natural person.

The term “application” may refer to a complete and deployable package, environment to achieve a certain function in an operational environment. The term “AI/ML application” or the like may be an application that contains some AI/ML models and application-level descriptions. The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure. The term “session” refers to a temporary and interactive information interchange between two or more communicating devices, two or more application instances, between a computer and user, or between any two or more entities or elements.

The term “network address” refers to an identifier for a node or host in a computer network, and may be a unique identifier across a network and/or may be unique to a locally administered portion of the network. Examples of network addresses include telephone numbers in a public switched telephone number, a cellular network address (e.g., international mobile subscriber identity (IMSI), mobile subscriber ISDN number (MSISDN), Subscription Permanent Identifier (SUPI), Temporary Mobile Subscriber Identity (TMSI), Globally Unique Temporary Identifier (GUTI), Generic Public Subscription Identifier (GPSI), etc.), an internet protocol (IP) address in an IP network (e.g., IP version 4 (Ipv4), IP version 6 (IPv6), etc.), an internet packet exchange (IPX) address, an X.25 address, an X.21 address, a port number (e.g., when using Transmission Control Protocol (TCP) or User Datagram Protocol (UDP)), a media access control (MAC) address, an Electronic Product Code (EPC) as defined by the EPCglobal Tag Data Standard, Bluetooth hardware device address (BD_ADDR), a Universal Resource Locator (URL), an email address, and/or the like.

The term “organization” or “org” refers to an entity comprising one or more people and/or users and having a particular purpose, such as, for example, a company, an enterprise, an institution, an association, a regulatory body, a government agency, a standards body, etc. Additionally or alternatively, an “org” may refer to an identifier that represents an entity/organization and associated data within an instance and/or data structure.

The term “intent data” may refer to data that is collected about users' observed behavior based on web content consumption, which provides insights into their interests and indicates potential intent to take an action. The term “engagement” refers to a measureable or observable user interaction with a content item or InOb. The term “engagement rate” refers to the level of user interaction that is generated from a content item or InOb. For purposes of the present disclosure, the term “engagement” may refer to the amount of interactions with content or InObs generated by an organization or entity, which may be based on the aggregate engagement of users associated with that organization or entity.

The term “session” refers to a temporary and interactive information interchange between two or more communicating devices, two or more application instances, between a computer and user, or between any two or more entities or elements. Additionally or alternatively, the term “session” may refer to a connectivity service or other service that provides or enables the exchange of data between two entities or elements. A “network session” may refer to a session between two or more communicating devices over a network, and a “web session” may refer to a session between two or more communicating devices over the Internet. A “session identifier,” “session ID,” or “session token” refers to a piece of data that is used in network communications to identify a session and/or a series of message exchanges.

The term “optimization” may refer to an act, process, or methodology of making something (e.g., a design, system, or decision) as fully perfect, functional, or effective as possible. Optimization usually includes mathematical procedures such as finding the maximum or minimum of a function. The term “optimal” refers to a most desirable or satisfactory end, outcome, or output. The term “optimum” refers to an amount or degree of something that is most favorable to some end. The term “optima” refers to a condition, degree, amount, or compromise that produces a best possible result. The term “optima” may additionally or alternatively refer to a most favorable or advantageous outcome or result. The term “Bayesian optimization” refers to a sequential design strategy for global optimization of black-box functions that does not assume any functional forms.

Although the various example embodiments and example implementations have been described herein, it will be evident that various modifications and changes may be made to these aspects without departing from the broader scope of the present disclosure. Many of the arrangements and processes described herein can be used in combination or in parallel implementations. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. The present disclosure is not to be taken in a limiting sense, and the scope of various aspects is defined only by the appended claims, along with the full range of equivalents to which such claims are entitled.

1. One or more non-transitory computer readable media (NTCRM) comprising instructions for operating a manager node in a distributed machine learning (ML) hyperparameter (HP) tuning system, the distributed ML HP tuning system comprising a manager node and a plurality pf training nodes, and wherein execution of the instructions by one or more processors of a computing system is to cause the computing system to:
operate an optimization algorithm to estimate one or more best-guess HP sets for an ML model;
distribute the best-guess HP sets to the plurality of training nodes in the ML HP tuning system, wherein individual training nodes of the plurality of training nodes separately train, in parallel, a local copy of the ML model using a respective best-guess HP set of the distributed best-guess HP sets;
obtain, from respective training nodes of the plurality of training nodes, the respective best-guess HP set used for training the local copy of the ML model and a corresponding performance value calculated from the training with the respective best-guess HP set; and
until an identified local copy of the ML model converges on a particular performance value,
operate the optimization algorithm to estimate additional HP sets from each HP set obtained from individual training nodes;
distribute the additional HP sets to available training nodes of the plurality of training nodes, wherein the individual training nodes separately train, in parallel, their local copy of the ML model using a respective additional HP set of the distributed additional HP sets, and
obtain, from the respective training nodes, the respective additional HP set used for training the local copy of the ML model and a corresponding performance value calculated from the training with the respective additional HP set.

2. The one or more NTCRM of claim 1, wherein execution of the instructions is to further cause the computing system to:
determine the best-guess HP sets for the ML model from at least one known HP set.

3. The one or more NTCRM of claim 1, wherein the at least one known HP set includes one or more known HPs that control the training of the local copy of the ML model, and each of the best-guess HP sets include one or more best-guess HPs predicted to control the training using fewer computing resources than the one or more known HPs, or predicted to complete the training faster than using the one or more known HPs.

4. The one or more NTCRM of claim 3, wherein each of the additional HP sets include one or more HPs predicted to control the training using fewer computing resources than the one or more best-guess HPs, or predicted to complete the training faster than using the one or more best-guess HPs.

5. The one or more NTCRM of claim 4, wherein:
the ML model is a topic classification (TC) model configured to identify topics from one or more information objects;
the one or more known HPs include sizes and dimensions that the TC model uses for building word vectors;
the one or more best-guess HPs include estimated sizes and dimensions for building the word vectors to improve identification of the topics in documents by the TC model over the known HPs;
the one or more HPs of the additional HP sets include new estimated sizes and dimensions for building the word vectors to improve identification of the topics in documents by the TC model than the best-guess HPs; and
the identified ML model is a trained TC model to be used to estimate topics in additional information objects.

6. The one or more NTCRM of claim 1, wherein execution of the instructions is to further cause the computing system to:
store the best-guess HP sets and the additional HP sets into respective slots of a queue for distribution to the plurality of training nodes,
wherein each training node of the plurality of training nodes automatically downloads the respective best-guess HP sets or the respective additional HP sets from the queue after generating the performance value for a previously downloaded HP set.

7. The one or more NTCRM of claim 1, wherein the optimization algorithm is a Bayesian optimization algorithm.

8. The one or more NTCRM of claim 1, wherein the identified local copy of the ML model that converges is an optimal ML model to be used for to making predictions or inferences on one or more datasets.

9. One or more non-transitory computer readable media (NTCRM) comprising instructions for operating a training node in a distributed machine learning (ML) hyperparameter (HP) tuning system, the distributed ML HP tuning system comprising a manager node and a plurality pf training nodes, and wherein execution of the instructions by one or more processors of a computing system is to cause the computing system to:
until an ML model convergence occurs,
obtain, from a queue storing HP sets, an HP set for training a local copy of an ML model;
train the local copy of the ML model using HPs of the HP set in parallel with one or more other training nodes of the distributed HP tuning system training other HPs of other HP sets;
determine a performance value for the HP set based on performance of the training using the HPs; and
send the performance value and the HP set to a manager node for generation of an additional HP set from the HP set based on an optimization algorithm.

10. The one or more NTCRM of claim 9, wherein a first HP set stored in the queue is based on at least one known HP set.

11. The one or more NTCRM of claim 9, wherein the at least one known HP set includes one or more known HPs that control the training of the local copy of the ML model, and the obtained HP set includes one or more HPs predicted to control the training using fewer computing resources than the one or more known HPs, or predicted to complete the training faster than using the one or more known HPs.

12. The one or more NTCRM of claim 11, wherein the additional HP sets includes one or more HPs predicted to control the training using fewer computing resources than the one or more HPs of the obtained HP set, or predicted to complete the training faster than using the one or more HPs of the obtained HP set.

13. The one or more NTCRM of claim 9, wherein the optimization algorithm is a Bayesian optimization algorithm.

14. The one or more NTCRM of claim 9, wherein a local copy of the ML model that converges is an optimal ML model to be used for to making predictions or inferences on one or more datasets.

15. The one or more NTCRM of claim 9, wherein execution of the instructions is to further cause the computing system to:
operate the trained ML model to make predictions based on a testing dataset; and
determine the performance value for the HP set further based on accuracy of the predictions of the trained ML model.

16. A distributed hyperparameter (HP) tuning system, comprising:
a manager node configured to:
continuously estimate HP sets for a machine learning (ML) model using an optimization algorithm,
store each of the estimated HP sets in a queue, and
stop the estimation when a performance value of an HP set used to train the ML model converges; and
a plurality of training nodes, wherein individual training nodes of the plurality of training nodes are configured to:
obtain, from the queue, respective HP sets for training respective local instances of the ML model;
train the respective local instances using respective HPs of the respective HP sets in parallel with other training nodes of the plurality of training nodes;
determine respective performance values for the HP sets based on performance of the trained respective local instances; and
send the respective performance values and the respective HP sets to the manager node for further estimation of HP sets.

17. The distributed HP tuning system of claim 16, wherein the manager node is further configured to:
determine one or more best-guess HP sets for the ML model from at least one known HP set.

18. The distributed HP tuning system of claim 17, wherein the individual training nodes are further configured to:
operate the trained respective local instances of the ML model to make predictions based on a testing dataset; and
determine the respective performance values for the respective HP sets further based on accuracy of the predictions of the trained respective local instances.

19. The distributed HP tuning system of claim 16, wherein the manager node and the plurality of training nodes are operated by one or more cloud compute nodes of a cloud computing system.

20. The distributed HP tuning system of claim 19, wherein the cloud computing system includes a container engine configured to deploy a plurality of containers using a container image, wherein each training node of the plurality of training nodes is to operate within a corresponding container of the plurality of containers, and the container image includes training and testing datasets and training libraries for training and testing the respective local instances of the ML model.
